(19) United States
(12) Patent Application Publication
(10) Pub. No.: US 2026/0005710 A1
(43) Pub. Date: Jan. 1, 2026

(54) HIGH-FREQUENCY CIRCUIT

(71) Applicant: Murata Manufacturing Co., Ltd., Nagaokakyo-shi (JP)

(72) Inventors: Atsushi ONO, Nagaokakyo-shi (JP); Hiroyuki NAGAMORI, Nagaokakyo-shi (JP); Hirotsugu MORI, Nagaokakyo-shi (JP); Syunsuke KIDO, Nagaokakyo-shi (JP); Yuudai TANOUE, Nagaokakyo-shi (JP)

(73) Assignee: Murata Manufacturing Co., Ltd., Nagaokakyo-shi (JP)

(21) Appl. No.: 19/318,420

(22) Filed: Sep. 4, 2025

Related U.S. Application Data
(63) Continuation of application No. PCT/JP2024/004624, filed on Feb. 9, 2024.

(30) Foreign Application Priority Data
Mar. 31, 2023 (JP) 2023-057633

(51) Int. Cl. H04B 1/00; H04B 1/44; H04L 5/14

(52) U.S. Cl. CPC H04B 1/0057; H04B 1/44; H04L 5/1461

(57) ABSTRACT

A high-frequency circuit includes: a first filter having a first pass band including a band A); a second filter having a second pass band including a band B for of simultaneous transmission and reception with the band A; a third filter having a pass band including the band A; a fourth filter having a pass band including the band B; and fifth and sixth filters having a pass band including the band A and the band B, respectively, and connected to a first input/output terminal. A first switch circuit includes a terminal connected to a power amplifier and first and second terminals connected to the first and second filters), respectively. A second switch circuit included first to sixth terminals connected to the first to sixth filters, respectively. A terminal is connected to a second input/output terminal not via the fifth and sixth filters.

### CROSS-REFERENCE TO RELATED APPLICATIONS

The present application is a continuation of International Application No. PCT/JP2024/004624, filed Feb. 9, 2024, which claims priority to Japanese patent application 2023-057633, filed Mar. 31, 2023, the entire contents of each of which being incorporated herein by reference.

### TECHNICAL FIELD

The present disclosure relates to a high-frequency circuit.

### BACKGROUND ART

In 3rd Generation Partnership Project (3GPP) (registered trademark), Simultaneous Rx/Tx has been studied in which two time division duplex (TDD) bands are combined to perform simultaneous transmission and reception.

### CITATION LIST

### Patent Document

Patent Document 1: U.S. Patent Application Publication No. 2015/0133067

### SUMMARY

### Technical Problems

However, in the conventional high-frequency circuit disclosed in Patent Document 1 or the like, there is concern about degradation in quality of a reception signal in Simultaneous Rx/Tx.

To address this, the present disclosure provides a high-frequency circuit capable of improving the quality of a reception signal in Simultaneous Rx/Tx.

### Solution to Problem

A high-frequency circuit according to an aspect of the present disclosure includes: a first power amplifier; a first low-noise amplifier and a second low-noise amplifier; a first filter having a pass band including a first band for time division duplex and switchably connected to the first power amplifier; a second filter having a pass band including a second band for time division duplex capable of simultaneous transmission and reception with the first band and switchably connected to the first power amplifier; a third filter having a pass band including the first band and connected to the first low-noise amplifier; a fourth filter having a pass band including the second band and connected to the second low-noise amplifier; a fifth filter having a pass band including the first band and having one end switchably connected to each of the first filter and the third filter and another end connected to a first input/output terminal; a sixth filter having a pass band including the second band and having one end switchably connected to each of the second filter and the fourth filter and another end connected to the first input/output terminal; a first switch circuit including a first terminal connected to the first power amplifier and a second terminal and a third terminal connected to the first filter and the second filter, respectively; and a second switch circuit including a fourth terminal, a fifth terminal, a sixth terminal, a seventh terminal, an eighth terminal, and a ninth terminal connected to the first filter, the second filter, the third filter, the fourth filter, the fifth filter, and the sixth filter, respectively, and a tenth terminal connected to a second input/output terminal not via the fifth filter and the sixth filter.

### Advantageous Effects

According to the high-frequency circuit of an aspect of the present disclosure, the quality of a reception signal can be improved in Simultaneous Rx/Tx.

### BRIEF DESCRIPTION OF DRAWINGS

FIG. 1 is a circuit structure diagram of a communication device according to a first embodiment.

FIG. 2 is a diagram depicting a first connection type of the communication device according to the first embodiment.

FIG. 3 is a diagram depicting a second connection type of the communication device according to the first embodiment.

FIG. 4 is a diagram depicting a third connection type of the communication device according to the first embodiment.

FIG. 5 is a diagram depicting a fourth connection type of the communication device according to the first embodiment.

FIG. 6 is a diagram depicting a fifth connection type of the communication device according to the first embodiment.

FIG. 7 is a diagram depicting a sixth connection type of the communication device according to the first embodiment.

FIG. 8 is a diagram depicting a seventh connection type of the communication device according to the first embodiment.

FIG. 9 is a circuit structure diagram of a communication device according to a second embodiment.

FIG. 10 is a diagram depicting a first connection type of the communication device according to the second embodiment.

FIG. 11 is a diagram depicting a second connection type of the communication device according to the second embodiment.

FIG. 12 is a diagram depicting a third connection type of the communication device according to the second embodiment.

FIG. 13 is a diagram depicting a fourth connection type of the communication device according to the second embodiment.

FIG. 14 is a diagram depicting a fifth connection type of the communication device according to the second embodiment.

FIG. 15 is a diagram depicting a sixth connection type of the communication device according to the second embodiment.

FIG. 16 is a diagram depicting a seventh connection type of the communication device according to the second embodiment.

FIG. 17 is a circuit structure diagram of a communication device according to a third embodiment.

FIG. 18 is a diagram depicting a first connection type of the communication device according to the third embodiment.

FIG. 19 is a diagram depicting a second connection type of the communication device according to the third embodiment.

FIG. 20 is a diagram depicting a third connection type of the communication device according to the third embodiment.

FIG. 21 is a circuit structure diagram of a communication device according to a fourth embodiment.

FIG. 22 is a diagram depicting a first mode of the communication device according to the fourth embodiment.

FIG. 23 is a diagram depicting a second mode of the communication device according to the fourth embodiment.

FIG. 24 is a diagram depicting a third mode of the communication device according to the fourth embodiment.

FIG. 25 is a diagram depicting a fourth mode of the communication device according to the fourth embodiment.

FIG. 26 is a circuit structure diagram of a communication device according to a first modification of the fourth embodiment.

FIG. 27 is a diagram depicting a first mode of the communication device according to the first modification of the fourth embodiment.

FIG. 28 is a diagram depicting a second mode of the communication device according to the first modification of the fourth embodiment.

FIG. 29 is a diagram depicting a third mode of the communication device according to the first modification of the fourth embodiment.

FIG. 30 is a diagram depicting a fourth mode of the communication device according to the first modification of the fourth embodiment.

FIG. 31 is a circuit structure diagram of a communication device according to a second modification of the fourth embodiment.

FIG. 32 is a circuit structure diagram of a communication device according to a third modification of the fourth embodiment.

FIG. 33 is a circuit structure diagram of a communication device according to a fifth embodiment.

FIG. 34 is a diagram depicting a first mode of the communication device according to the fifth embodiment.

FIG. 35 is a diagram depicting a second mode of the communication device according to the fifth embodiment.

FIG. 36 is a diagram depicting a third mode of the communication device according to the fifth embodiment.

FIG. 37 is a diagram depicting a fourth mode of the communication device according to the fifth embodiment.

FIG. 38 is a circuit structure diagram of a communication device according to a sixth embodiment.

FIG. 39 is a circuit structure diagram of a communication device according to a seventh embodiment.

FIG. 40 is a circuit structure diagram of a communication device according to a modification of the seventh embodiment.

### DESCRIPTION OF EMBODIMENTS

Embodiments of the present disclosure are described in detail below by using the drawings. The embodiments described below each describe a comprehensive or specific example. Numerical values, shapes, materials, components, the arrangement and connection types of the components, and so forth described in the embodiments below are merely examples and are not intended to restrict the present disclosure.

Note that each drawing is a schematic drawing with enhancement, omission, or ratio adjustment as appropriate to describe the present disclosure and is not necessarily strictly depicted and the shapes, positional relation, and ratio may be different from actual ones. In each drawing, substantially identical structures are provided with the same reference character and redundant description of these may be omitted or simplified.

In the circuit structure, “connected” includes not only a direct connection with a connection terminal and/or wiring conductor but also an electrical connection via another circuit element. “C is connected between A and B” means that one end of C is connected to A and the other end of C is connected to B and C is connected in series with a path connecting A and B. “A is switchably connected to B” means that connection and non-connection between A and B is switchable and A is connected via a switch to B. Note that “A is connected to B” includes “A is switchably connected to B”.

In the circuit structure, “terminal” means a point where a conductor in the component ends. Note that when impedance of a conductor between components is sufficiently low, the terminal can be construed as not only a single point but also any point on the conductor between components or the whole conductor.

“Pass band of a filter” means a portion of a frequency spectral transmitted by a filter and is defined as a frequency band in which output power does not attenuate by 3 dB or more from the maximum output power. “Attenuation band of a filter” is defined as a frequency band in which output power attenuates by 5 dB or more from the maximum output power.

“Transmission band” means a frequency band for use in transmission in a communication device, and “reception band” means a frequency band for use in reception in the communication device. For example, in a frequency division duplex (FDD) band, as a transmission band and a reception band, frequency bands that are different from each other (for example, uplink band and downlink band) are used. Also, for example, in a TDD band, the same frequency band is used for the transmission band and the reception band.

### First Embodiment

A first embodiment is described. A communication device 5 according to the present embodiment functions as a UE in a cellular network, and is typically a mobile phone, smartphone, tablet computer, wearable device, or the like. Note that the communication device 5 may be an internet-of-things (IoT) sensor device, medical/healthcare device, vehicle, unmanned aerial vehicle (UAV) (so-called drone), or automated guided vehicle (AGV). Also, the communication device 5 may function as a BS in a cellular network.

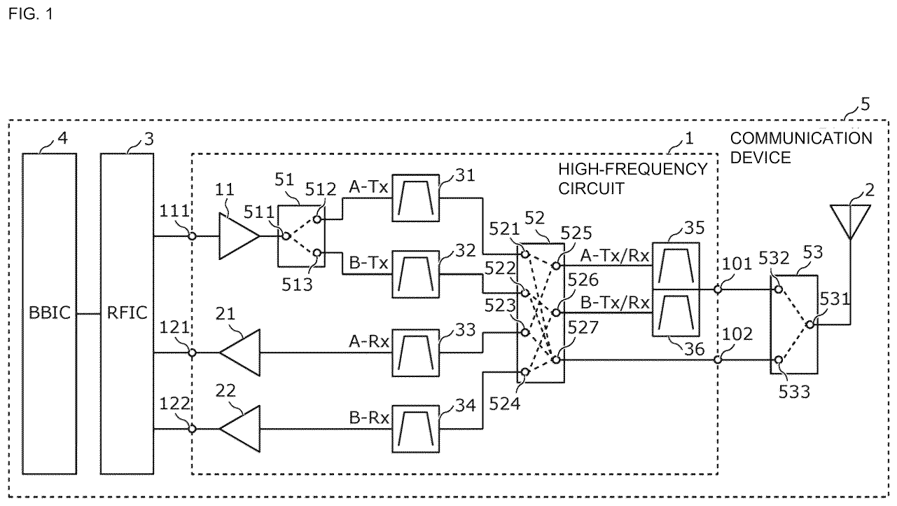

The circuit structure of the communication device 5 and a high-frequency circuit 1 according to the present embodiment is described with reference to FIG. 1. FIG. 1 is a circuit structure diagram of the communication device 5 according to the present embodiment. In the drawings below, a broken line in a switch circuit represents a path between connectable terminals.

Note that FIG. 1 is an exemplary circuit structure and the communication device 5 and the high-frequency circuit 1 can be implemented by using any of various circuit implementations or circuit technologies. Therefore, description of the communication device 5 and the high-frequency circuit 1 provided below is as restrictive.

### [1.1 Circuit Structure of Communication Device 5]

First, the circuit structure of the communication device 5 according to the present embodiment is described with reference to FIG. 1. The communication device 5 is implemented on a UE, and includes the high-frequency circuit 1, an antenna 2, a radio frequency integrated circuit (RFIC) 3, a baseband integrated circuit (BBIC) 4, and a switch circuit 53.

The high-frequency circuit 1 can transmit a high-frequency signal between the antenna 2 and the RFIC 3. The circuit structure of the high-frequency circuit 1 is described further below.

The antenna 2 is connected to the switch circuit 53. The antenna 2 can receive a high-frequency signal from outside the communication device 5 and supply the high-frequency signal via the switch circuit 53 to the high-frequency circuit 1. Furthermore, the antenna 2 can transmit a high-frequency signal supplied from the high-frequency circuit 1 via the switch circuit 53 to the outside of the communication device 5. Note that the antenna 2 may not be included in the communication device 5. Also, the communication device 5 may further include, in addition to the antenna 2, one or more antennas.

The RFIC 3 is one example of a signal processing circuit to process a high-frequency signal. Specifically, the RFIC 3 can perform signal processing by down conversion or the like on a high-frequency reception signal input via a reception path of the high-frequency circuit 1 and output the reception signal generated by the signal processing to the BBIC 4. Furthermore, the RFIC 3 can perform signal processing by up conversion or the like on a transmission signal input from the BBIC 4 and output the high-frequency transmission signal generated by the signal processing to the high-frequency circuit 1. Also, the RFIC 3 may include a control part for controlling a switch, power amplifier, and so forth the high-frequency circuit 1 has. Note that an entire or part of the control part may be provided outside the RFIC 3 and may be included in, for example, the BBIC 4 or the high-frequency circuit 1.

The BBIC 4 is a baseband signal processing circuit for signal processing by using a frequency band lower than that of a high-frequency signal to be transmitted by the high-frequency circuit 1. As a signal to be processed in the BBIC 4, for example, an image signal for image display and/or an audio signal for conversation via a loudspeaker are used. Note that the BBIC 4 may not be included in the communication device 5.

The switch circuit 53 is one example of a third switch circuit, and is connected between the antenna 2 and the high-frequency circuit 1. Specifically, the switch circuit 53 includes terminals 531 to 533. The terminal 531 is one example of an eleventh terminal, and is connected to the antenna 2. The terminal 532 is one example of a twelfth terminal, and is connected to an input/output terminal 101 of the high-frequency circuit 1. The terminal 533 is one example of a thirteenth terminal, and is connected to an input/output terminal 102 of the high-frequency circuit 1. In this connection structure, for example, based on a control signal from the RFIC 3, the switch circuit 53 can connect the terminal 531 exclusively to the terminals 532 and 533. The switch circuit 53 is configured of, for example, a single-pole double-throw (SPDT)-type switch circuit. Note that the switch circuit 53 may be included in the high-frequency circuit 1.

### [1.2 Circuit Structure of High-Frequency Circuit 1]

Next, the circuit structure of the high-frequency circuit 1 according to the present embodiment is described with reference to FIG. 1. The high-frequency circuit 1 includes a power amplifier 11, low-noise amplifiers 21 and 22, filters 31 to 36, switch circuits 51 and 52, the input/output terminals 101 and 102, an input terminal 111, and output terminals 121 and 122.

The input/output terminals 101 and 102 are example of a first input/output terminal and a second input/output terminal, respectively, and are external connection terminals of the high-frequency circuit 1. The input/output terminal 101 is connected to the terminal 532 of the switch circuit 53 outside the high-frequency circuit 1, and is connected to the filters 35 and 36 inside the high-frequency circuit 1. The input/output terminal 102 is connected to the terminal 533 of the switch circuit 53 outside the high-frequency circuit 1, and is connected to a terminal 527 of the switch circuit 52 inside the high-frequency circuit 1.

Note that the input/output terminal 101 and/or 102 may not be an external connection terminal of the high-frequency circuit 1. For example, when the switch circuit 53 is included in the high-frequency circuit 1, the input/output terminal 101 may be a path connecting the filters 35 and 36 and the terminal 532 of the switch circuit 53 or a node on that path, and the input/output terminal 102 may be a path connecting the terminal 527 of the switch circuit 52 and the terminal 533 of the switch circuit 53 or a node on that path.

The input terminal 111 is an external connection terminal of the high-frequency circuit 1, and is a high-frequency input terminal. The input terminal 111 is connected to the RFIC 3 outside the high-frequency circuit 1, and is connected to the power amplifier 11 inside the high-frequency circuit 1. The input terminal 111 can receive transmission signals of bands A and B from the RFIC 3.

The output terminals 121 and 122 are external connection terminals of the high-frequency circuit 1, and are high-frequency output terminals. The output terminal 121 is connected to the RFIC 3 outside the high-frequency circuit 1, and is connected to the low-noise amplifier 21 inside the high-frequency circuit 1. The output terminal 122 is connected to the RFIC 3 outside the high-frequency circuit 1, and is connected to the low-noise amplifier 22 inside the high-frequency circuit 1. The output terminal 121 can supply a reception signal of the band A to the RFIC 3, and the output terminal 122 can supply a reception signal of the band B to the RFIC 3.

The power amplifier 11 is one example of a first power amplifier. The input end of the power amplifier 11 is connected to the input terminal 111. The output end of the power amplifier 11 is connected via the switch circuit 51 to the filters 31 and 32. By using electric power supplied from a power supply (not depicted), the power amplifier 11 can amplify transmission signals of the bands A and B supplied from the RFIC 3 via the input terminal 111.

The power amplifier 11 can be configured of a heterojunction bipolar transistor (HBT), and can be manufactured by using a semiconductor material. As a semiconductor material, for example, silicon germanium (SiGe) or gallium arsenide (GaAs) can be used. Note that the amplifying transistor of the power amplifier 11 is not limited to an HBT. For example, the power amplifier 11 may be configured of, for example, a high electron mobility transistor (HEMT) or metal-semiconductor field effect transistor (MESFET). In this case, as a semiconductor material, gallium nitride (GaN) or silicon carbide (SiC) may be used.

The low-noise amplifier 21 is one example of a first low-noise amplifier. The input end of the low-noise amplifier 21 is connected to the filter 33. The output end of the low-noise amplifier 21 is connected to the output terminal 121. By using electric power supplied from a power supply (not depicted), the low-noise amplifier 21 can amplify a reception signal of the band A passing through the filter 33.

The low-noise amplifier 22 is one example of a second low-noise amplifier. The input end of the low-noise amplifier 22 is connected to the filter 34. The output end of the low-noise amplifier 22 is connected to the output terminal 122. By using electric power supplied from a power supply (not depicted), the low-noise amplifier 22 can amplify a reception signal of the band B passing through the filter 34.

The low-noise amplifiers 21 and 22 can be each configured of a field effect transistor (FET), and can be manufactured by using a semiconductor material. As a semiconductor material, for example, a silicon single crystal, GaN, or SiC can be used. Note that the amplifying transistor of the low-noise amplifiers 21 and 22 is not limited to an FET. For example, an entire or part of the low-noise amplifiers 21 and 22 may be configured of a bipolar transistor.

The filter 31 is one example of a first filter, and is a band pass filter having a pass band including the band A. One end of the filter 31 is connected to a terminal 512 of the switch circuit 51, and is switchably connected via the switch circuit 51 to the power amplifier 11. On the other hand, the other end of the filter 31 is connected to a terminal 521 of the switch circuit 52, and is switchably connected via the switch circuit 52 to each of the input/output terminals 101 and 102. In the present embodiment, the filter 31 is used for transmission of a signal of the band A (A-Tx).

The filter 32 is one example of a second filter, and is a band pass filter having a pass band including the band B. One end of the filter 32 is connected to a terminal 513 of the switch circuit 51, and is switchably connected via the switch circuit 51 to the power amplifier 11. On the other hand, the other end of the filter 32 is connected to a terminal 522 of the switch circuit 52, and is switchably connected via the switch circuit 52 to each of the input/output terminals 101 and 102. In the present embodiment, the filter 32 is used for transmission of a signal of the band B (B-Tx).

The filter 33 is one example of a third filter, and is a band pass filter having a pass band including the band A. One end of the filter 33 is connected to the low-noise amplifier 21. On the other hand, the other end of the filter 33 is connected to a terminal 523 of the switch circuit 52, and is switchably connected via the switch circuit 52 to each of the input/output terminals 101 and 102. In the present embodiment, the filter 33 is used for reception of a signal of the band A (A-Rx).

The filter 34 is one example of a fourth filter, and is a band pass filter having a pass band including the band B. One end of the filter 34 is connected to the low-noise amplifier 22. On the other hand, the other end of the filter 34 is connected to a terminal 524 of the switch circuit 52, and is switchably connected via the switch circuit 52 to each of the input/output terminals 101 and 102. In the present embodiment, the filter 34 is used for reception of a signal of the band B (B-Rx).

The filter 35 is one example of a fifth filter, and is a band pass filter having a pass band including the band A. One end of the filter 35 is connected to a terminal 525 of the switch circuit 52, and is switchably connected via the switch circuit 52 to each of the filters 31 and 33. On the other hand, the other end of the filter 35 is connected to the input/output terminal 101. In the present embodiment, the filter 35 is used for transmission and reception of a signal of the band A (A-Tx/Rx) in Simultaneous Rx/Tx.

The filter 36 is one example of a sixth filter, and is a band pass filter having a pass band including the band B. One end of the filter 36 is connected to a terminal 526 of the switch circuit 52, and is switchably connected via the switch circuit 52 to each of the filters 32 and 34. On the other hand, the other end of the filter 36 is connected to the input/output terminal 101. In the present embodiment, the filter 36 is used for transmission and reception of a signal of the band B (B-Tx/Rx) in Simultaneous Rx/Tx.

As each of these filters 31 to 36, a surface acoustic wave (SAW) filter, bulk acoustic wave (BAW) filter, LC filter or dielectric filter, or any combination of these may be used and, furthermore, these are not restrictive.

The switch circuit 51 is one example of a first switch circuit, and is connected between the power amplifier 11 and the filters 31 and 32. Specifically, the switch circuit 51 includes terminals 511 to 513. The terminal 511 is one example of a first terminal, and is connected to the power amplifier 11. The terminal 512 is one example of a second terminal, and is connected to the filter 31. The terminal 513 is one example of a third terminal, and is connected to the filter 32.

In this connection structure, for example, based on a control signal from the RFIC 3, the switch circuit 51 can connect the terminal 511 exclusively to the terminals 512 and 513. The switch circuit 51 is configured of, for example, an SPDT-type switch circuit.

The switch circuit 52 is one example of a second switch circuit, and is connected between the filters 31 to 34 and the input/output terminals 101 and 102. Specifically, the switch circuit 52 includes terminals 521 to 527. The terminal 521 is one example of a fourth terminal, and is connected to the filter 31. The terminal 522 is one example of a fifth terminal, and is connected to the filter 32. The terminal 523 is one example of a sixth terminal, and is connected to the filter 33. The terminal 524 is one example of a seventh terminal, and is connected to the filter 34. The terminal 525 is one example of an eighth terminal, and is connected to the filter 35 and is connected via the filter 35 to the input/output terminal 101. The terminal 526 is one example of a ninth terminal, and is connected to the filter 36 and is connected via the filter 36 to the input/output terminal 101. The terminal 527 is one example of a tenth terminal, and is connected to the input/output terminal 102 not via the filters 35 and 36.

In this connection structure, for example, based on a control signal from the RFIC 3, the switch circuit 52 can connect the terminals 521 to 524 to the terminals 525 to 527. Specifically, the terminal 521 is connected exclusively to the terminals 525 and 527, the terminal 522 is connected exclusively to the terminals 526 and 527, the terminal 523 is connected exclusively to the terminals 525 and 527, and the terminal 524 is connected exclusively to the terminals 526 and 527. The switch circuit 52 is configured of, for example, a multi-connection-type switch circuit.

[1.3 Frequency Bands] Here, specific examples of frequency bands for use in the communication device 5 according to the present embodiment are described.

The bands A and B are examples of a first band and a second band, respectively, and are defined in advance by any of standardization organizations or the like (for example, 3GPP, the Institute of Electrical and Electronics Engineers (IEEE), or the like) for a communication system constructed by using radio access technology (RAT). As examples of the communication system, a 5th Generation New Radio (5GNR) system, Long Term Evolution (LTE) system, wireless local area network (WLAN) system, and so forth can be recited.

The bands A and B each are a frequency band for TDD, and are a combination of bands capable of simultaneous transmission and reception. As a combination of the bands A and B, a combination of Band 40 for LTE (2300-2400 MHZ) or n40 for 5GNR (2300-2400 MHZ) and Band 41 for LTE (2496-2690 MHz) or n41 for 5GNR (2496-2690 MHZ) can be used. Note that in place of Band 40 for LTE or n40 for 5GNR, Band 39 for LTE (1880-1920 MHz) or n39 for 5GNR (1880-1920 MHZ) may be used. Furthermore, in place of Band 40 for LTE or n40 for 5GNR, Band 34 for LTE or n34 for 5GNR may be used, and n97 for 5GNR may be used. Note that the combination of the bands A and B is not limited to the above.

### [1.4 Connection Types in Communication Device 5]

Next, a plurality of connection types in the communication device 5 are described.

### [1.4.1 First Connection Type]

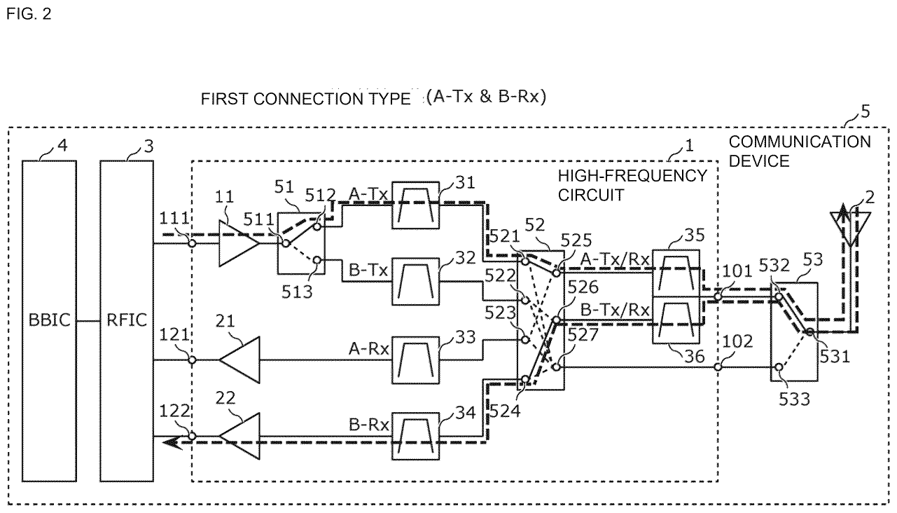

First, a first connection type is described with reference to FIG. 2. FIG. 2 is a diagram depicting the first connection type of the communication device 5 according to the present embodiment. In the drawings below, a dotted arrow represents a signal flow.

In the first connection type, transmission of a signal of the band A and reception of a signal of the band B can be simultaneously performed. That is, the first connection type is a connection type for Simultaneous Rx/Tx. As depicted in FIG. 2, in the first connection type, the switch circuit 51 connects the terminal 511 to the terminal 512, the switch circuit 52 connects the terminal 521 to the terminal 525 and connects the terminal 524 to the terminal 526, and the switch circuit 53 connects the terminal 531 to the terminal 532. With this, the filters 31 and 35 are connected to a transmission path of the band A, and the filters 34 and 36 are connected to a reception path of the band B.

As a result, the transmission signal of the band A is transferred from the RFIC 3 via the input terminal 111, the power amplifier 11, the switch circuit 51, the filter 31, the switch circuit 52, the filter 35, the input/output terminal 101, and the switch circuit 53 to the antenna 2. The reception signal of the band B is transferred from the antenna 2 via the switch circuit 53, the input/output terminal 101, the filter 36, the switch circuit 52, the filter 34, the low-noise amplifier 22, and the output terminal 122 to the RFIC 3.

### [1.4.2 Second Connection Type]

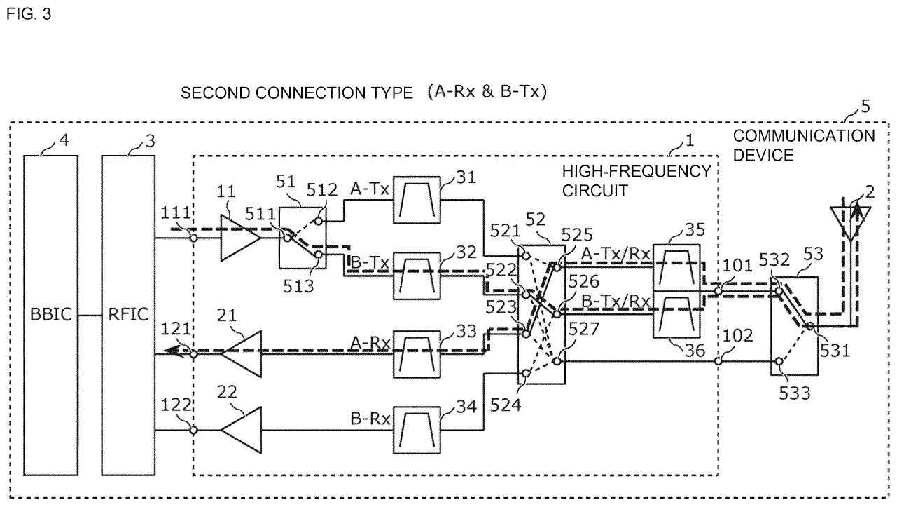

Next, a second connection type is described with reference to FIG. 3. FIG. 3 is a diagram depicting the second connection type of the communication device 5 according to the present embodiment.

In the second connection type, reception of a signal of the band A and transmission of a signal of the band B can be simultaneously performed. That is, the second connection type is a connection type for Simultaneous Rx/Tx. As depicted in FIG. 3, in the second connection type, the switch circuit 51 connects the terminal 511 to the terminal 513, the switch circuit 52 connects the terminal 522 to the terminal 526 and connects the terminal 523 to the terminal 525, and the switch circuit 53 connects the terminal 531 to the terminal 532. With this, the filters 32 and 36 are connected to a transmission path of the band B, and the filters 33 and 35 are connected to a reception path of the band A.

As a result, the transmission signal of the band B is transferred from the RFIC 3 via the input terminal 111, the power amplifier 11, the switch circuit 51, the filter 32, the switch circuit 52, the filter 36, the input/output The reception signal of the band A is transferred from the antenna 2 via the switch circuit 53, the input/output terminal 101, the filter 35, the switch circuit 52, the filter 33, the low-noise amplifier 21, and the output terminal 121 to the RFIC 3.

### [1.4.3 Third Connection Type]

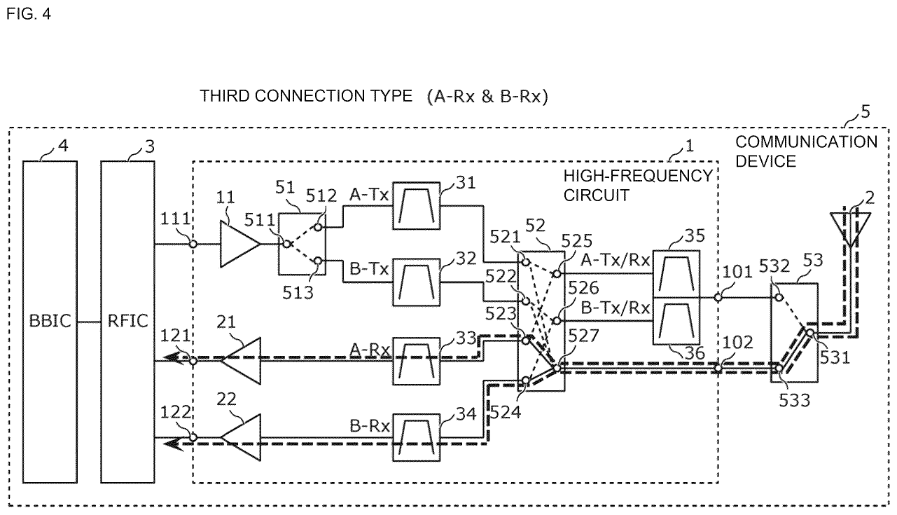

Next, a third connection type is described with reference to FIG. 4. FIG. 4 is a diagram depicting the third connection type of the communication device 5 according to the present embodiment.

In the third connection type, reception of a signal of the band A and reception of a signal of the band B can be simultaneously performed. As depicted in FIG. 4, in the third connection type, the switch circuit 52 connects the terminals 523 and 524 to the terminal 527, the switch circuit 53 connects the terminal 531 to the terminal 533. With this, the filter 33 is connected to a reception path of the band A, and the filter 34 is connected to a reception path of the band B.

As a result, the reception signal of the band A is transferred from the antenna 2 via the switch circuit 53, the input/output terminal 102, the switch circuit 52, the filter 33, the low-noise amplifier 21, and the output terminal 121 to the RFIC 3. The reception signal of the band B is transferred from the antenna 2 via the switch circuit 53, the input/output terminal 102, the switch circuit 52, the filter 34, the low-noise amplifier 22, and the output terminal 122 to the RFIC 3.

### [1.4.4 Fourth Connection Type]

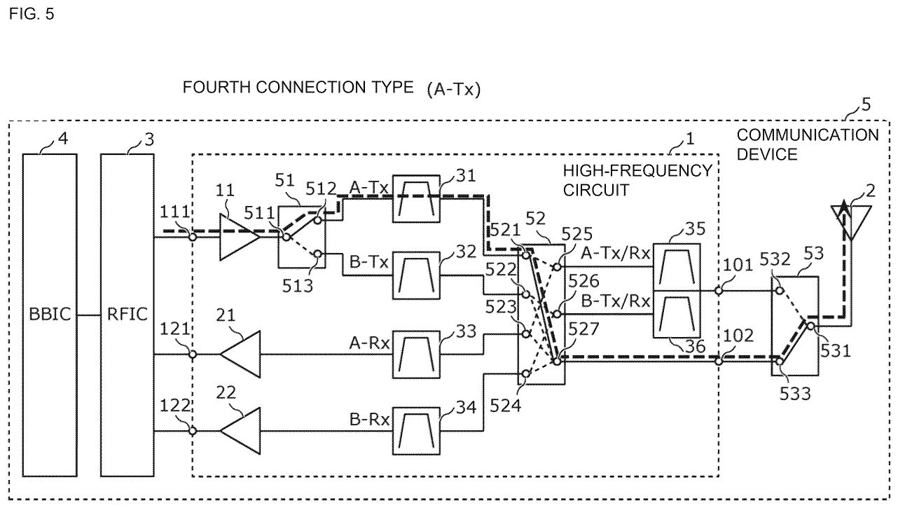

Next, a fourth connection type is described with reference to FIG. 5. FIG. 5 is a diagram depicting the fourth connection type of the communication device 5 according to the present embodiment.

In the fourth connection type, transmission of a signal of the band A can be singly performed. With a fourth connection state and a fifth connection state alternately switched, TDD of the band A is achieved. As depicted in FIG. 5, in the fourth connection type, the switch circuit 51 connects the terminal 511 to the terminal 512, the switch circuit 52 connects the terminal 521 to the terminal 527, and the switch circuit 53 connects the terminal 531 to the terminal 533. With this, the filter 31 is connected to a transmission path of the band A.

As a result, the transmission signal of the band A is transferred from the RFIC 3 via the input terminal 111, the power amplifier 11, the switch circuit 51, the filter 31, the switch circuit 52, the input/output terminal 102, and the switch circuit 53 to the antenna 2.

### [1.4.5 Fifth Connection Type]

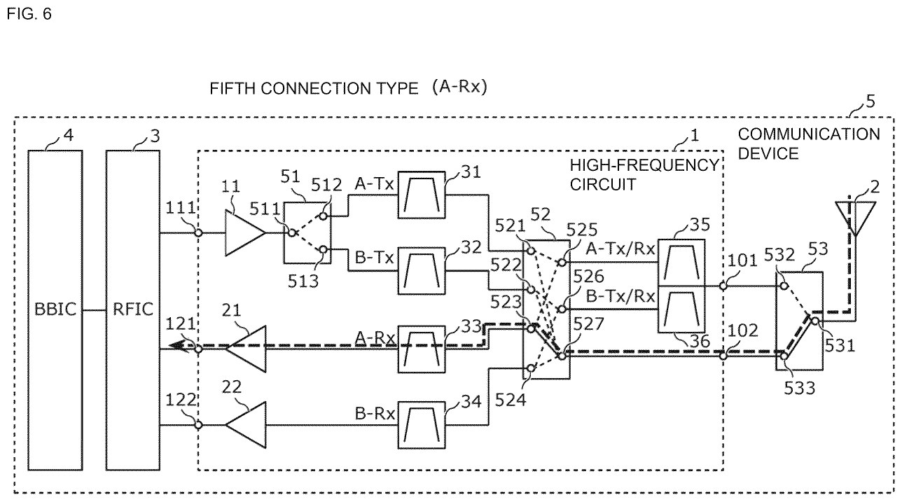

Next, a fifth connection type is described with reference to FIG. 6. FIG. 6 is a diagram depicting the fifth connection type of the communication device 5 according to the present embodiment.

In the fifth connection type, reception of a signal of the band A can be singly performed. With the fourth connection state and the fifth connection state alternately switched, TDD of the band A is achieved. As depicted in FIG. 6, in the fifth connection type, the switch circuit 52 connects the terminal 523 to the terminal 527, and the switch circuit 53 connects the terminal 531 to the terminal 533. With this, the filter 33 is connected to a reception path of the band A.

As a result, the reception signal of the band A is transferred from the antenna 2 via the switch circuit 53, the input/output terminal 102, the switch circuit 52, the filter 33, the low-noise amplifier 21, and the output terminal 121 to the RFIC 3.

### [1.4.6 Sixth Connection Type]

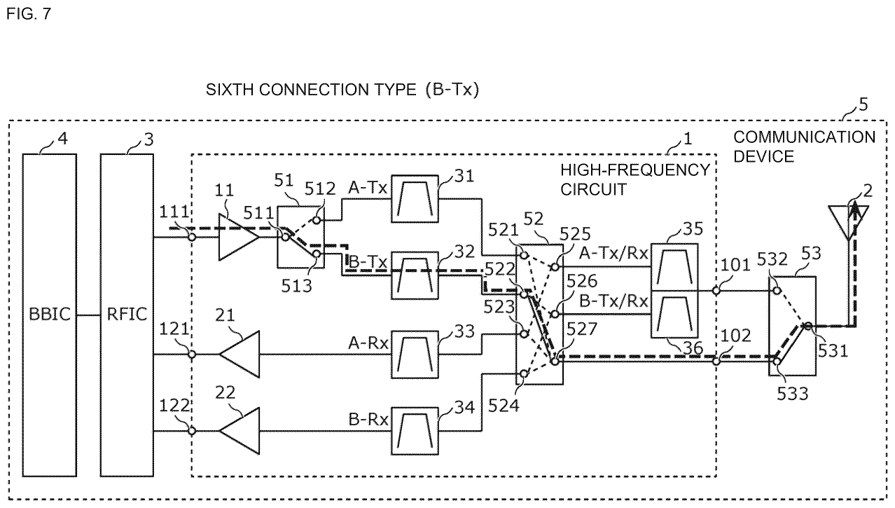

Next, a sixth connection type is described with reference to FIG. 7. FIG. 7 is a diagram depicting the sixth connection type of the communication device 5 according to the present embodiment.

In the sixth connection type, transmission of a signal of the band B can be singly performed. With a sixth connection state and a seventh connection state alternately switched, TDD of the band B is achieved. As depicted in FIG. 7, in the sixth connection type, the switch circuit 51 connects the terminal 511 to the terminal 513, the switch circuit 52 connects the terminal 522 to the terminal 527, and the switch circuit 53 connects the terminal 531 to the terminal 533. With this, the filter 32 is connected to a transmission path of the band B.

As a result, the transmission signal of the band B is transferred from the RFIC 3 via the input terminal 111, the power amplifier 11, the switch circuit 51, the filter 32, the switch circuit 52, the input/output terminal 102, and the switch circuit 53 to the antenna 2.

### [1.4.7 Seventh Connection Type]

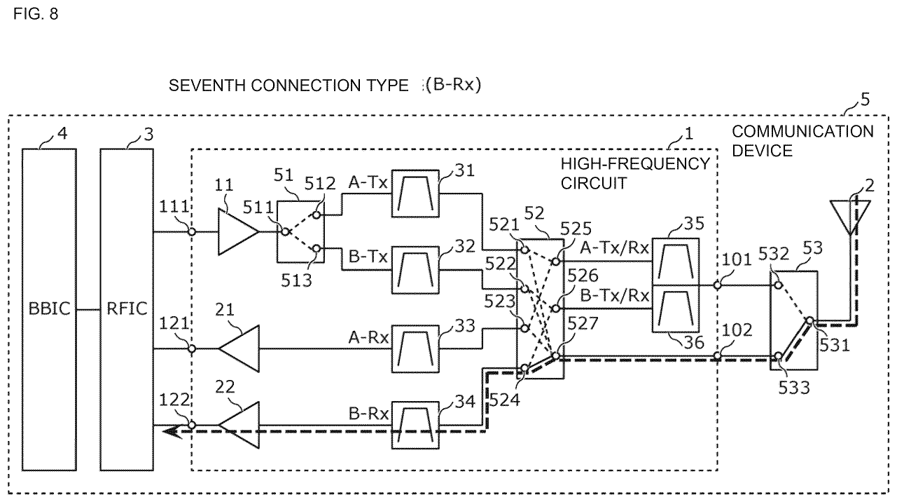

Next, a seventh connection type is described with reference to FIG. 8. FIG. 8 is a diagram depicting the seventh connection type of the communication device 5 according to the present embodiment.

In the seventh connection type, reception of a signal of the band B can be singly performed. With the sixth connection state and the seventh connection state alternately switched, TDD of the band B is achieved. As depicted in FIG. 8, in the seventh connection type, the switch circuit 52 connects the terminal 524 to the terminal 527, and the switch circuit 53 connects the terminal 531 to the terminal 533. With this, the filter 34 is connected to a reception path of the band B.

As a result, the reception signal of the band B is transferred from the antenna 2 via the switch circuit 53, the input/output terminal 102, the switch circuit 52, the filter 34, the low-noise amplifier 22, and the output terminal 122 to the RFIC 3.

### [1.5 Overview]

As described above, the high-frequency circuit 1 according to the present embodiment includes: the power amplifier 11; the low-noise amplifiers 21 and 22; the filter 31 having a pass band including the band A for TDD and switchably connected to the power amplifier 11; the filter 32 having a pass band including the band B for TDD capable of simultaneous transmission and reception with the band A and switchably connected to the power amplifier 11; the filter 33 having a pass band including the band A and connected to the low-noise amplifier 21; the filter 34 having a pass band including the band B and connected to the low-noise amplifier 22; the filter 35 having a pass band including the band A and having one end switchably connected to each of the filters 31 and 33 and the other end connected to the input/output terminal 101; the filter 36 having a pass band including the band B and having one end switchably connected to each of the filters 32 and 34 and the other end connected to the input/output terminal 101; the switch circuit 51 including the terminal 511 connected to the power amplifier 11 and the terminals 512 and 513 connected to the filters 31 and 32, respectively; and the switch circuit 52 including the terminals 521 to 526 connected to the filters 31 to 36, respectively, and the terminal 527 connected to the input/output terminal 102 not via the filters 35 and 36.

According to this, switching between a path connected via the filters 35 and 36 to the input/output terminal 101 and a path connected to the input/output terminal 102 not via the filters 35 and 36 can be made by the switch circuit 52. Therefore, in Simultaneous Rx/Tx, by connecting the filters 31 to 34 via the filters 35 and 36 to the input/output terminal 101, interference between the transmission signal of one of the bands A and B with the reception signal of the other one of the bands A and B may be suppressed, thereby improving the quality of the reception signal of the other one of the bands A and B, e.g., by increasing the electrical isolation between the transmission and reception paths. In particular, since it is difficult to sufficiently attenuate the transmission signal only with the reception filters (filters 33 and 34) for the TDD band, the effect of improving isolation between the transmission path and the reception path by the filters 35 and 36 is large. On the other hand, not in Simultaneous Rx/Tx, the filters 31 to 34 are directly connected to the input/output terminal 102 not via the filters 35 and 36, i.e., the filters 35 and 36 are bypassed. This direct path avoids a signal loss associated with the additional filters, i.e., the filters 35 and 36, thereby preserving reception sensitivity and minimizing the output power required for the power amplifier 11.

Also, for example, the high-frequency circuit 1 according to the present embodiment may further include the switch circuit 53 including the terminal 531 connected to the antenna 2, the terminal 532 connected to the input/output terminal 101, and the terminal 533 connected to the input/output terminal 102.

According to this, the connection of the antenna 2 can be switched between the input/output terminals 101 and 102, and Simultaneous Rx/Tx can be achieved with the single antenna 2.

Also, for example, in the high-frequency circuit 1 according to the present embodiment, when transmission of the band A and reception of the band B are simultaneously performed, the switch circuit 51 may connect the terminal 511 to the terminal 512, the switch circuit 52 may connect the terminal 521 to the terminal 525 and connect the terminal 524 to the terminal 526, and the switch circuit 53 may connect the terminal 531 to the terminal 532.

According to this, in Simultaneous Rx/Tx with transmission of the band A and reception of the band B, the filter 31 is connected via the filter 35 to the input/output terminal 101, and the filter 34 is connected via the filter 36 to the input/output terminal 101. Therefore, the two filters 34 and 36 may suppress entry of the transmission signal of the band A into the reception path of the band B, thereby improving the quality of the reception signal of the band B. For example, if the switch circuit 52 connects the terminals 521 and 524 to the terminal 527 to cause the filters 31 and 34 to be connected to the input/output terminal 102 not via the filters 35 and 36, i.e., bypassing the filters 35 and 36, the transmission signal of the band A leaks from the filter 34 to the low-noise amplifier 22 to degrade the quality of the reception signal of the band B. By contrast, with the filters 31 and 34 connected via the filters 35 and 36 to the input/output terminal 101, leakage of the transmission signal of the band A to the low-noise amplifier 22 is suppressed by the two filters 34 and 36, thereby allowing the quality of the reception signal of the band B to be improved.

Also, for example, in the high-frequency circuit 1 according to the present embodiment, when reception of the band A and transmission of the band B are simultaneously performed, the switch circuit 51 may connect the terminal 511 to the terminal 513, the switch circuit 52 may connect the terminal 522 to the terminal 526 and connect the terminal 523 to the terminal 525, and the switch circuit 53 may connect the terminal 531 to the terminal 532.

According to this, in Simultaneous Rx/Tx with reception of the band A and transmission of the band B, the filter 33 is connected via the filter 35 to the input/output terminal 101, and the filter 32 is connected via the filter 36 to the input/output terminal 101. Therefore, the two filters 33 and 35 may suppress entry of the transmission signal of the band B into the reception path of the band A, thereby improving the quality of the reception signal of the band A. For example, if the switch circuit 52 connects the terminals 522 and 523 to the terminal 527 to cause the filters 32 and 33 to be connected to the input/output terminal 102 not via the filters 35 and 36, the transmission signal of the band B leaks from the filter 33 to the low-noise amplifier 21 to degrade the quality of the reception signal of the band A. By contrast, with the filters 32 and 33 connected via the filters 35 and 36 to the input/output terminal 101, leakage of the transmission signal of the band B to the low-noise amplifier 21 is suppressed by the two filters 33 and 35, thereby allowing the quality of the reception signal of the band A to be improved.

Also, for example, in the high-frequency circuit 1 according to the present embodiment, when reception of the band A and reception of the band B are simultaneously performed, the switch circuit 52 may connect the terminal 523 and the terminal 524 to the terminal 527, and the switch circuit 53 may connect the terminal 531 to the terminal 533.

According to this, in simultaneous reception of the bands A and B, the filters 33 and 34 are connected to the input/output terminal 102 not via the filters 35 and 36. Therefore, a loss of the reception signal by the filters 35 and 36 can be avoided, and a decrease in reception sensitivity in simultaneous reception of the bands A and B can be suppressed.

Also, for example, in the high-frequency circuit 1 according to the present embodiment, a combination of the bands A and B may be a combination of Band 40 for LTE or n40 for 5GNR and Band 41 for LTE or n41 for 5GNR or a combination of Band 39 for LTE or n39 for 5GNR and Band 41 for LTE or n41 for 5GNR.

According to this, in an LTE or 5GNR communication network, the quality of the reception signal at Simultaneous Rx/Tx can be improved.

Also, the communication device 5 according to the present embodiment includes the RFIC 3 that processes a high-frequency signal and the high-frequency circuit 1 that transfers the high-frequency signal between the RFIC 3 and the antenna 2.

According to this, effects similar to those of the high-frequency circuit 1 can be achieved by the communication device 5.

### Second Embodiment

Next, a second embodiment is described. The present embodiment is different from the above-described first embodiment mainly in that the high-frequency circuit 1 is configured to be able to use the filters 31 and 32 each as not only a transmission filter but also a reception filter. In the following, the point of the present embodiment that is different from the above-described first embodiment is mainly described with reference to the drawings.

### [2.1 Circuit Structure of High-Frequency Circuit 1A]

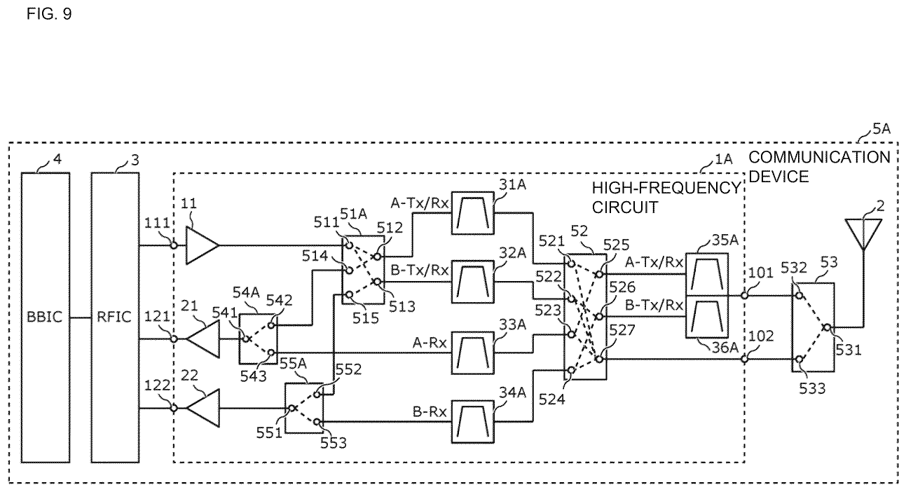

The circuit structure of a high-frequency circuit 1A according to the present embodiment is described with reference to FIG. 9. FIG. 9 is a circuit structure diagram of a communication device 5A according to the present embodiment.

Note that FIG. 9 is an exemplary circuit structure and the communication device 5A and the high-frequency circuit 1A can be implemented by using any of various circuit implementations or circuit technologies. Therefore, description of the communication device 5A and the high-frequency circuit 1A provided below is not restrictive.

The communication device 5A according to the present embodiment is similar to the communication device 5 according to the first embodiment except that it includes the high-frequency circuit 1A in place of the high-frequency circuit 1, and its description is therefore not repeated.

The high-frequency circuit 1A according to the present embodiment includes: the power amplifier 11; the low-noise amplifiers 21 and 22; filters 31A to 36A; switch circuits 51A, 52, 54A, and 55A; the input/output terminals 101 and 102; the input terminal 111; and the output terminals 121 and 122.

The filter 31A is one example of the first filter, and is a band pass filter having a pass band including the band A. One end of the filter 31A is connected to the terminal 512 of the switch circuit 51A, is switchably connected via the switch circuit 51A to the power amplifier 11, and is switchably connected via the switch circuits 51A and 54A to the low-noise amplifier 21. On the other hand, the other end of the filter 31A is connected to the terminal 521 of the switch circuit 52, and is switchably connected via the switch circuit 52 to each of the input/output terminals 101 and 102. In the present embodiment, the filter 31A is used for transmission and reception of the band A (A-Tx/Rx).

The filter 32A is one example of the second filter, and is a band pass filter having a pass band including the band B. One end of the filter 32A is connected to the terminal 513 of the switch circuit 51A, is switchably connected via the switch circuit 51A to the power amplifier 11, and is switchably connected via the switch circuits 51A and 55A to the low-noise amplifier 22. On the other hand, the other end of the filter 32A is connected to the terminal 522 of the switch circuit 52, and is switchably connected via the switch circuit 52 to each of the input/output terminals 101 and 102. In the present embodiment, the filter 32A is used for transmission and reception of the band B (B-Tx/Rx).

The filter 33A is one example of the third filter, and is a band pass filter having a pass band including the band A. One end of the filter 33A is connected to a terminal 543 of the switch circuit 54A, and is switchably connected via the switch circuit 54A to the low-noise amplifier 21. On the other hand, the other end of the filter 33A is connected to the terminal 523 of the switch circuit 52, and is switchably connected via the switch circuit 52 to each of the input/output terminals 101 and 102. In the present embodiment, the filter 33A is used for reception of the band A (A-Rx) in Simultaneous Rx/Tx. Note that the filter 33A is not limited to a band pass filter. For example, the filter 33A may be a high pass filter or low pass filter.

The filter 34A is one example of the fourth filter, and is a band pass filter having a pass band including the band B. One end of the filter 34A is connected to a terminal 553 of the switch circuit 55A, and is switchably connected via the switch circuit 55A to the low-noise amplifier 22. On the other hand, the other end of the filter 34A is connected to the terminal 524 of the switch circuit 52, and is switchably connected via the switch circuit 52 to each of the input/output terminals 101 and 102. In the present embodiment, the filter 34A is used for reception of the band B (B-Rx) in Simultaneous Rx/Tx. Note that the filter 34A is not limited to a band pass filter. For example, the filter 34A may be a high pass filter or low pass filter.

The filter 35A is one example of the fifth filter, and is a band pass filter having a pass band including the band A. One end of the filter 35A is connected to the terminal 525 of the switch circuit 52, and is switchably connected via the switch circuit 52 to each of the filters 31A and 33A. On the other hand, the other end of the filter 35A is connected to the input/output terminal 101. In the present embodiment, the filter 35A is used for transmission and reception of the band A (A-Tx/Rx) in Simultaneous Rx/Tx.

The filter 36A is one example of the sixth filter, and is a band pass filter having a pass band including the band B. One end of the filter 36A is connected to the terminal 526 of the switch circuit 52, and is switchably connected via the switch circuit 52 to each of the filters 32A and 34A. On the other hand, the other end of the filter 36A is connected to the input/output terminal 101. In the present embodiment, the filter 36A is used for transmission and reception of the band B (B-Tx/Rx) in Simultaneous Rx/Tx.

As each of these filters 31A to 36A, a SAW filter, BAW filter, LC filter or dielectric filter, or any combination of these may be used and, furthermore, these are not restrictive. In particular, in the present embodiment, since the filters 33A and 34A are used for attenuation of a transmission signal in Simultaneous Rx/Tx, an LC filter can be used as each of the filters 33A and 34A. In this case, as the filters 35A and 36A, it is desirable to use an acoustic wave filter including an inductor, a capacitor, and an acoustic wave resonator.

The switch circuit 51A is one example of the first switch circuit, and includes terminals 514 and 515 in addition to the terminals 511 to 513. The terminal 514 is one example of a fourteenth terminal, and is connected to the terminal 542 of the switch circuit 54A and is switchably connected via the switch circuit 54A to the low-noise amplifier 21. The terminal 515 is one example of a fifteenth terminal, and is connected to a terminal 552 of the switch circuit 55A and is switchably connected via the switch circuit 55A to the low-noise amplifier 22.

In this connection structure, for example, based on a control signal from the RFIC 3, as with the switch circuit 51 of the first embodiment, the switch circuit 51A can connect the terminal 511 exclusively to the terminals 512 and 513. Furthermore, in the present embodiment, the switch circuit 51A can connect the terminal 512 exclusively to the terminals 511 and 514 and can connect the terminal 513 to the terminals 511 and 515. The switch circuit 51A is configured of, for example, a multi-connection-type switch circuit.

The switch circuit 54A is one example of a fourth switch circuit, and is connected between the low-noise amplifier 21 and the filters 31A and 33A. Specifically, the switch circuit 54A includes terminals 541 to 543. The terminal 541 is one example of a sixteenth terminal, and is connected to the low-noise amplifier 21. The terminal 542 is one example of a seventeenth terminal, and is connected to the terminal 514 of the switch circuit 51A and is switchably connected via the switch circuit 51A to the filter 31A. The terminal 543 is one example of an eighteenth terminal, and is connected to the filter 33A.

In this connection structure, for example, based on a control signal from the RFIC 3, the switch circuit 54A can connect the terminal 541 exclusively to the terminals 542 and 543. The switch circuit 54A is configured of, for example, an SPDT-type switch circuit.

The switch circuit 55A is one example of a fifth switch circuit, and is connected between the low-noise amplifier 22 and the filters 32A and 34A. Specifically, the switch circuit 55A includes terminals 551 to 553. The terminal 551 is one example of a nineteenth terminal, and is connected to the low-noise amplifier 22. The terminal 552 is one example of a twentieth terminal, and is connected to the terminal 515 of the switch circuit 51A and is switchably connected via the switch circuit 51A to the filter 32A. The terminal 553 is one example of a twenty-first terminal, and is connected to the filter 34A.

In this connection structure, for example, based on a control signal from the RFIC 3, the switch circuit 55A can connect the terminal 551 exclusively to the terminals 552 and 553. The switch circuit 55A is configured of, for example, an SPDT-type switch circuit.

### [2.2 Connection Types in Communication Device 5A]

Next, a plurality of connection types in the communication device 5A are described.

### [2.2.1 First Connection Type]

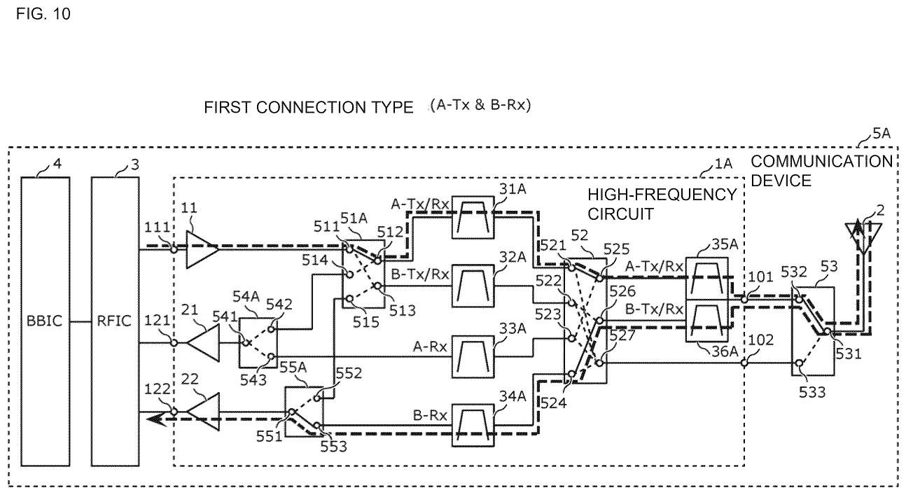

First, a first connection type is described with reference to FIG. 10. FIG. 10 is a diagram depicting the first connection type of the communication device 5A according to the present embodiment.

In the first connection type, transmission of a signal of the band A and reception of a signal of the band B can be simultaneously performed. That is, the first connection type is a connection type for Simultaneous Rx/Tx. As depicted in FIG. 10, in the first connection type, the switch circuit 51A connects the terminal 511 to the terminal 512, the switch circuit 52 connects the terminal 521 to the terminal 525 and connects the terminal 524 to the terminal 526, the switch circuit 53 connects the terminal 531 to the terminal 532, and the switch circuit 55A connects the terminal 551 to the terminal 553. With this, the filters 31A and 35A are connected to a transmission path of the band A, and the filters 34A and 36A are connected to a reception path of the band B.

As a result, the transmission signal of the band A is transferred from the RFIC 3 via the input terminal 111, the power amplifier 11, the switch circuit 51A, the filter 31A, the switch circuit 52, the filter 35A, the input/output terminal 101, and the switch circuit 53 to the antenna 2. The reception signal of the band B is transferred from the antenna 2 via the switch circuit 53, the input/output terminal 101, the filter 36A, the switch circuit 52, the filter 34A, the switch circuit 55A, the low-noise amplifier 22, and the output terminal 122 to the RFIC 3.

### [2.2.2 Second Connection Type]

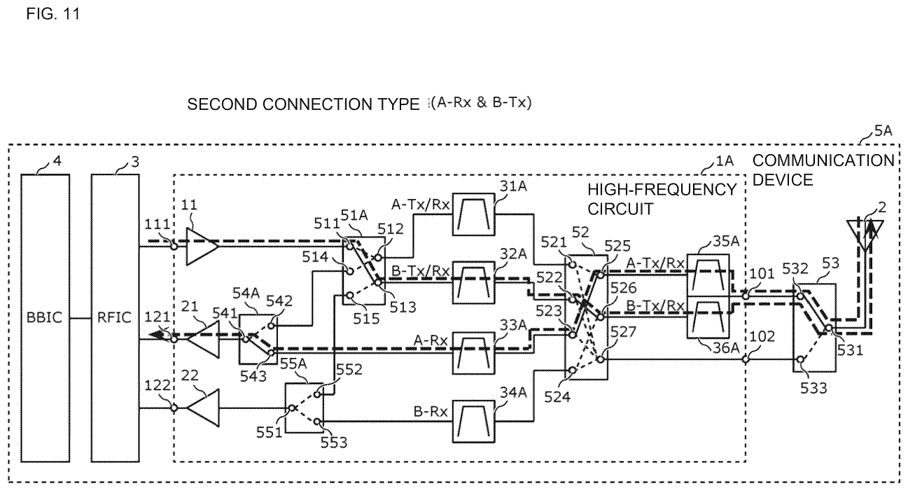

Next, a second connection type is described with reference to FIG. 11. FIG. 11 is a diagram depicting the second connection type of the communication device 5A according to the present embodiment.

In the second connection type, reception of a signal of the band A and transmission of a signal of the band B can be simultaneously performed. That is, the second connection type is a connection type for Simultaneous Rx/Tx. As depicted in FIG. 11, in the second connection type, the switch circuit 51A connects the terminal 511 to the terminal 513, the switch circuit 52 connects the terminal 522 to the terminal 526 and connects the terminal 523 to the terminal 525, the switch circuit 53 connects the terminal 531 to the terminal 532, and the switch circuit 54A connects the terminal 541 to the terminal 543. With this, the filters 32A and 36A are connected to a transmission path of the band B, and the filters 33A and 35A are connected to a reception path of the band A.

As a result, the transmission signal of the band B is transferred from the RFIC 3 via the input terminal 111, the power amplifier 11, the switch circuit 51A, the filter 32A, the switch circuit 52, the filter 36A, the input/output The reception signal of the band A is transferred from the antenna 2 via the switch circuit 53, the input/output terminal 101, the filter 35A, the switch circuit 52, the filter 33A, the switch circuit 54A, the low-noise amplifier 21, and the output terminal 121 to the RFIC 3.

### [2.2.3 Third Connection Type]

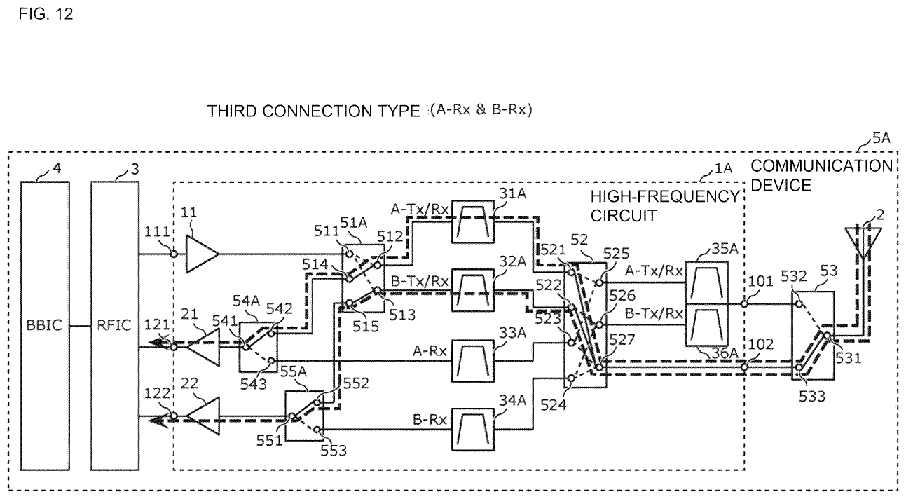

Next, a third connection type is described with reference to FIG. 12. FIG. 12 is a diagram depicting the third connection type of the communication device 5A according to the present embodiment.

In the third connection type, reception of a signal of the band A and reception of a signal of the band B can be simultaneously performed. As depicted in FIG. 12, in the third connection type, the switch circuit 51A connects the terminal 512 to the terminal 514 and connects the terminal 513 to the terminal 515, the switch circuit 52 connects the terminals 521 and 522 to the terminal 527, the switch circuit 53 connects the terminal 531 to the terminal 533, the switch circuit 54A connects the terminal 541 to the terminal 542, and the switch circuit 55A connects the terminal 551 to the terminal 552. With this, the filter 31A is connected to a reception path of the band A, and the filter 32A is connected to a reception path of the band B.

As a result, the reception signal of the band A is transferred from the antenna 2 via the switch circuit 53, the input/output terminal 102, the switch circuit 52, the filter 31A, the switch circuits 51A and 54A, the low-noise amplifier 21, and the output terminal 121 to the RFIC 3. The reception signal of the band B is transferred from the antenna 2 via the switch circuit 53, the input/output terminal 102, the switch circuit 52, the filter 32A, the switch circuits 51A and 55A, the low-noise amplifier 22, and the output terminal 122 to the RFIC 3.

In this manner, in the present embodiment, the filters 31A and 32A are used as reception filters of the band A and the band B, respectively, in simultaneous reception of the band A and the band B.

### [2.2.4 Fourth Connection Type]

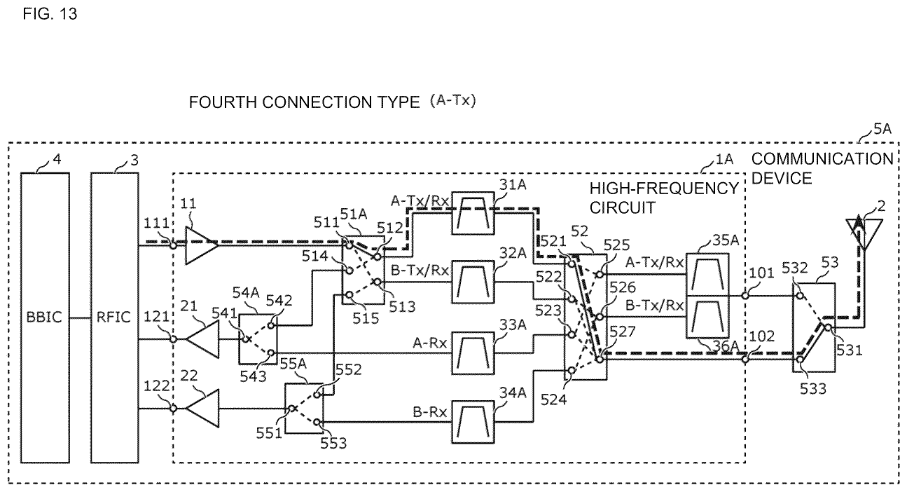

Next, a fourth connection type is described with reference to FIG. 13. FIG. 13 is a diagram depicting the fourth connection type of the communication device 5A according to the present embodiment.

In the fourth connection type, transmission of a signal of the band A can be singly performed. With a fourth connection state and a fifth connection state alternately switched, TDD of the band A is achieved. As depicted in FIG. 13, in the fourth connection type, the switch circuit 51A connects the terminal 511 to the terminal 512, the switch circuit 52 connects the terminal 521 to the terminal 527, and the switch circuit 53 connects the terminal 531 to the terminal 533. With this, the filter 31A is connected to a transmission path of the band A.

As a result, the transmission signal of the band A is transferred from the RFIC 3 via the input terminal 111, the power amplifier 11, the switch circuit 51A, the filter 31A, the switch circuit 52, the input/output terminal 102, and the switch circuit 53 to the antenna 2.

### [2.2.5 Fifth Connection Type]

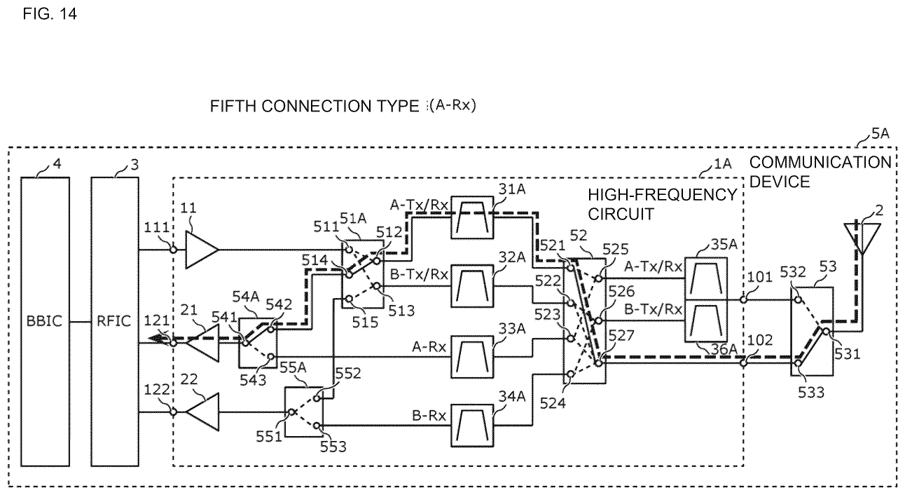

Next, a fifth connection type is described with reference to FIG. 14. FIG. 14 is a diagram depicting the fifth connection type of the communication device 5A according to the present embodiment.

In the fifth connection type, reception of a signal of the band A can be singly performed. With the fourth connection state and the fifth connection state alternately switched, TDD of the band A is achieved. As depicted in FIG. 14, in the fifth connection type, the switch circuit 51A connects the terminal 512 to the terminal 514, the switch circuit 52 connects the terminal 521 to the terminal 527, the switch circuit 53 connects the terminal 531 to the terminal 533, and the switch circuit 54A connects the terminal 541 to the terminal 542. With this, the filter 31A is connected to a reception path of the band A.

As a result, the reception signal of the band A is transferred from the antenna 2 via the switch circuit 53, the input/output terminal 102, the switch circuit 52, the filter 31A, the switch circuits 51A and 54A, the low-noise amplifier 21, and the output terminal 121 to the RFIC 3.

In this manner, in the present embodiment, the filter 31A is used as a reception filter of the band A in single reception of the band A.

### [2.2.6 Sixth Connection Type]

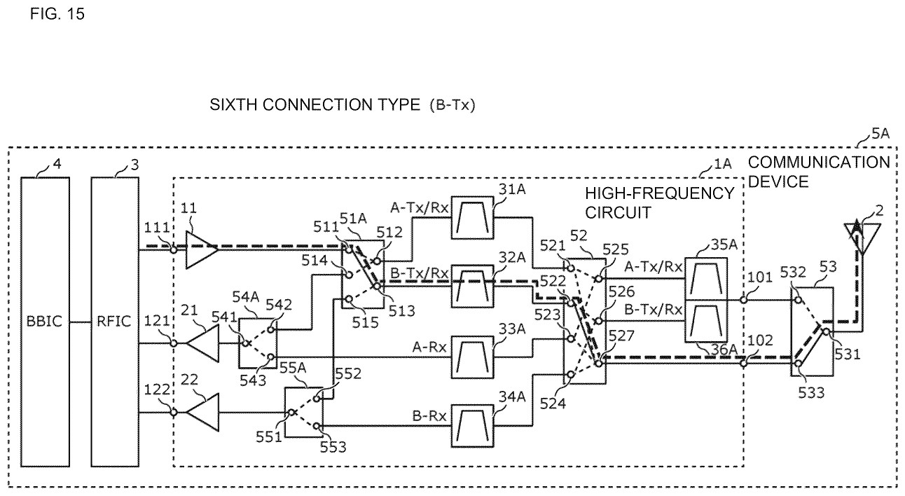

Next, a sixth connection type is described with reference to FIG. 15. FIG. 15 is a diagram depicting the sixth connection type of the communication device 5A according to the present embodiment.

In the sixth connection type, transmission of a signal of the band B can be singly performed. With a sixth connection state and a seventh connection state alternately switched, TDD of the band B is achieved. As depicted in FIG. 15, in the sixth connection type, the switch circuit 51A connects the terminal 511 to the terminal 513, the switch circuit 52 connects the terminal 522 to the terminal 527, and the switch circuit 53 connects the terminal 531 to the terminal 533. With this, the filter 32A is connected to a transmission path of the band B.

As a result, the transmission signal of the band B is transferred from the RFIC 3 via the input terminal 111, the power amplifier 11, the switch circuit 51A, the filter 32A, the switch circuit 52, the input/output terminal 102, and the switch circuit 53 to the antenna 2.

### [2.2.7 Seventh Connection Type]

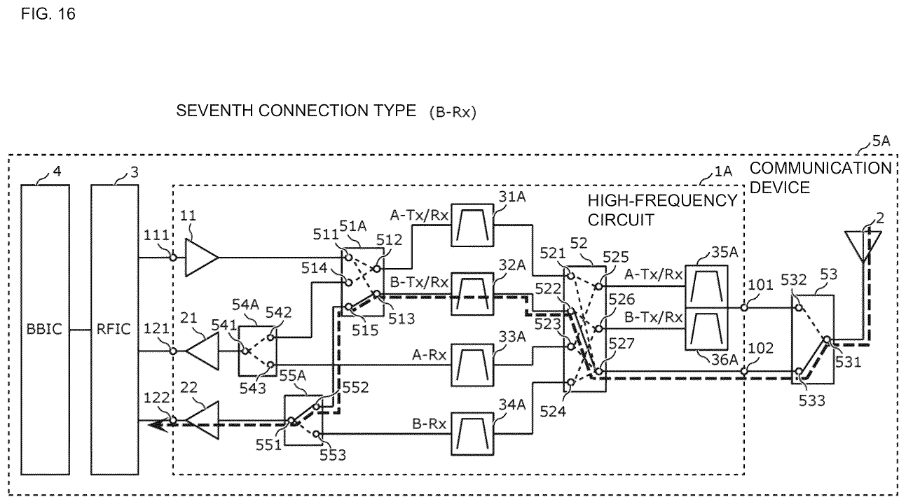

Next, a seventh connection type is described with reference to FIG. 16. FIG. 16 is a diagram depicting the seventh connection type of the communication device 5A according to the present embodiment.

In the seventh connection type, reception of a signal of the band B can be singly performed. With the sixth connection state and the seventh connection state alternately switched, TDD of the band B is achieved. As depicted in FIG. 16, in the seventh connection type, the switch circuit 51A connects the terminal 513 to the terminal 515, the switch circuit 52 connects the terminal 522 to the terminal 527, the switch circuit 53 connects the terminal 531 to the terminal 533, and the switch circuit 55A connects the terminal 551 to the terminal 552. With this, the filter 32A is connected to a reception path of the band B.

As a result, the reception signal of the band B is transferred from the antenna 2 via the switch circuit 53, the input/output terminal 102, the switch circuit 52, the filter 32A, the switch circuits 51A and 55A, the low-noise amplifier 22, and the output terminal 122 to the RFIC 3.

In this manner, in the present embodiment, the filter 32A is used as a reception filter of the band B in single reception of the band B.

### [2.3 Overview]

As described above, the high-frequency circuit 1A according to the present embodiment includes: the power amplifier 11; the low-noise amplifiers 21 and 22; the filter 31A having a pass band including the band A for TDD and switchably connected to the power amplifier 11; the filter 32A having a pass band including the band B for TDD capable of simultaneous transmission and reception with the band A and switchably connected to the power amplifier 11; the filter 33A having a pass band including the band A and connected to the low-noise amplifier 21; the filter 34A having a pass band including the band B and connected to the low-noise amplifier 22; the filter 35A having a pass band including the band A and having one end switchably connected to each of the filters 31A and 33A and the other end connected to the input/output terminal 101; the filter 36A having a pass band including the band B and having one end switchably connected to each of the filters 32A and 34A and the other end connected to the input/output terminal 101; the switch circuit 51A including the terminal 511 connected to the power amplifier 11, the terminals 512 and 513 connected to the filters 31A and 32A, respectively, and the terminals 514 and 515; the switch circuit 52 including the terminals 521 to 526 connected to the filters 31A to 36A, respectively, and the terminal 527 connected to the input/output terminal 102 not via the filters 35A and 36A; the switch circuit 53 including the terminal 531 connected to the antenna 2, the terminal 532 connected to the input/output terminal 101, and the terminal 533 connected to the input/output terminal 102; the switch circuit 54A including the terminal 541 connected to the low-noise amplifier 21, the terminal 542 connected to the terminal 514, and the terminal 543 connected to the filter 33A; and the switch circuit 55A including the terminal 551 connected to the low-noise amplifier 22, the terminal 552 connected to the terminal 515, and the terminal 553 connected to the filter 34A.

According to this, as with the high-frequency circuit 1 according to the first embodiment, the quality of the reception signal can be improved in Simultaneous Rx/Tx, and an increase in output power in the power amplifier and a decrease in reception sensitivity can be suppressed not in Simultaneous Rx/Tx. Furthermore, in the high-frequency circuit 1A according to the present embodiment, the filter 31A can be connected via the switch circuits 51A and 54A to the low-noise amplifier 21, and the filter 32A can be connected via the switch circuits 51A and 55A to the low-noise amplifier 22. Therefore, not in Simultaneous Rx/Tx, the filters 31A and 32A can be each used for reception of the bands A and B, and thus the performance required for the filters 33A and 34A can be mitigated, and the filters 33A and 34A can be downsized. Also, even if distortion occurring at the power amplifier 11 due to isolation insufficiency between the terminals 511 and 514 of the switch circuit 51A leaks to the switch circuit 54A, leakage of distortion to the reception path can be attenuated at the switch circuit 54A, and the quality of the reception signal can be improved. Similarly, even if distortion occurring at the power amplifier 11 due to isolation insufficiency between the terminals 511 and 515 of the switch circuit 51A leaks to the switch circuit 55A, leakage of distortion to the reception path can be attenuated at the switch circuit 55A, and the quality of the reception signal can be improved.

Also, for example, in the high-frequency circuit 1A according to the present embodiment, when transmission of the band A and reception of the band B are simultaneously performed, the switch circuit 51A may connect the terminal 511 to the terminal 512, the switch circuit 52 may connect the terminal 521 to the terminal 525 and connect the terminal 524 to the terminal 526, the switch circuit 53 may connect the terminal 531 to the terminal 532, and the switch circuit 55A may connect the terminal 551 to the terminal 553.

According to this, in Simultaneous Rx/Tx with transmission of the band A and reception of the band B, the filter 31A is connected via the filter 35A to the input/output terminal 101, and the filter 34A is connected via the filter 36A to the input/output terminal 101. Therefore, the two filters 34A and 36A may suppress entry of the transmission signal of the band A into the reception path of the band B, thereby improving the quality of the reception signal of the band B. For example, if the switch circuit 52 connects the terminals 521 and 524 to the terminal 527 to cause the filters 31A and 34A to be connected to the input/output terminal 102 not via the filters 35A and 36A, the transmission signal of the band A leaks from the filter 34A to the low-noise amplifier 22 to degrade the quality of the reception signal of the band B. By contrast, with the filters 31A and 34A connected via the filters 35A and 36A to the input/output terminal 101, leakage of the transmission signal of the band A to the low-noise amplifier 22 is suppressed by the two filters 34A and 36A, thereby allowing the quality of the reception signal of the band B to be improved.

Also, for example, in the high-frequency circuit 1A according to the present embodiment, when reception of the band A and transmission of the band B are simultaneously performed, the switch circuit 51A may connect the terminal 511 to the terminal 513, the switch circuit 52 may connect the terminal 522 to the terminal 526 and connect the terminal 523 to the terminal 525, the switch circuit 53 may connect the terminal 531 to the terminal 532, and the switch circuit 54A may connect the terminal 541 to the terminal 543.

According to this, in Simultaneous Rx/Tx with reception of the band A and transmission of the band B, the filter 33A is connected via the filter 35A to the input/output terminal 101, and the filter 32A is connected via the filter 36A to the input/output terminal 101. Therefore, the two filters 33A and 35A may suppress entry of the transmission signal of the band B into the reception path of the band A, thereby allowing the quality of the reception signal of the band A to be improved. For example, if the switch circuit 52 connects the terminals 522 and 523 to the terminal 527 to cause the filters 32A and 33A to be connected to the input/output terminal 102 not via the filters 35A and 36A, the transmission signal of the band B leaks from the filter 33A to the low-noise amplifier 21 to degrade the quality of the reception signal of the band A. By contrast, with the filters 32A and 33A connected via the filters 35A and 36A to the input/output terminal 101, leakage of the transmission signal of the band B to the low-noise amplifier 21 is suppressed by the two filters 33A and 35A, thereby allowing the quality of the reception signal of the band A to be improved.

Also, for example, in the high-frequency circuit 1A according to the present embodiment, when reception of the band A and reception of the band B are simultaneously performed, the switch circuit 51A may connect the terminal 512 to the terminal 514 and connect the terminal 513 to the terminal 515, the switch circuit 52 may connect the terminals 521 and 522 to the terminal 527, the switch circuit 53 may connect the terminal 531 to the terminal 533, the switch circuit 54A may connect the terminal 541 to the terminal 542, and the switch circuit 55A may connect the terminal 551 to the terminal 552.

According to this, in simultaneous reception of the bands A and B, the filters 31A and 32A are connected to the input/output terminal 102 not via the filters 35A and 36A. Therefore, a loss of the reception signal by the filters 35A and 36A can be avoided, and a decrease in reception sensitivity in simultaneous reception of the bands A and B can be suppressed. Furthermore, the filters 31A and 32A can be each used for reception of the bands A and B, and thus the performance required for the filters 33A and 34A can be mitigated, and the filters 33A and 34A can be downsized.

Also, for example, in the high-frequency circuit 1A according to the present embodiment, a combination of the band A and the band B may be a combination of Band 40 for LTE or n40 for 5GNR and Band 41 for LTE or n41 for 5GNR or a combination of Band 39 for LTE or n39 for 5GNR and Band 41 for LTE or n41 for 5GNR.

According to this, in an LTE or 5GNR communication network, the quality of the reception signal at Simultaneous Rx/Tx can be improved.

Also, for example, in the high-frequency circuit 1A according to the present embodiment, at least one of the filters 35A and 36A may be an acoustic wave filter including an inductor, a capacitor, and an acoustic wave resonator.

According to this, the attenuation characteristics near the pass band can be improved by the acoustic wave resonator, and the attenuation characteristics away from the pass band can be improved by the inductor and the capacitor. Thus, the characteristics of the filter 35A and/or 36A can be improved.

Also, for example, in the high-frequency circuit 1A according to the present embodiment, at least one of the filters 33A and 34A may be an LC filter.

According to this, the filter 33A and/or 34A can be downsized.

Also, the communication device 5A according to the present embodiment includes the RFIC 3 that processes a high-frequency signal and the high-frequency circuit 1A that transfers the high-frequency signal between the RFIC 3 and the antenna 2.

According to this, effects similar to those of the high-frequency circuit 1A can be achieved by the communication device 5A.

### Third Embodiment

Next, a third embodiment is described. The present embodiment is different from each of the above-described embodiments mainly in that a filter for another frequency band is included in the high-frequency circuit. In the following, the point of the present embodiment that is different from the above-described second embodiment is mainly described with reference to the drawings.

### [3.1 Circuit Structure of High-Frequency Circuit 1B]

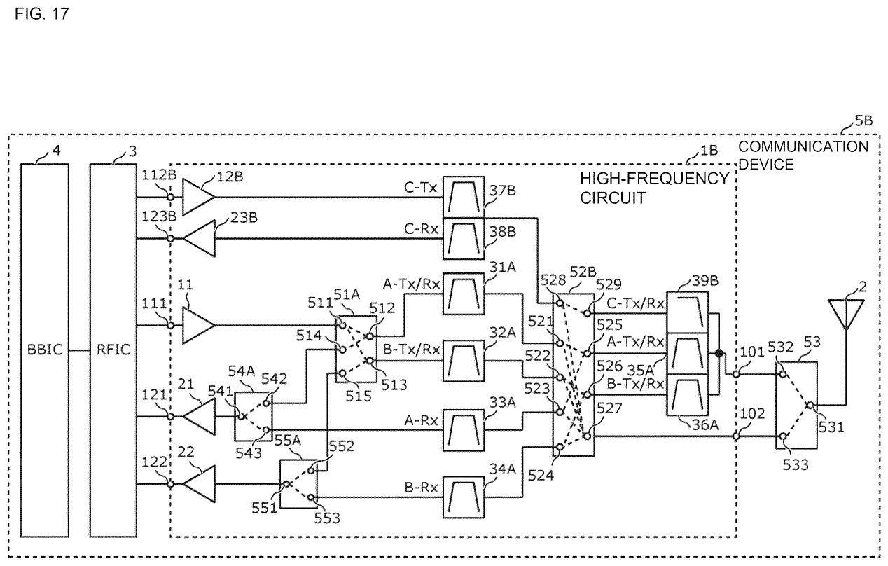

The circuit structure of a high-frequency circuit 1B according to the present embodiment is described with reference to FIG. 17. FIG. 17 is a circuit structure diagram of a communication device 5B according to the present embodiment.

Note that FIG. 17 is an exemplary circuit structure and the communication device 5B and the high-frequency circuit 1B can be implemented by using any of various circuit implementations or circuit technologies. Therefore, description of the communication device 5B and the high-frequency circuit 1B provided below is not restrictive.

The communication device 5B according to the present embodiment is similar to the communication device 5A according to the second embodiment except that it includes the high-frequency circuit 1B in place of the high-frequency circuit 1A, and its description is therefore not repeated.

The high-frequency circuit 1B according to the present embodiment includes: power amplifiers 11 and 12B; low-noise amplifiers 21, 22, and 23B; filters 31A to 36A and 37B to 39B, switch circuits 51A, 52B, 54A, and 55A; the input/output terminals 101 and 102; input terminals 111 and 112B; and output terminals 121, 122, and 123B.

The input terminal 112B is an external connection terminal of the high-frequency circuit 1B, and is a high-frequency input terminal. The input terminal 112B is connected to the RFIC 3 outside the high-frequency circuit 1B, and is connected to the power amplifier 12B inside the high-frequency circuit 1B. The input terminal 112B can receive a transmission signal of a band C from the RFIC 3.

The output terminal 123B is an external connection terminal of the high-frequency circuit 1B, and is a high-frequency output terminal. The output terminal 123B is connected to the RFIC 3 outside the high-frequency circuit 1B, and is connected to the low-noise amplifier 23B inside the high-frequency circuit 1B. The output terminal 123B can supply a reception signal of the band C to the RFIC 3.

The power amplifier 12B is one example of a second power amplifier. The input end of the power amplifier 12B is connected to the input terminal 112B. The output end of the power amplifier 12B is connected to the filter 37B. By using electric power supplied from a power supply (not depicted), the power amplifier 12B can amplify the transmission signal of the band C supplied from the RFIC 3 via the input terminal 112B.

The low-noise amplifier 23B is one example of a third low-noise amplifier. The input end of the low-noise amplifier 23B is connected to the filter 38B. The output end of the low-noise amplifier 23B is connected to the output terminal 123B. By using electric power supplied from a power supply (not depicted), the low-noise amplifier 23B can amplify a reception signal of the band C passing through the filter 38B.

The filter 37B is one example of a seventh filter, and is a band pass filter having a pass band including the transmission band of the band C. One end of the filter 37B is connected to the power amplifier 12B. On the other hand, the other end of the filter 37B is connected to a terminal 528 of the switch circuit 52B, and is switchably connected via the switch circuit 52B to each of the input/output terminals 101 and 102. The filter 37B is used for transmission of a signal of the band C (C-Tx).

The filter 38B is one example of an eighth filter, and is a band pass filter having a pass band including the reception band of the band C. One end of the filter 38B is connected to the low-noise amplifier 23B. On the other hand, the other end of the filter 38B is connected to the terminal 528 of the switch circuit 52B, and is switchably connected via the switch circuit 52B to each of the input/output terminals 101 and 102. The filter 38B is used for reception of a signal of the band C (C-Rx).

The filter 39B is one example of a ninth filter, and is a low pass filter having a pass band including the transmission band and the reception band of the band C. One end of the filter 39B is connected to a terminal 529 of the switch circuit 52B, and is switchably connected via the switch circuit 52B to the filters 37B and 38B. On the other hand, the other end of the filter 39B is connected to the input/output terminal 101. In the present embodiment, the filter 39B is used for transmission and reception of a signal of the band C (C-Tx/Rx) in Simultaneous Rx/Tx.

As each of the filters 37B to 39B, a SAW filter, BAW filter, LC filter or dielectric filter, or any combination of these may be used and, furthermore, these are not restrictive.

The switch circuit 52B is one example of the second switch circuit, and includes the terminals 528 and 529 in addition to the terminals 521 to 527. The terminal 528 is one example of a twenty-second terminal, and is connected to the filters 37B and 38B. The terminal 529 is one example of a twenty-third terminal, and is connected to the filter 39B.

In this connection structure, for example, based on a control signal from the RFIC 3, as with the switch circuit 52 of each of the above-described embodiments, the switch circuit 52B can connect the terminals 521 to 524 to the terminals 525 to 527. Furthermore, the switch circuit 52B can connect the terminal 528 exclusively to the terminals 527 and 529. The switch circuit 52B is configured of, for example, a multi-connection-type switch circuit.

Note that the high-frequency circuit 1B may include only one of the filters 37B and 38B.

### [3.2 Frequency Bands]

Here, specific examples of the band C for use in the communication device 5B according to the present embodiment are described.

The band C is one example of a third band and, as with the bands A and B, is defined in advance by a standardization organization or the like for a communication system constructed by using RAT. In the present embodiment, the band C is a frequency band for FDD, and is a combination of bands capable of simultaneous transmission and reception with the bands A and B.

For example, as the band C, Band 1 (1920-2170 MHZ), Band 3 (1710-1880 MHZ), Band 5 (824-894 MHZ), Band 8 (880-915 MHZ), or Band 28 (703-803 MHZ) for LTE; or n1 (1920-2170 MHz), n3 (1710-1880 MHZ), n5 (824-894 MHZ), n8 (880-915 MHz), or n28 (703-803 MHZ) for 5GNR can be used.

Note that the band C is not limited to a frequency band for FDD. The band C may be a frequency band for TDD, supplementary uplink (SUL), or supplementary downlink (SDL). When the band C is a frequency band for SUL, the filter 38B may not be included in the high-frequency circuit 1B. When the band C is a frequency band for SDL, the filter 37B may not be included in the high-frequency circuit 1B.

### [3.3 Connection Types in Communication Device 5B]

Next, a plurality of connection types in the communication device 5B are described.

### [3.3.1 First Connection Type]

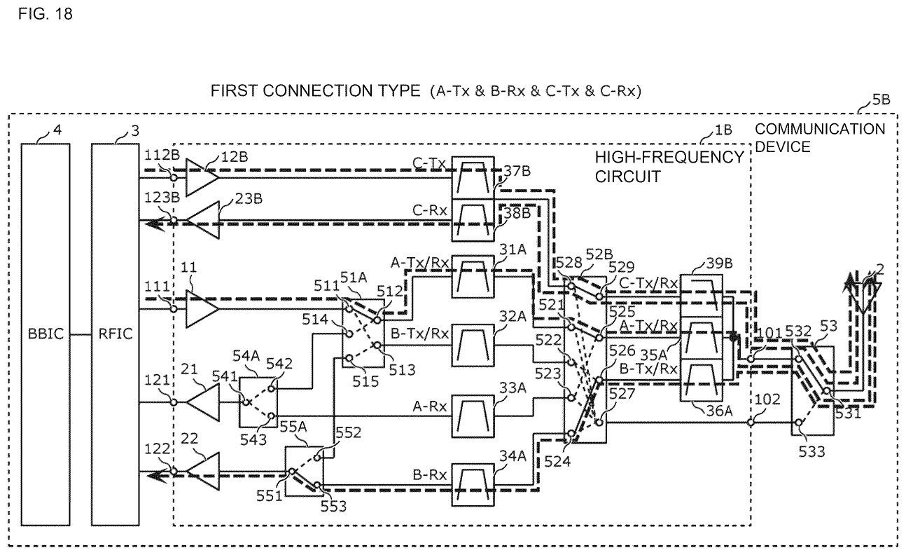

First, a first connection type is described with reference to FIG. 18. FIG. 18 is a diagram depicting the first connection type of the communication device 5B according to the present embodiment.

In the first connection type, transmission of a signal of the band A, reception of a signal of the band B, and transmission and reception of a signal of the band C can be simultaneously performed. That is, the first connection type is a connection type for Simultaneous Rx/Tx. As depicted in FIG. 18, in the first connection type, the switch circuit 51A connects the terminal 511 to the terminal 512, the switch circuit 52B connects the terminal 521 to the terminal 525, connects the terminal 524 to the terminal 526, and connects the terminal 528 to the terminal 529, the switch circuit 53 connects the terminal 531 to the terminal 532, and the switch circuit 55A connects the terminal 551 to the terminal 553. With this, the filters 31A and 35A are connected to a transmission path of the band A, the filters 34A and 36A are connected to a reception path of the band B, the filters 37B and 39B are connected to a transmission path of the band C, and the filters 38B and 39B are connected to a reception path of the band C.

As a result, the transmission signal of the band A is transferred from the RFIC 3 via the input terminal 111, the power amplifier 11, the switch circuit 51A, the filter 31A, the switch circuit 52B, the filter 35A, the input/output The reception signal of the band B is transferred from the antenna 2 via the switch circuit 53, the input/output terminal 101, the filter 36A, the switch circuit 52B, the filter 34A, the switch circuit 55A, the low-noise amplifier 22, and the output terminal 122 to the RFIC 3. The transmission signal of the band C is transferred from the RFIC 3 via the input terminal 112B, the power amplifier 12B, the filter 37B, the switch circuit 52B, the filter 39B, the input/output terminal 101, and the switch circuit 53 to the antenna 2. The reception signal of the band C is transferred from the antenna 2 via the switch circuit 53, the input/output terminal 101, the filter 39B, the switch circuit 52B, the filter 38B, the low-noise amplifier 23B, and the output terminal 123B to the RFIC 3.

### [3.3.2 Second Connection Type]

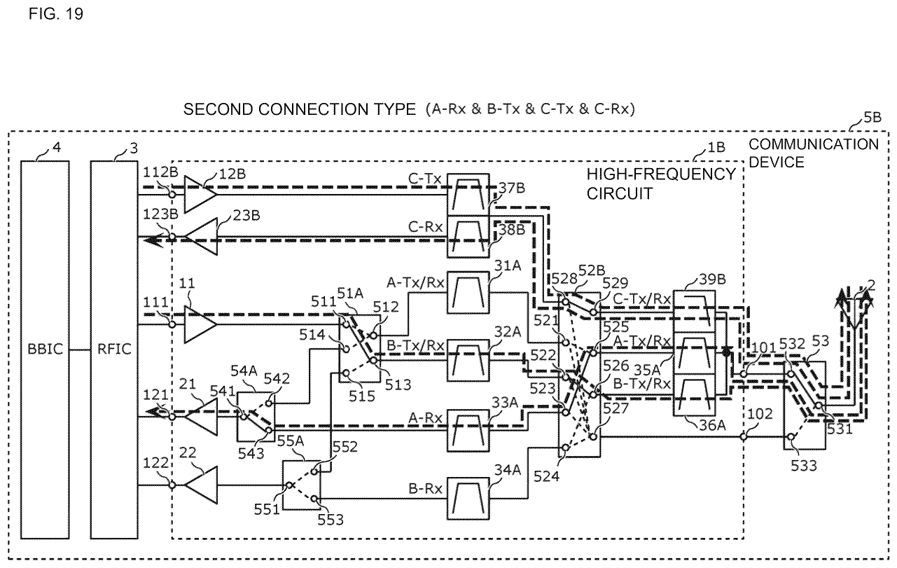

Next, a second connection type is described with reference to FIG. 19. FIG. 19 is a diagram depicting the second connection type of the communication device 5B according to the present embodiment.

In the second connection type, reception of a signal of the band A, transmission of a signal of the band B, and transmission and reception of a signal of the band C can be simultaneously performed. That is, the second connection type is a connection type for Simultaneous Rx/Tx. As depicted in FIG. 19, in the second connection type, the switch circuit 51A connects the terminal 511 to the terminal 513, the switch circuit 52B connects the terminal 522 to the terminal 526, connects the terminal 523 to the terminal 525, and connects the terminal 528 to the terminal 529, the switch circuit 53 connects the terminal 531 to the terminal 532, and the switch circuit 54A connects the terminal 541 to the terminal 543. With this, the filters 32A and 36A are connected to a transmission path of the band B, the filters 33A and 35A are connected to a reception path of the band A, the filters 37B and 39B are connected to a transmission path of the band C, and the filters 38B and 39B are connected to a reception path of the band C.

As a result, the transmission signal of the band B is transferred from the RFIC 3 via the input terminal 111, the power amplifier 11, the switch circuit 51A, the filter 32A, the switch circuit 52B, the filter 36A, the input/output terminal 101, and the switch circuit 53 to the antenna 2. The reception signal of the band A is transferred from the antenna 2 via the switch circuit 53, the input/output terminal 101, the filter 35A, the switch circuit 52B, the filter 33A, the switch circuit 54A, the low-noise amplifier 21, and the output terminal 121 to the RFIC 3. The transmission signal of the band C is transferred from the RFIC 3 via the input terminal 112B, the power amplifier 12B, the filter 37B, the switch circuit 52B, the filter 39B, the input/output terminal 101, and the switch circuit 53 to the antenna 2. The reception signal of the band C is transferred from the antenna 2 via the switch circuit 53, the input/output terminal 101, the filter 39B, the switch circuit 52B, the filter 38B, the low-noise amplifier 23B, and the output terminal 123B to the RFIC 3.

### [3.3.3 Third Connection Type]

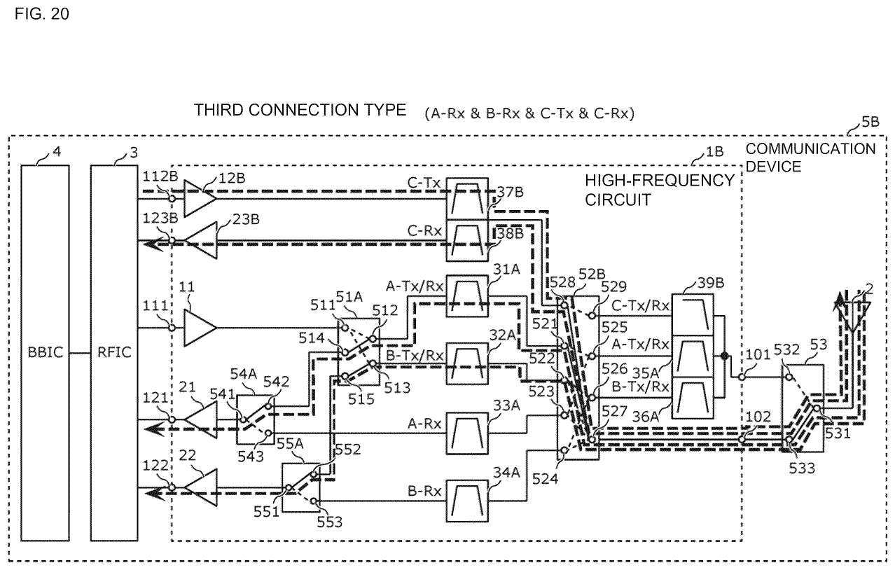

Next, a third connection type is described with reference to FIG. 20. FIG. 20 is a diagram depicting the third connection type of the communication device 5B according to the present embodiment.

In the third connection type, reception of a signal of the band A and reception of a signal of the band B can be simultaneously performed. As depicted in FIG. 20, in the third connection type, the switch circuit 51A connects the terminal 512 to the terminal 514 and connects the terminal 513 to the terminal 515, the switch circuit 52B connects the terminals 521, 522, and 528 to the terminal 527, the switch circuit 53 connects the terminal 531 to the terminal 533, the switch circuit 54A connects the terminal 541 to the terminal 542, and the switch circuit 55A connects the terminal 551 to the terminal 552. With this, the filter 31A is connected to a reception path of the band A, the filter 32A is connected to a reception path of the band B, the filter 37B is connected to a transmission path of the band C, and the filter 38B is connected to a reception path of the band C. The transmission signal of the band C is transferred from the RFIC 3 via the input terminal 112B, the power amplifier 12B, the filter 37B, the switch circuit 52B, the input/output terminal 102, and the switch circuit 53 to the antenna 2. The reception signal of the band C is transferred from the antenna 2 via the switch circuit 53, the input/output terminal 102, the switch circuit 52B, the filter 38B, the low-noise amplifier 23B, and the output terminal 123B to the RFIC 3.

As a result, the reception signal of the band A is transferred from the antenna 2 via the switch circuit 53, the input/output terminal 102, the switch circuit 52B, the filter 31A, the switch circuits 51A and 54A, the low-noise amplifier 21, and the output terminal 121 to the RFIC 3. The reception signal of the band B is transferred from the antenna 2 via the switch circuit 53, the input/output terminal 102, the switch circuit 52B, the filter 32A, the switch circuits 51A and 55A, the low-noise amplifier 22, and the output terminal 122 to the RFIC 3.

Note that single transmission and reception of each of the bands A and B is similar to that of the above-described second embodiment and therefore its depiction and description are not repeated. Also, single transmission and reception of the band C is similar to that of the above-described third connection type and therefore its depiction and description are not repeated.

### [3.4 Overview]

As described above, the high-frequency circuit 1B according to the present embodiment includes: the power amplifiers 11 and 12B; the low-noise amplifiers 21, 22, and 23B; the filter 31A having a pass band including the band A for TDD and switchably connected to the power amplifier 11; the filter 32A having a pass band including the band B for TDD capable of simultaneous transmission and reception with the band A and switchably connected to the power amplifier 11; the filter 33A having a pass band including the band A and connected to the low-noise amplifier 21; the filter 34A having a pass band including the band B and connected to the low-noise amplifier 22; the filter 35A having a pass band including the band A and having one end switchably connected to each of the filters 31A and 33A and the other end connected to the input/output terminal 101; the filter 36A having a pass band including the band B and having one end switchably connected to each of the filters 32A and 34A and the other end connected to the input/output terminal 101; the filter 37B having a pass band including a transmission band of the band C and connected to the power amplifier 12B; the filter 38B having a pass band including a reception band of the band C and connected to the low-noise amplifier 23B; the filter 39B having a pass band including the transmission band and the reception band of the band C and having one end switchably connected to the filters 37B and 38B and the other end connected to the input/output terminal 101; the switch circuit 51A including the terminal 511 connected to the power amplifier 11, the terminals 512 and 513 connected to the filters 31A and 32A, respectively, and the terminals 514 and 515; the switch circuit 52B including the terminals 521 to 526 connected to the filters 31A to 36A, respectively, the terminal 527 connected to the input/output terminal 102 not via the filters 35A and 36A, the terminal 528 connected to the filters 37B and 38B, and the terminal 529 connected to the filter 39B; the switch circuit 53 including the terminal 531 connected to the antenna 2, the terminal 532 connected to the input/output terminal 101, and the terminal 533 connected to the input/output terminal 102; the switch circuit 54A including the terminal 541 connected to the low-noise amplifier 21, the terminal 542 connected to the terminal 514, and the terminal 543 connected to the filter 33A; and the switch circuit 55A including the terminal 551 connected to the low-noise amplifier 22, the terminal 552 connected to the terminal 515, and the terminal 553 connected to the filter 34A.

According to this, as with the high-frequency circuit 1 according to the first embodiment, the quality of the reception signal can be improved in Simultaneous Rx/Tx, and an increase in output power in the power amplifier and a decrease in reception sensitivity can be suppressed not in Simultaneous Rx/Tx. Also, as with the high-frequency circuit 1A according to the second embodiment, the performance required for the filters 33A and 34A can be mitigated, and the filters 33A and 34A can be downsized. Furthermore, in Simultaneous Rx/Tx with the bands A and B, transmission and reception of a signal of the band C can also be supported.

Also, for example, in the high-frequency circuit 1B according to the present embodiment, when transmission of the band A, reception of the band B, and transmission and reception of the band C are simultaneously performed, the switch circuit 51A may connect the terminal 511 to the terminal 512, the switch circuit 52B may connect the terminal 521 to the terminal 525, connect the terminal 524 to the terminal 526, and connect the terminal 528 to the terminal 529, the switch circuit 53 may connect the terminal 531 to the terminal 532, and the switch circuit 55A may connect the terminal 551 to the terminal 553.

According to this, in Simultaneous Rx/Tx with transmission of the band A and reception of the band B, the filter 31A is connected via the filter 35A to the input/output terminal 101, and the filter 34A is connected via the filter 36A to the input/output terminal 101. Therefore, the two filters 34A and 36A may suppress entry of the transmission signal of the band A into the reception path of the band B, thereby improving the quality of the reception signal of the band B. For example, if the switch circuit 52B connects the terminals 521 and 524 to the terminal 527 to cause the filters 31A and 34A to be connected to the input/output terminal 102 not via the filters 35A and 36A, the transmission signal of the band A leaks from the filter 34A to the low-noise amplifier 22 to degrade the quality of the reception signal of the band B. By contrast, with the filters 31A and 34A connected via the filters 35A and 36A to the input/output terminal 101, leakage of the transmission signal of the band A to the low-noise amplifier 22 is suppressed by the two filters 34A and 36A, thereby allowing the quality of the reception signal of the band B to be improved. Furthermore, transmission and reception of the band C can also be supported by using the filters 37B to 39B.

Also, for example, in the high-frequency circuit 1B according to the present embodiment, when reception of the band A, transmission of the band B, and transmission and reception of the band C are simultaneously performed, the switch circuit 51A may connect the terminal 511 to the terminal 513, the switch circuit 52B may connect the terminal 522 to the terminal 526, connect the terminal 523 to the terminal 525, and connect the terminal 528 to the terminal 529, the switch circuit 53 may connect the terminal 531 to the terminal 532, and the switch circuit 54A may connect the terminal 541 to the terminal 543.

According to this, in Simultaneous Rx/Tx with reception of the band A and transmission of the band B, the filter 33A is connected via the filter 35A to the input/output terminal 101, and the filter 32A is connected via the filter 36A to the input/output terminal 101. Therefore, the two filters 33A and 35A may suppress entry of the transmission signal of the band B into the reception path of the band A, thereby improving the quality of the reception signal of the band A. For example, if the switch circuit 52B connects the terminals 522 and 523 to the terminal 527 to cause the filters 32A and 33A to be connected to the input/output terminal 102 not via the filters 35A and 36A, the transmission signal of the band B leaks from the filter 33A to the low-noise amplifier 21 to degrade the quality of the reception signal of the band A. By contrast, with the filters 32A and 33A connected via the filters 35A and 36A to the input/output terminal 101, leakage of the transmission signal of the band B to the low-noise amplifier 21 is suppressed by the two filters 33A and 35A, thereby allowing the quality of the reception signal of the band A to be improved. Furthermore, transmission and reception of the band C can also be supported by using the filters 37B to 39B.

Also, for example, in the high-frequency circuit 1B according to the present embodiment, when reception of the band A, reception of the band B, and transmission and reception of the band C are simultaneously performed, the switch circuit 51A may connect the terminal 512 to the terminal 514 and connect the terminal 513 to the terminal 515, the switch circuit 52B may connect the terminals 521, 522, and 528 to the terminal 527, the switch circuit 53 may connect the terminal 531 to the terminal 533, the switch circuit 54A may connect the terminal 541 to the terminal 542, and the switch circuit 55A may connect the terminal 551 to the terminal 552.

According to this, in simultaneous transmission and reception of the bands A to C, the filters 31A and 32A are connected to the input/output terminal 102 not via the filter 35A and 36A. Therefore, a loss of the reception signal by the filters 35A and 36A may be avoided and reception sensitivity in simultaneous reception of the bands A and B may be maintained. Furthermore, the filters 31A and 32A can be each used for reception of the bands A and B, and thus the performance required for the filters 33A and 34A can be mitigated, and the filters 33A and 34A can be downsized. Also, the filters 37B and 38B are connected to the input/output terminal 102 not via the filter 39B. Therefore, a signal loss by the filter 39B may be avoided, thereby minimizing output power of the transmission signal of the band C required for the power amplifier 12B and maintaining reception sensitivity of the band C.

Also, for example, in the high-frequency circuit 1B according to the present embodiment, a combination of the bands A and B may be a combination of Band 40 for LTE or n40 for 5GNR and Band 41 for LTE or n41 for 5GNR or a combination of Band 39 for LTE or n39 for 5GNR and Band 41 for LTE or n41 for 5GNR, and the band C may be Band 1, Band 3, Band 5, Band 8, or Band 28 for LTE or n1, n3, n5, n8, or n28 for 5GNR.

According to this, in an LTE or 5GNR communication network, the quality of the reception signal at Simultaneous Rx/Tx can be improved.

Also, for example, in the high-frequency circuit 1B according to the present embodiment, at least one of the filters 35A and 36A may be an acoustic wave filter including an inductor, a capacitor, and an acoustic wave resonator.

According to this, the attenuation characteristics near the pass band can be improved by the acoustic wave resonator, and the attenuation characteristics away from the pass band can be improved by the inductor and the capacitor. Thus, the characteristics of the filter 35A and/or 36A can be improved.

Also, for example, in the high-frequency circuit 1B according to the present embodiment, at least one of the filters 33A and 34A may be an LC filter.

According to this, the filter 33A and/or 34A can be downsized.

Also, the communication device 5B according to the present embodiment includes the RFIC 3 that processes a high-frequency signal and the high-frequency circuit 1B that transfers the high-frequency signal between the RFIC 3 and the antenna 2.

According to this, effects similar to those of the high-frequency circuit 1B can be achieved by the communication device 5B.

### Fourth Embodiment

Next, a fourth embodiment is described. The present embodiment is different from the above-described first embodiment mainly in the connection structure of the filters and the switch circuits. In the following, the point of the present embodiment that is different from the above-described first embodiment is mainly described with reference to the drawings.

### [4.1 Circuit Structure of High-Frequency Circuit 1C]

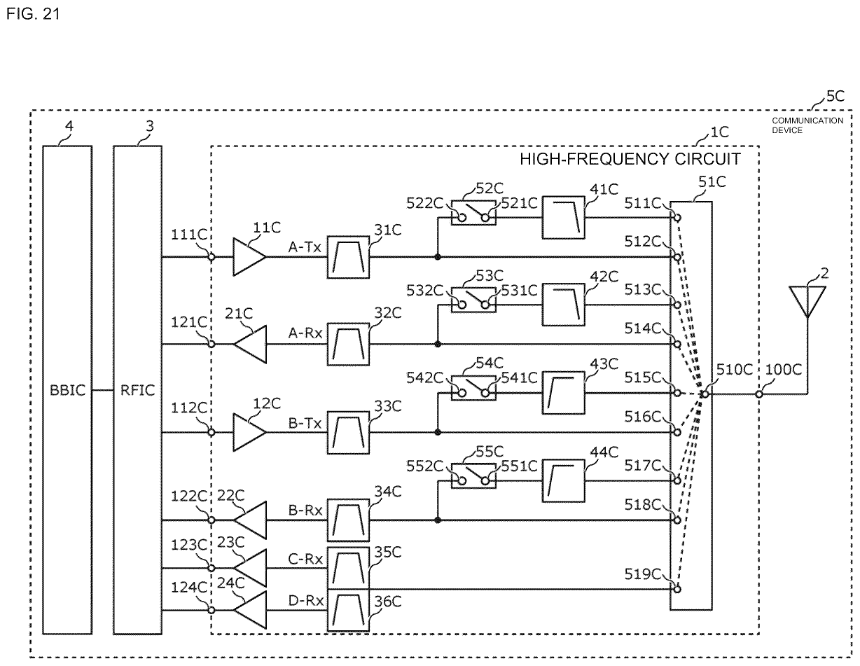

The circuit structure of a high-frequency circuit 1C according to the present embodiment is described with reference to FIG. 21. FIG. 21 is a circuit structure diagram of a communication device 5C according to the present embodiment.

Note that FIG. 21 is an exemplary circuit structure and the communication device 5C and the high-frequency circuit 1C can be implemented by using any of various circuit implementations or circuit technologies. Therefore, description of the communication device 5C and the high-frequency circuit 1C provided below is not restrictive.

The communication device 5C according to the present embodiment is similar to the communication device 5 according to the first embodiment except that it includes the high-frequency circuit 1C in place of the high-frequency circuit 1A and does not include the switch circuit 53, and therefore its description is not repeated.

The high-frequency circuit 1C according to the present embodiment includes: power amplifiers 11C and 12C; low-noise amplifiers 21C, 22C, 23C, and 24C; filters 31C, 32C, 33C, 34C, 35C, 36C, 41C, 42C, 43C, and 44C; switch circuits 51C, 52C, 53C, 54C, and 55C; an antenna connection terminal 100C; input terminals 111C and 112C; and output terminals 121C, 122C, 123C, and 124C.

The antenna connection terminal 100C is an external connection terminal of the high-frequency circuit 1C, and is connected to the antenna 2. Specifically, the antenna connection terminal 100C is connected to the antenna 2 outside the high-frequency circuit 1C, and is connected to the switch circuit 51C inside the high-frequency circuit 1C.

The input terminal 111C is an external connection terminal of the high-frequency circuit 1C, and is a high-frequency input terminal. The input terminal 111C is connected to the RFIC 3 outside the high-frequency circuit 1C, and is connected to the power amplifier 11C inside the high-frequency circuit 1C. The input terminal 111C can receive a transmission signal of the band A from the RFIC 3.

The input terminal 112C is an external connection terminal of the high-frequency circuit 1C, and is a high-frequency input terminal. The input terminal 112C is connected to the RFIC 3 outside the high-frequency circuit 1C, and is connected to the power amplifier 12C inside the high-frequency circuit 1C. The input terminal 112C can receive a transmission signal of the band B from the RFIC 3.

The output terminal 121C is an external connection terminal of the high-frequency circuit 1C, and is a high-frequency output terminal. The output terminal 121C is connected to the RFIC 3 outside the high-frequency circuit 1C, and is connected to the low-noise amplifier 21C inside the high-frequency circuit 1C. The output terminal 121C can supply a reception signal of the band A to the RFIC 3.

The output terminal 122C is an external connection terminal of the high-frequency circuit 1C, and is a high-frequency output terminal. The output terminal 122C is connected to the RFIC 3 outside the high-frequency circuit 1C, and is connected to the low-noise amplifier 22C inside the high-frequency circuit 1C. The output terminal 122C can supply a reception signal of the band B to the RFIC 3.

The output terminal 123C is an external connection terminal of the high-frequency circuit 1C, and is a high-frequency output terminal. The output terminal 123C is connected to the RFIC 3 outside the high-frequency circuit 1C, and is connected to the low-noise amplifier 23C inside the high-frequency circuit 1C. The output terminal 123C can supply a reception signal of the band C to the RFIC 3.

The output terminal 124C is an external connection terminal of the high-frequency circuit 1C, and is a high-frequency output terminal. The output terminal 124C is connected to the RFIC 3 outside the high-frequency circuit 1C, and is connected to the low-noise amplifier 24C inside the high-frequency circuit 1C. The output terminal 124C can supply a reception signal of a band D to the RFIC 3.

The power amplifier 11C is one example of the first power amplifier. The input end of the power amplifier 11C is connected to the input terminal 111C. The output end of the power amplifier 11C is connected to the filter 31C. By using electric power supplied from a power supply (not depicted), the power amplifier 11C can amplify a transmission signal of the band A supplied from the RFIC 3 via the input terminal 111C. Note that an entire or part of the power amplifier 11C may not be included in the high-frequency circuit 1C. In this case, an entire or part of the power amplifier 11C may be connected between the RFIC 3 and the input terminal 111C or may be included in the RFIC 3.

The power amplifier 12C is one example of the second power amplifier. The input end of the power amplifier 12C is connected to the input terminal 112C. The output end of the power amplifier 12C is connected to the filter 33C. By using electric power supplied from a power supply (not depicted), the power amplifier 12C can amplify a transmission signal of the band B supplied from the RFIC 3 via the input terminal 112C. Note that an entire or part of the power amplifier 12C may not be included in the high-frequency circuit 1C. In this case, an entire or part of the power amplifier 12C may be connected between the RFIC 3 and the input terminal 112C or may be included in the RFIC 3.

The low-noise amplifier 21C is one example of the first low-noise amplifier. The input end of the low-noise amplifier 21C is connected to the filter 32C. The output end of the low-noise amplifier 21C is connected to the output terminal 121C. By using electric power supplied from a power supply (not depicted), the low-noise amplifier 21C can amplify a reception signal of the band A passing through the filter 32C. Note that an entire or part of the low-noise amplifier 21C may not be included in the high-frequency circuit 1C. In this case, an entire or part of the low-noise amplifier 21C may be connected between the RFIC 3 and the output terminal 121C or may be included in the RFIC 3.

The low-noise amplifier 22C is one example of the second low-noise amplifier. The input end of the low-noise amplifier 22C is connected to the filter 34C. The output end of the low-noise amplifier 22C is connected to the output terminal 122C. By using electric power supplied from a power supply (not depicted), the low-noise amplifier 22C can amplify a reception signal of the band B passing through the filter 34C. Note that an entire or part of the low-noise amplifier 22C may not be included in the high-frequency circuit 1C. In this case, an entire or part of the low-noise amplifier 22C may be connected between the RFIC 3 and the output terminal 122C or may be included in the RFIC 3.

The low-noise amplifier 23C is one example of the third low-noise amplifier. The input end of the low-noise amplifier 23C is connected to the filter 35C. The output end of the low-noise amplifier 23C is connected to the output terminal 123C. By using electric power supplied from a power supply (not depicted), the low-noise amplifier 23C can amplify a reception signal of the band C passing through the filter 35C. Note that an entire or part of the low-noise amplifier 23C may not be included in the high-frequency circuit 1C. In this case, an entire or part of the low-noise amplifier 23C may be connected between the RFIC 3 and the output terminal 123C or may be included in the RFIC 3.

The low-noise amplifier 24C is one example of a fourth low-noise amplifier. The input end of the low-noise amplifier 24C is connected to the filter 36C. The output end of the low-noise amplifier 24C is connected to the output terminal 124C. By using electric power supplied from a power supply (not depicted), the low-noise amplifier 24C can amplify a reception signal of the band D passing through the filter 36C. Note that an entire or part of the low-noise amplifier 24C may not be included in the high-frequency circuit 1C. In this case, an entire or part of the low-noise amplifier 24C may be connected between the RFIC 3 and the output terminal 124C or may be included in the RFIC 3.

The filter 31C is one example of the first filter, and is a band pass filter having a pass band including the transmission band of the band A. One end of the filter 31C is connected to the power amplifier 11C. On the other hand, the other end of the filter 31C is connected to a terminal 512C of the switch circuit 51C, and is switchably connected via the switch circuit 52C and the filter 41C to a terminal 511C of the switch circuit 51C. The filter 31C is used for transmission of the band A (A-Tx).

The filter 32C is one example of the first filter, and is a band pass filter having a pass band including the reception band of the band A. One end of the filter 32C is connected to the low-noise amplifier 21C. On the other hand, the other end of the filter 32C is connected to a terminal 514C of the switch circuit 51C, and is switchably connected via the switch circuit 53C and the filter 42C to a terminal 513C of the switch circuit 51C. The filter 32C is used for reception of the band A (A-Rx).

The filter 33C is one example of the second filter, and is a band pass filter having a pass band including the transmission band of the band B. One end of the filter 33C is connected to the power amplifier 12C. On the other hand, the other end of the filter 33C is connected to a terminal 516C of the switch circuit 51C, and is switchably connected via the switch circuit 54C and the filter 43C to a terminal 515C of the switch circuit 51C. The filter 33C is used for transmission of the band B (B-Tx).

The filter 34C is one example of the second filter, and is a band pass filter having a pass band including the reception band of the band B. One end of the filter 34C is connected to the low-noise amplifier 22C. On the other hand, the other end of the filter 34C is connected to a terminal 518C of the switch circuit 51C, and is switchably connected via the switch circuit 55C and the filter 44C to a terminal 517C of the switch circuit 51C. The filter 34C is used for reception of the band B (B-Rx).

The filter 35C is a band pass filter having a pass band including the reception band of the band C. One end of the filter 35C is connected to the low-noise amplifier 23C. On the other hand, the other end of the filter 35C is connected to a terminal 519C of the switch circuit 51C. The filter 35C is used for reception of the band C (C-Rx). Note that the filter 35C may not be included in the high-frequency circuit 1C.

The filter 36C is a band pass filter having a pass band including the reception band of the band D. One end of the filter 36C is connected to the low-noise amplifier 24C. On the other hand, the other end of the filter 36C is connected to the terminal 519C of the switch circuit 51C. The filter 36C is used for reception of the band D (D-Rx). Note that the filter 36C may not be included in the high-frequency circuit 1C.

The filter 41C is one example of the third filter, and is a low pass filter having an attenuation band including the band B. One end of the filter 41C is connected to the terminal 511C of the switch circuit 51C. On the other hand, the other end of the filter 41C is connected to a terminal 521C of the switch circuit 52C. The filter 41C has a pass band including the band A, and is used for transmission of a signal of the band A. Note that the filter 41C is not limited to a low pass filter. For example, the filter 41C may be a band elimination filter or band pass filter.

The filter 42C is one example of the third filter, and is a low pass filter having an attenuation band including the band B. One end of the filter 42C is connected to the terminal 513C of the switch circuit 51C. On the other hand, the other end of the filter 42C is connected to a terminal 531C of the switch circuit 53C. The filter 42C has a pass band including the band A, and is used for reception of a signal of the band A. Note that the filter 42C is not limited to a low pass filter. For example, the filter 42C may be a band elimination filter or band pass filter.

Note that only one of the filters 41C and 42C may be included in the high-frequency circuit 1C.

The filter 43C is a high pass filter having an attenuation band including the band A. One end of the filter 43C is connected to the terminal 515C of the switch circuit 51C. On the other hand, the other end of the filter 43C is connected to a terminal 541C of the switch circuit 54C. The filter 43C has a pass band including the band B, and is used for transmission of a signal of the band B. Note that the filter 43C is not limited to a high pass filter. For example, the filter 43C may be a band elimination filter or band pass filter. Note that the filter 43C may not be included in the high-frequency circuit 1C.

The filter 44C is a high pass filter having an attenuation band including the band A. One end of the filter 44C is connected to the terminal 517C of the switch circuit 51C. On the other hand, the other end of the filter 44C is connected to a terminal 551C of the switch circuit 55C. The filter 44C has a pass band including the band B, and is used for reception of a signal of the band B. Note that the filter 44C is not limited to a high pass filter. For example, the filter 44C may be a band elimination filter or band pass filter. Note that the filter 44C may not be included in the high-frequency circuit 1C.

As each of the filters 31C to 36C and 41C to 44C, a SAW filter, BAW filter, LC filter or dielectric filter, or any combination of these may be used and, furthermore, these are not restrictive.

The switch circuit 51C is one example of the first switch circuit, and includes terminals 510C to 519C. The terminal 510C is one example of the first terminal, and is connected to the antenna connection terminal 100C. The terminal 511C is one example of the fourth terminal, and is connected to the filter 41C. The terminal 512C is one example of the second terminal, and is connected to the filter 31C. The terminal 513C is one example of the fourth terminal, and is connected to the filter 42C. Note that when the filter 42C is not included in the high-frequency circuit 1C, the terminal 513C may not be included in the switch circuit 51C. The terminal 514C is one example of the second terminal, and is connected to the filter 32C. The terminal 515C is connected to the filter 43C. The terminal 516C is one example of the third terminal, and is connected to the filter 33C. The terminal 517C is connected to the filter 44C. The terminal 518C is one example of the third terminal, and is connected to the filter 34C. The terminal 519C is connected to the filters 35C and 36C.

In this connection structure, for example, based on a control signal from the RFIC 3, the switch circuit 51C can connect the terminal 510C to the terminals 511C to 519C. The switch circuit 51C is configured of, for example, a multi-connection-type switch circuit.

The switch circuit 52C is one example of the second switch circuit, and includes terminals 521C and 522C. The terminal 521C is one example of the fifth terminal, and is connected to the filter 41C. The terminal 522C is one example of the sixth terminal, and is connected to the filter 31C.

In this connection structure, for example, based on a control signal from the RFIC 3, the switch circuit 52C can connect the terminal 521C to the terminal 522C. The switch circuit 52C is configured of, for example, a single-pole single-throw (SPST)-type switch circuit. Note that when the filter 41C is not included in the high-frequency circuit 1C, the switch circuit 52C may not be included in the high-frequency circuit 1C.

The switch circuit 53C is one example of the second switch circuit, and includes terminals 531C and 532C. The terminal 531C is one example of the fifth terminal, and is connected to the filter 42C. The terminal 532C is one example of the sixth terminal, and is connected to the filter 32C.

In this connection structure, for example, based on a control signal from the RFIC 3, the switch circuit 53C can connect the terminal 531C to the terminal 532C. The switch circuit 53C is configured of, for example, an SPST-type switch circuit. Note that when the filter 42C is not included in the high-frequency circuit 1C, the switch circuit 53C may not be included in the high-frequency circuit 1C.

The switch circuit 54C includes terminals 541C and 542C. The terminal 541C is connected to the filter 43C. The terminal 542C is connected to the filter 33C.

In this connection structure, for example, based on a control signal from the RFIC 3, the switch circuit 54C can connect the terminal 541C to the terminal 542C. The switch circuit 54C is configured of, for example, an SPST-type switch circuit. Note that when the filter 43C is not included in the high-frequency circuit 1C, the switch circuit 54C may not be included in the high-frequency circuit 1C.

The switch circuit 55C includes terminals 551C and 552C. The terminal 551C is connected to the filter 44C. The terminal 552C is connected to the filter 34C.

In this connection structure, for example, based on a control signal from the RFIC 3, the switch circuit 55C can connect the terminal 551C to the terminal 552C. The switch circuit 55C is configured of, for example, an SPST-type switch circuit. Note that when the filter 44C is not included in the high-frequency circuit 1C, the switch circuit 55C may not be included in the high-frequency circuit 1C.

As with the bands A to C, the band D is defined in advance by a standardization organization or the like for a communication system constructed by using RAT. In the present embodiment, the band D is a frequency band for FDD different from the band C, and is a band capable of simultaneous transmission and reception with the bands A and B.

For example, as the band D, Band 1 (1920-2170 MHZ), Band 3 (1710-1880 MHZ), Band 5 (824-894 MHZ), Band 8 (880-915 MHZ), or Band 28 (703-803 MHz) for LTE; or n1 (1920-2170 MHz), n3 (1710-1880 MHZ), n5 (824-894 MHZ), n8 (880-915 MHz), or n28 (703-803 MHz) for 5GNR can be used.

Note that the band D is not limited to a frequency band for FDD. The band D may be a frequency band for TDD or SDL.

### [4.2 Communication Modes of Communication Device 5C]

Next, communication modes of the communication device 5C are described.

### [4.2.1 First Mode]

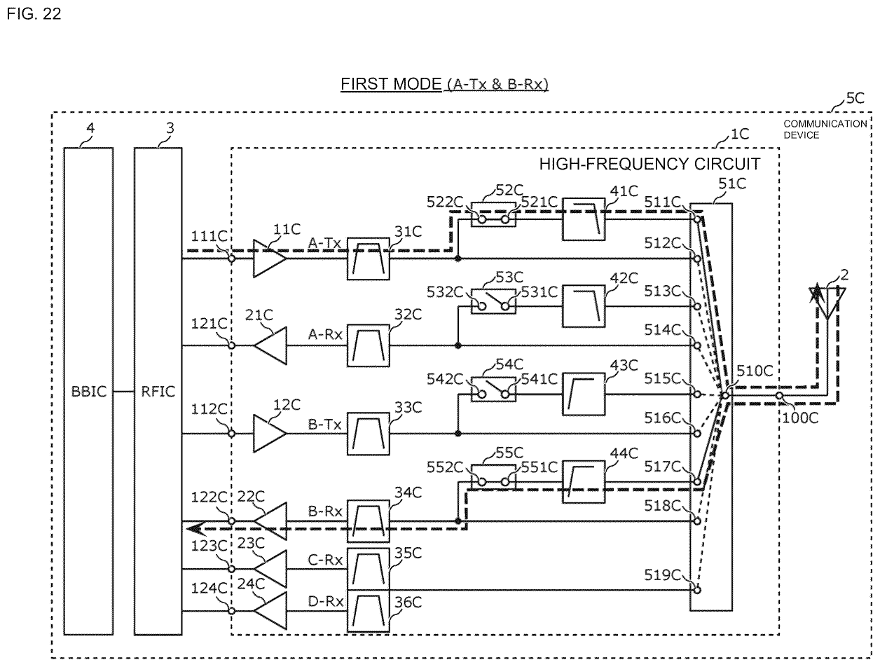

First, a first mode is described with reference to FIG. 22. FIG. 22 is a diagram depicting the first mode of the communication device 5C according to the present embodiment.

In the first mode, transmission of a signal of the band A and reception of a signal of the band B are simultaneously performed. That is, the first mode corresponds to the first connection type in the above-described first to third embodiments, and is a communication mode for Simultaneous Rx/Tx. As depicted in FIG. 22, in the first mode, the switch circuit 51C connects the terminal 510C to the terminals 511C and 517C and does not connect it to the terminals 512C to 516C, 518C, and 519C. The switch circuit 52C connects the terminal 521C to the terminal 522C, and the switch circuit 55C connects the terminal 551C to the terminal 552C. That is, the switch circuits 52C and 55C are closed. Here, the switch circuits 53C and 54C are opened. With this, the filters 31C and 41C are connected to the transmission path of the band A, and the filters 34C and 44C are connected to the reception path of the band B.

As a result, the transmission signal of the band A is transferred from the RFIC 3 via the input terminal 111C, the power amplifier 11C, the filter 31C, the switch circuit 52C, the filter 41C, the switch circuit 51C, and the antenna connection terminal 100C to the antenna 2. The reception signal of the band B is transferred from the antenna 2 via the antenna connection terminal 100C, the switch circuit 51C, the filter 44C, the switch circuit 55C, the filter 34C, the low-noise amplifier 22C, and the output terminal 122C to the RFIC 3.

### [4.2.2 Second Mode]

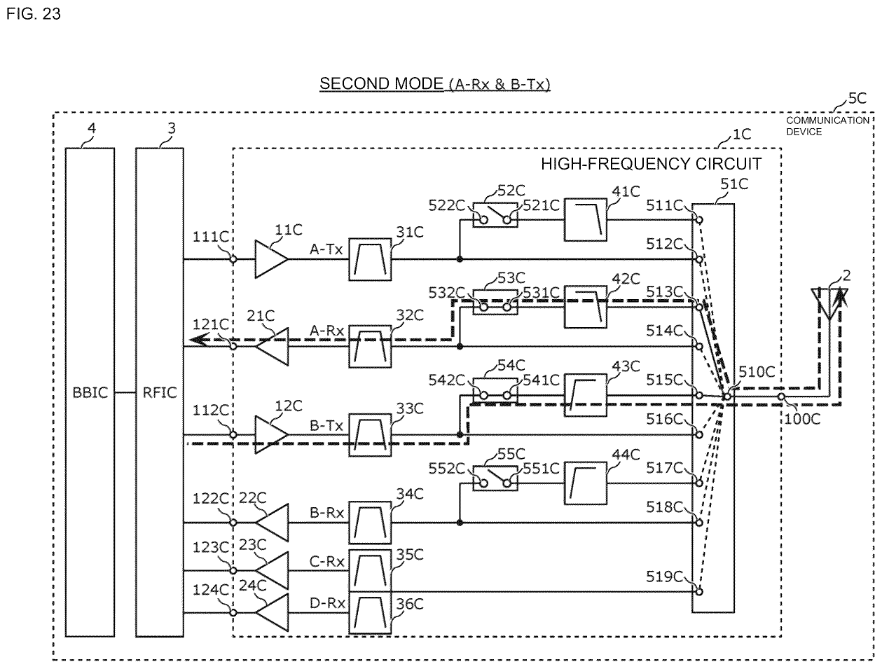

Next, a second mode is described with reference to FIG. 23. FIG. 23 is a diagram depicting the second mode of the communication device 5C according to the present embodiment.

In the second mode, transmission of a signal of the band B and reception of a signal of the band A are simultaneously performed. That is, the second mode corresponds to the second connection type in the above-described first to third embodiments, and is a communication mode for Simultaneous Rx/Tx. As depicted in FIG. 23, in the second mode, the switch circuit 51C connects the terminal 510C to the terminals 513C and 515C and does not connect it to the terminals 511c, 512C, 514C, and 516C to 519C. The switch circuit 53C connects the terminal 531C to the terminal 532C, and the switch circuit 54C connects the terminal 541C to the terminal 542C. That is, the switch circuits 53C and 54C are closed. Here, the switch circuits 52C and 55C are opened. With this, the filters 32C and 42C are connected to the reception path of the band A, and the filters 33C and 43C are connected to the transmission path of the band B.

As a result, the transmission signal of the band B is transferred from the RFIC 3 via the input terminal 112C, the power amplifier 12C, the filter 33C, the switch circuit 54C, the filter 43C, the switch circuit 51C, and the antenna connection terminal 100C to the antenna 2. The reception signal of the band A is transferred from the antenna 2 via the antenna connection terminal 100C, the switch circuit 51C, the filter 42C, the switch circuit 53C, the filter 32C, the low-noise amplifier 21C, and the output terminal 121C to the RFIC 3.

### [4.2.3 Third Mode]

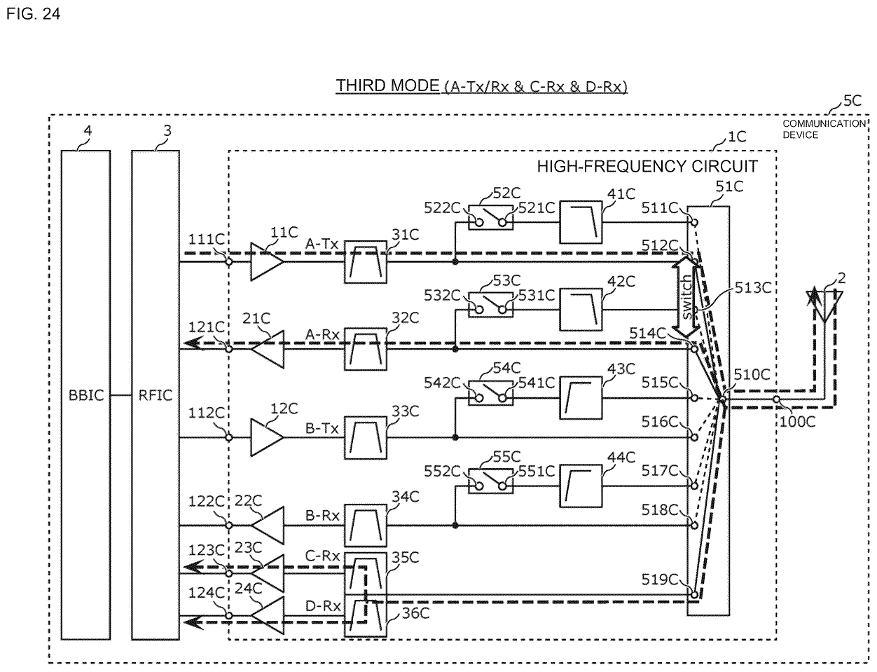

Next, a third mode is described with reference to FIG. 24. FIG. 24 is a diagram depicting the third mode of the communication device 5C according to the present embodiment.

In the third mode, a switch is made with time between transmission and reception of a signal of the band A, and reception of signals of the bands C and D is performed. As depicted in FIG. 24, in the third mode, while connecting the terminal 510C to the terminal 519C, the switch circuit 51C switches the connection of the terminal 510C between the terminals 512C and 514C. Here, the switch circuit 51C does not connect the terminal 510C to the terminals 511C, 513C, and 515C to 518C. With this, the filter 31C is connected to a transmission path of the band A, the filter 32C is connected to a reception path of the band A, and the filters 35C and 36C are each connected to reception paths of the bands C and D.

As a result, the transmission signal of the band A is transferred from the RFIC 3 via the input terminal 111C, the power amplifier 11C, the filter 31C, the switch circuit 51C, and the antenna connection terminal 100C to the antenna 2. The reception signal of the band A is transferred from the antenna 2 via the antenna connection terminal 100C, the switch circuit 51C, the filter 32C, the low-noise amplifier 21C, and the output terminal 121C to the RFIC 3. The reception signal of the band C is transferred from the antenna 2 via the antenna connection terminal 100C, the switch circuit 51C, the filter 35C, the low-noise amplifier 23C, and the output terminal 123C to the RFIC 3. The reception signal of the band D is transferred from the antenna 2 via the antenna connection terminal 100C, the switch circuit 51C, the filter 36C, the low-noise amplifier 24C, and the output terminal 124C to the RFIC 3.

### [4.2.4 Fourth Mode]

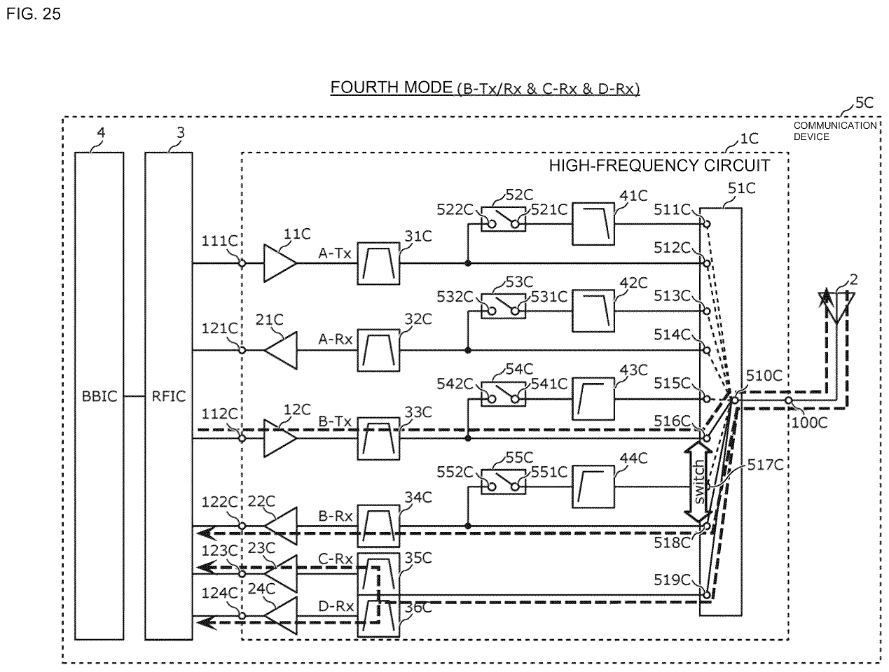

Next, a fourth mode is described with reference to FIG. 25. FIG. 25 is a diagram depicting the fourth mode of the communication device 5C according to the present embodiment.

In the fourth mode, a switch is made with time between transmission and reception of a signal of the band B, and reception of signals of the bands C and D is performed. As depicted in FIG. 25, in the fourth mode, while connecting the terminal 510C to the terminal 519C, the switch circuit 51C switches the connection of the terminal 510C between the terminals 516C and 518C. Here, the switch circuit 51C does not connect the terminal 510C to the terminals 511C to 515C and 517C. With this, the filter 33C is connected to a transmission path of the band B, the filter 34C is connected to a reception path of the band B, and the filters 35C and 36C are each connected to reception paths of the bands C and D.

As a result, the transmission signal of the band B is transferred from the RFIC 3 via the input terminal 112C, the power amplifier 12C, the filter 33C, the switch circuit 51C, and the antenna connection terminal 100C to the antenna 2. The reception signal of the band B is transferred from the antenna 2 via the antenna connection terminal 100C, the switch circuit 51C, the filter 34C, the low-noise amplifier 22C, and the output terminal 122C to the RFIC 3. The reception signal of the band C is transferred from the antenna 2 via the antenna connection terminal 100C, the switch circuit 51C, the filter 35C, the low-noise amplifier 23C, and the output terminal 123C to the RFIC 3. The reception signal of the band D is transferred from the antenna 2 via the antenna connection terminal 100C, the switch circuit 51C, the filter 36C, the low-noise amplifier 24C, and the output terminal 124C to the RFIC 3.

### [4.3 Overview]

As described above, the high-frequency circuit 1C according to the present embodiment includes: the filter 31C and/or 32C having a pass band including the band A for TDD; the filter 33C and/or 34C having a pass band including the band B capable of simultaneous transmission and reception with the band A for TDD; the filter 41C and/or 42C having an attenuation band including the band B; the switch circuit 51C including the terminal 510C connected to the antenna connection terminal 100C, the terminal 512C and/or 514C connected to the filter 31C and/or 32C, the terminal 516C and/or 518C connected to the filter 33C and/or 34C, and the terminal 511C and/or 513C connected to the filter 41C and/or 42C; and the switch circuit 52C and/or 53C including the terminal 521C and/or 531C connected to the filter 41C and/or 42C and the terminal 522C and/or 532C connected to the filter 31C and/or 32C. The filter 31C and/or 32C is switchably connected via the switch circuit 52C and/or 53C and the filter 41C and/or 42C to the terminal 511C and/or 513C of the switch circuit 51C.

According to this, the switch circuit 51C is operable to select between a first path that includes one of the filters 41C to 44C for enhanced isolation and a second path which bypasses the filters 41C to 44C. This allows the circuit to be optimized for either high-isolation Simultaneous Rx/Tx operation or low-loss, single-band operation. Therefore, in Simultaneous Rx/Tx, by connecting the filters 31C to 34C via the filters 41C to 44C to the antenna connection terminal 100C, the transmission signal of one of the bands A and B from interfering with the reception signal of the other one of the bands A and B may be suppressed, thereby improving the quality of the reception signal of the other one of the bands A and B. In particular, since it is difficult to sufficiently attenuate the transmission signal only with the reception filter (filter 32C or 34C) for the TDD band, the effect of improving isolation between the transmission path and the reception path by the filters 42C and 44C is large. On the other hand, not in Simultaneous Rx/Tx, by connecting the filters 31C to 34C to the antenna connection terminal 100C not via the switch circuits 52C to 55C and the filters 41C to 44C, a signal loss by the switch circuits 52C to 55C and the filters 41C to 44C may be avoided, thereby minimizing output power required for the power amplifiers 11C and 12C and preserving reception sensitivity.

### First Modification of Fourth Embodiment

Next, a first modification of the above-described fourth embodiment is described. The present modification is different from the above-described fourth embodiment mainly in that the transmission filter and the reception filter of the band A are unified into one transmission/reception filter and the transmission filter and the reception filter of the band B are unified into one transmission/reception filter. In the following, the point of the present modification that is different from the above-described fourth embodiment is mainly described with reference to the drawings.

### [5.1 Circuit Structure of High-Frequency Circuit 1D]

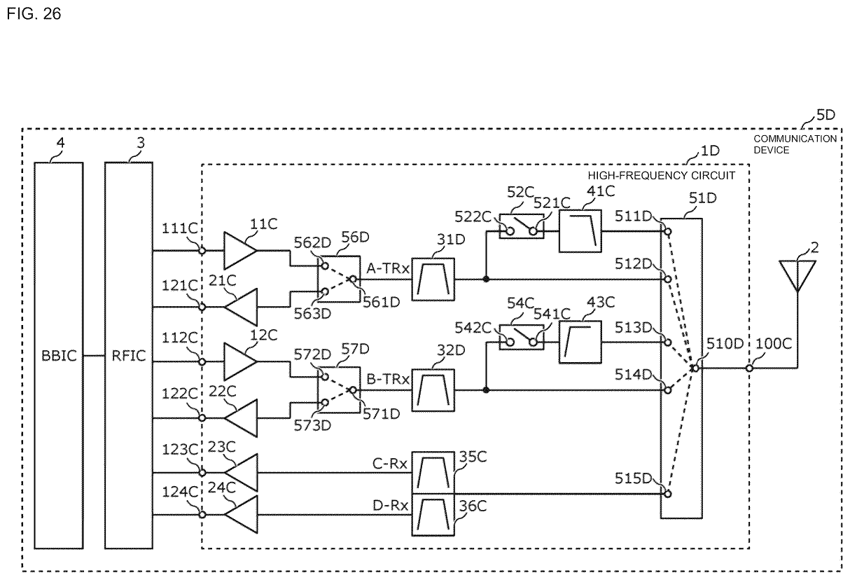

The circuit structure of a high-frequency circuit 1D according to the present modification is described with reference to FIG. 26. FIG. 26 is a circuit structure diagram of a communication device 5D according to the present modification.

Note that FIG. 26 is an exemplary circuit structure and the communication device 5D and the high-frequency circuit 1D can be implemented by using any of various circuit implementations or circuit technologies. Therefore, description of the communication device 5D and the high-frequency circuit 1D provided below is not restrictive.

The communication device 5D according to the present modification is similar to the communication device 5C according to the fourth embodiment except that it includes the high-frequency circuit 1D in place of the high-frequency circuit 1C, and its description is therefore not repeated.

The high-frequency circuit 1D according to the present modification includes: the power amplifiers 11C and 12C; the low-noise amplifiers 21C, 22C, 23C, and 24C; filters 31D, 32D, 35C, 36C, 41C, and 43C; switch circuits 51D, 52C, 54C, 56D, and 57D; the antenna connection terminal 100C; the input terminals 111C and 112C; and the output terminals 121C, 122C, 123C, and 124C.

The filter 31D is one example of the first filter, and is a band pass filter having pass bands including the transmission band and the reception band of the band A. One end of the filter 31D is switchably connected to the power amplifier 11C and the low-noise amplifier 21C. On the other hand, the other end of the filter 31D is connected to a terminal 512D of the switch circuit 51D and is switchably connected via the switch circuit 52C and the filter 41C to a terminal 511D of the switch circuit 51D. The filter 31D is used for transmission and reception of the band A (A-TRx).

The filter 32D is one example of the second filter, and is a band pass filter having pass bands including the transmission band and the reception band of the band B. One end of the filter 32D is switchably connected to the power amplifier 12C and the low-noise amplifier 22C. On the other hand, the other end of the filter 32D is connected to a terminal 514D of the switch circuit 51D and is switchably connected via the switch circuit 54C and the filter 43C to a terminal 513D of the switch circuit 51D. The filter 32D is used for transmission and reception of the band B (B-TRx).

The switch circuit 51D is one example of the first switch circuit, and includes terminals 510D to 515D. The terminal 510D is one example of the first terminal, and is connected to the antenna connection terminal 100C. The terminal 511D is one example of the fourth terminal, and is connected to the filter 41C. The terminal 512D is one example of the second terminal, and is connected to the filter 31D. The terminal 513D is connected to the filter 43C. The terminal 514D is one example of the third terminal, and is connected to the filter 32D. The terminal 515D is connected to the filters 35C and 36C.

In this connection structure, for example, based on a control signal from the RFIC 3, the switch circuit 51D can connect the terminal 510D to the terminals 511D to 515D. The switch circuit 51D is configured of, for example, a multi-connection-type switch circuit.

The switch circuit 56D includes terminals 561D to 563D. The terminal 561D is connected to the filter 31D. The terminal 562D is connected to the output end of the power amplifier 11C. The terminal 563D is connected to the input end of the low-noise amplifier 21C.

In this connection structure, for example, based on a control signal from the RFIC 3, the switch circuit 56D can connect the terminal 561D exclusively to the terminals 562D and 563D. The switch circuit 56D is configured of, for example, an SPDT-type switch circuit.

The switch circuit 57D includes terminals 571D to 573D. The terminal 571D is connected to the filter 32D. The terminal 572D is connected to the output end of the power amplifier 12C. The terminal 573D is connected to the input end of the low-noise amplifier 22C.

In this connection structure, for example, based on a control signal from the RFIC 3, the switch circuit 57D can connect the terminal 571D exclusively to the terminals 572D and 573D. The switch circuit 57D is configured of, for example, an SPDT-type switch circuit.

### [5.2 Communication Modes of Communication Device 5D]

Next, communication modes of the communication device 5D are described.

### [5.2.1 First Mode]

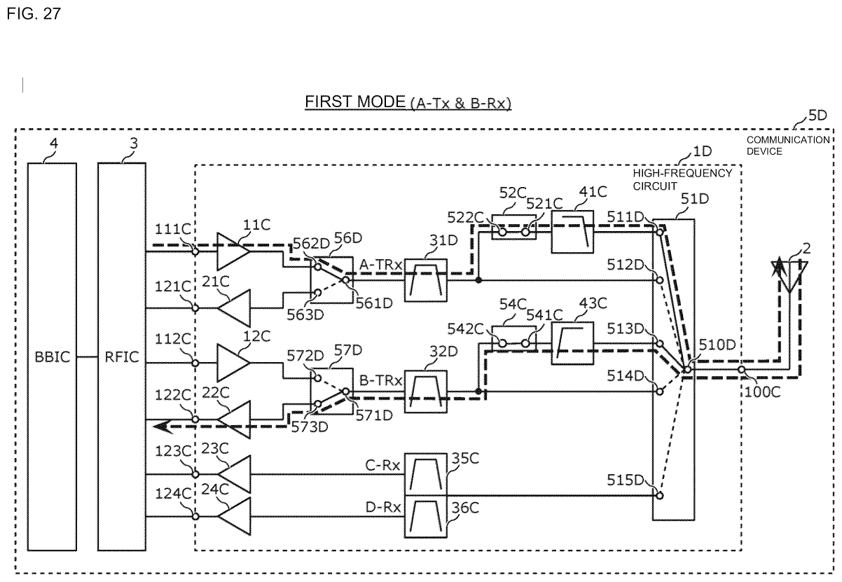

First, a first mode is described with reference to FIG. 27. FIG. 27 is a diagram depicting the first mode of the communication device 5D according to the present modification.

In the first mode, transmission of a signal of the band A and reception of a signal of the band B are simultaneously performed. That is, the first mode corresponds to the first connection type in the above-described first to third embodiments, and is a communication mode for Simultaneous Rx/Tx. As depicted in FIG. 27, in the first mode, the switch circuit 51D connects the terminal 510D to the terminals 511D and 513D and does not connect it to the terminals 512D, 514D, and 515D. Furthermore, the switch circuit 52C connects the terminal 521C to the terminal 522C, and the switch circuit 54C connects the terminal 541C to the terminal 542C. That is, the switch circuits 52C and 54C are closed. Also, the switch circuit 56D connects the terminal 561D to the terminal 562D and does not connect it to the terminal 563D. Furthermore, the switch circuit 57D connects the terminal 571D to the terminal 573D and does not connect it to the terminal 572D. With this, the filters 31D and 41C are connected to the transmission path of the band A, and the filters 32D and 43C are connected to the reception path of the band B.

As a result, the transmission signal of the band A is transferred from the RFIC 3 via the input terminal 111C, the power amplifier 11C, the switch circuit 56D, the filter 31D, the switch circuit 52C, the filter 41C, the switch circuit 51D, and the antenna connection terminal 100C to the antenna 2. The reception signal of the band B is transferred from the antenna 2 via the antenna connection terminal 100C, the switch circuit 51D, the filter 43C, the switch circuit 54C, the filter 32D, the switch circuit 57D, the low-noise amplifier 22C, and the output terminal 122C to the RFIC 3.

### [5.2.2 Second Mode]

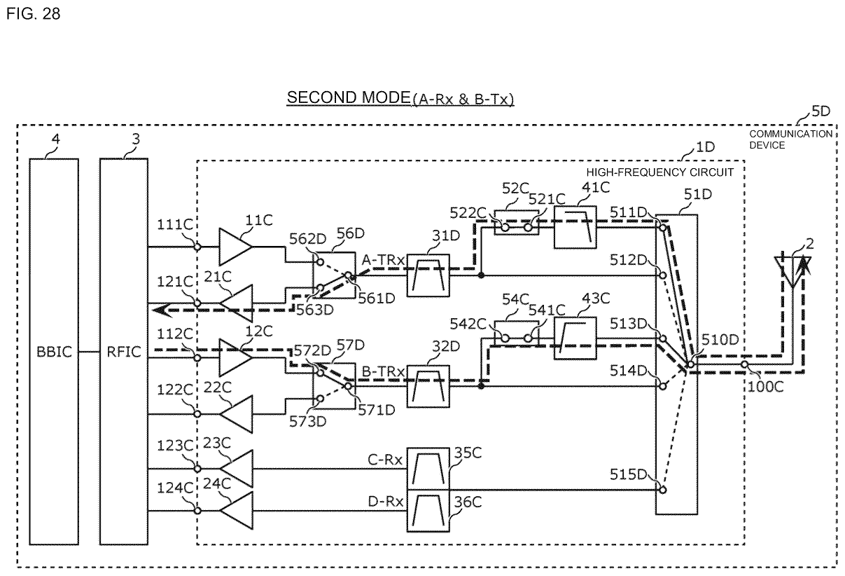

Next, a second mode is described with reference to FIG. 28. FIG. 28 is a diagram depicting the second mode of the communication device 5D according to the present modification.

In the second mode, transmission of a signal of the band B and reception of a signal of the band A are simultaneously performed. That is, the second mode corresponds to the second connection type in the above-described first to third embodiments, and is a communication mode for Simultaneous Rx/Tx. As depicted in FIG. 28, in the second mode, the switch circuit 51D connects the terminal 510D to the terminals 511D and 513D and does not connect it to the terminals 512D, 514D, and 515D. Furthermore, the switch circuit 52C connects the terminal 521C to the terminal 522C, and the switch circuit 54C connects the terminal 541C to the terminal 542C. That is, the switch circuits 52C and 54C are closed. Also, the switch circuit 56D connects the terminal 561D to the terminal 563D and does not connect it to the terminal 562D. Furthermore, the switch circuit 57D connects the terminal 571D to the terminal 572D and does not connect it to the terminal 573D. With this, the filters 31D and 41C are connected to the reception path of the band A, and the filters 32D and 43C are connected to the transmission path of the band B.

As a result, the transmission signal of the band B is transferred from the RFIC 3 via the input terminal 112C, the power amplifier 12C, the switch circuit 57D, the filter 32D, the switch circuit 54C, the filter 43C, the switch circuit 51D, and the antenna connection terminal 100C to the antenna 2. The reception signal of the band A is transferred from the antenna 2 via the antenna connection terminal 100C, the switch circuit 51D, the filter 41C, the switch circuit 52C, the filter 31D, the switch circuit 56D, the low-noise amplifier 21C, and the output terminal 121C to the RFIC 3.

### [5.2.3 Third Mode]

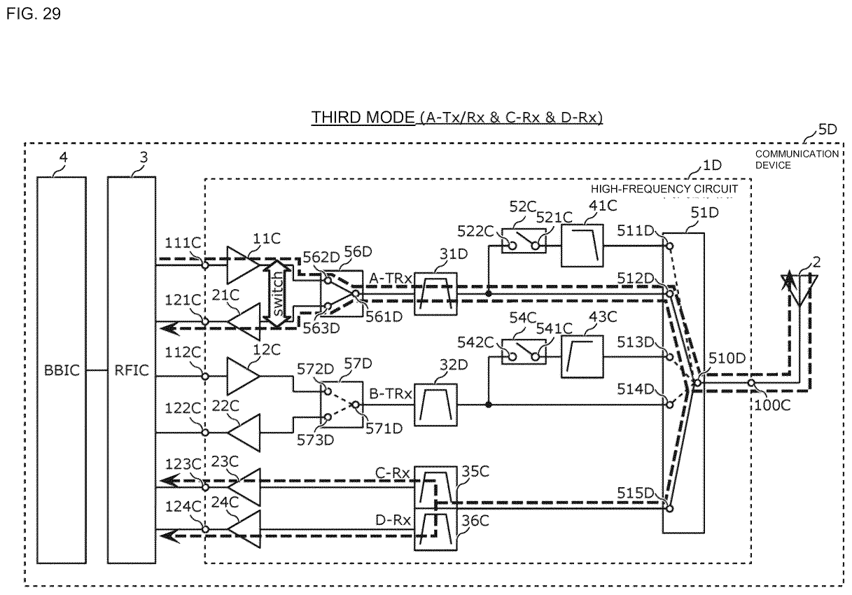

Next, a third mode is described with reference to FIG. 29. FIG. 29 is a diagram depicting the third mode of the communication device 5D according to the present modification.

In the third mode, a switch is made with time between transmission and reception of a signal of the band A, and reception of signals of the bands C and D is performed. As depicted in FIG. 29, in the third mode, the switch circuit 51D connects the terminal 510D to the terminals 512D and 515D and does not connect it to the terminals 511D, 513D, and 514D. The switch circuit 56D switches the connection of the terminal 561D between the terminals 562D and 563D. Here, the switch circuit 52C is opened. With this, the filter 31D is connected to a transmission/reception path of the band A, and the filters 35C and 36C are each connected to reception paths of the bands C and D.

As a result, the transmission signal of the band A is transferred from the RFIC 3 via the input terminal 111C, the power amplifier 11C, the switch circuit 56D, the filter 31D, the switch circuit 51D, and the antenna connection terminal 100C to the antenna 2. The reception signal of the band A is transferred from the antenna 2 via the antenna connection terminal 100C, the switch circuit 51D, the filter 31D, the switch circuit 56D, the low-noise amplifier 21C, and the output terminal 121C to the RFIC 3. The reception signal of the band C is transferred from the antenna 2 via the antenna connection terminal 100C, the switch circuit 51D, the filter 35C, the low-noise amplifier 23C, and the output terminal 123C to the RFIC 3. The reception signal of the band D is transferred from the antenna 2 via the antenna connection terminal 100C, the switch circuit 51D, the filter 36C, the low-noise amplifier 24C, and the output terminal 124C to the RFIC 3.

### [5.2.4 Fourth Mode]

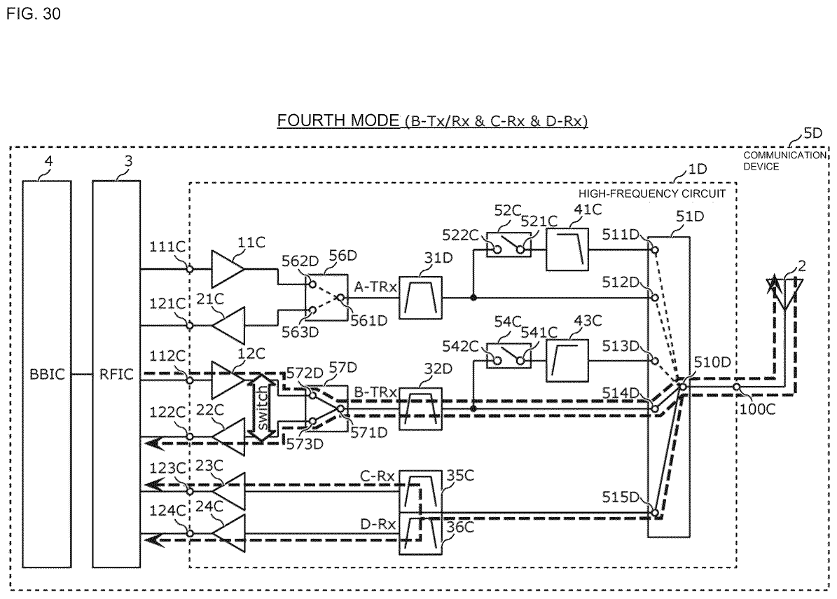

Next, a fourth mode is described with reference to FIG. 30. FIG. 30 is a diagram depicting the fourth mode of the communication device 5D according to the present modification.

In the fourth mode, a switch is made with time between transmission and reception of a signal of the band B, and reception of signals of the bands C and D is performed. As depicted in FIG. 30, in the fourth mode, the switch circuit 51D connects the terminal 510D to the terminals 514D and 515D and does not connect it to the terminals 511D to 513D. The switch circuit 57D switches the connection of the terminal 571D between the terminals 572D and 573D. Here, the switch circuit 54C is opened. With this, the filter 32D is connected to a transmission/reception path of the band B, and the filters 35C and 36C are each connected to reception paths of the bands C and D.

As a result, the transmission signal of the band B is transferred from the RFIC 3 via the input terminal 112C, the power amplifier 12C, the switch circuit 57D, the filter 32D, the switch circuit 51D, and the antenna connection terminal 100C to the antenna 2. The reception signal of the band B is transferred from the antenna 2 via the antenna connection terminal 100C, the switch circuit 51D, the filter 32D, the switch circuit 57D, the low-noise amplifier 22C, and the output terminal 122C to the RFIC 3. The reception signal of the band C is transferred from the antenna 2 via the antenna connection terminal 100C, the switch circuit 51D, the filter 35C, the low-noise amplifier 23C, and the output terminal 123C to the RFIC 3. The reception signal of the band D is transferred from the antenna 2 via the antenna connection terminal 100C, the switch circuit 51D, the filter 36C, the low-noise amplifier 24C, and the output terminal 124C to the RFIC 3.

### [5.3 Overview]

As described above, the high-frequency circuit 1D according to the present modification includes: the filter 31D having a pass band including the band A for TDD; the filter 32D having a pass band including the band B capable of simultaneous transmission and reception with the band A for TDD; the filter 41C having an attenuation band including the band B; the switch circuit 51D including the terminal 510D connected to the antenna connection terminal 100C, terminal 512D connected to the filter 31D, the terminal 514D connected to the filter 32D, and the terminal 511D connected to the filter 41C; and the switch circuit 52C including the terminal 521C connected to the filter 41C and the terminal 522C connected to the filter 31D. The filter 31D is switchably connected via the switch circuit 52C and the filter 41C to the terminal 511D of the switch circuit 51D.

According to this, effects similar to those of the above-described fourth embodiment can be achieved and, furthermore, the number of filters and the number of terminals of the switch circuit 51D can be reduced.

### Second Modification of Fourth Embodiment

Next, a second modification of the above-described fourth embodiment is described. The present modification is different from the above-described fourth embodiment mainly in that a switch circuit for using the filter 41C for both of transmission and reception and a switch circuit for using the filter 43C for both of transmission and reception are included in the high-frequency circuit. In the following, the point of the present modification that is different from the above-described fourth embodiment is mainly described with reference to the drawings.

### [6.1 Circuit Structure of High-Frequency Circuit 1E]

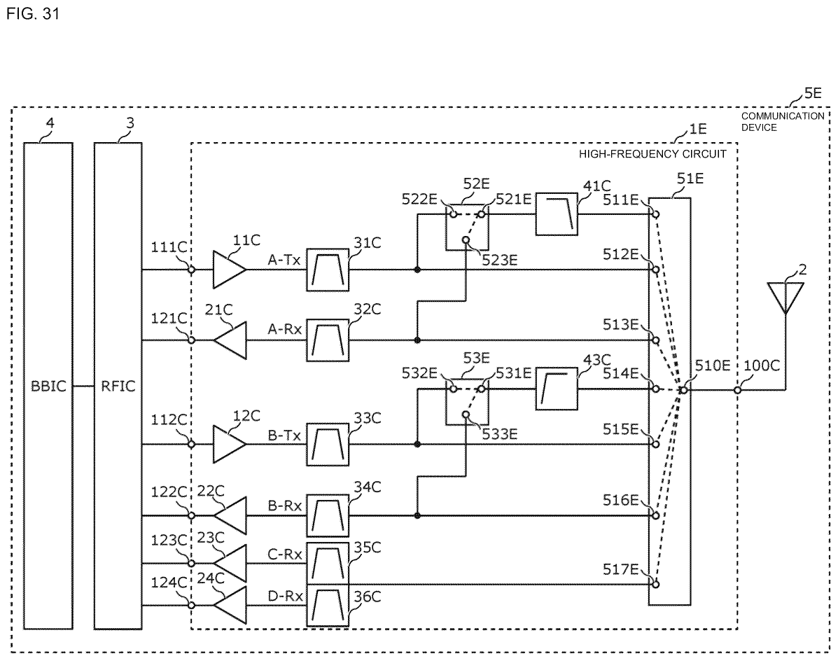

The circuit structure of a high-frequency circuit 1E according to the present modification is described with reference to FIG. 31. FIG. 31 is a circuit structure diagram of a communication device 5E according to the present modification.

Note that FIG. 31 is an exemplary circuit structure and the communication device 5E and the high-frequency circuit 1E can be implemented by using any of various circuit implementations or circuit technologies. Therefore, description of the communication device 5E and the high-frequency circuit 1E provided below is not restrictive.

The communication device 5E according to the present modification is similar to the communication device 5C according to the fourth embodiment except that it includes the high-frequency circuit 1E in place of the high-frequency circuit 1C, and its description is therefore not repeated.

The high-frequency circuit 1E according to the present modification includes: the power amplifiers 11C and 12C; the low-noise amplifiers 21C, 22C, 23C, and 24C; the filters 31C, 32C, 33C, 34C, 35C, 36C, 41C, and 43C; switch circuits 51E, 52E, and 53E; the antenna connection terminal 100C; the input terminals 111C and 112C; and the output terminals 121C, 122C, 123C, and 124C.

The switch circuit 51E is one example of the first switch circuit, and includes terminals 510E to 517E. The terminal 510E is one example of the first terminal, and is connected to the antenna connection terminal 100C. The terminal 511E is one example of the fourth terminal, and is connected to the filter 41C. The terminal 512E is one example of the second terminal, and is connected to the filter 31C. The terminal 513E is one example of the third terminal, and is connected to the filter 32C. The terminal 514E is connected to the filter 43C. The terminal 515E is connected to the filter 33C. The terminal 516E is connected to the filter 34C. The terminal 517E is connected to the filters 35C and 36C.

In this connection structure, for example, based on a control signal from the RFIC 3, the switch circuit 51E can connect the terminal 510E to the terminals 511E to 517E. The switch circuit 51E is configured of, for example, a multi-connection-type switch circuit.

The switch circuit 52E is one example of the second switch circuit, and includes terminals 521E to 523E. The terminal 521E is one example of the fifth terminal, and is connected to the filter 41C. The terminal 522E is one example of the sixth terminal, and is connected to the filter 31C. The terminal 523E is one example of the sixth terminal, and is connected to the filter 32C.

In this connection structure, for example, based on a control signal from the RFIC 3, the switch circuit 52E can connect the terminal 521E exclusively to the terminals 522E and 523E. Specifically, the switch circuit 52E may connect the terminal 521E to the terminal 522E in the first mode, and may connect the terminal 521E to the terminal 523E in the second mode. The switch circuit 52E is configured of, for example, an SPDT-type switch circuit.

The switch circuit 53E includes terminals 531E to 533E. The terminal 531E is connected to the filter 43C. The terminal 532E is connected to the filter 33C. The terminal 533E is connected to the filter 34C.

In this connection structure, for example, based on a control signal from the RFIC 3, the switch circuit 53E can connect the terminal 531E exclusively to the terminals 532E and 533E. Specifically, the switch circuit 53E may connect the terminal 531E to the terminal 533E in the first mode, and may connect the terminal 531E to the terminal 532E in the second mode. The switch circuit 53E is configured of, for example, an SPDT-type switch circuit.

### [6.2 Overview]

As described above, the high-frequency circuit 1E according to the present modification includes: the filter 31C and/or 32C having a pass band including the band A for TDD; the filter 33C and/or 34C having a pass band including the band B capable of simultaneous transmission and reception with the band A for TDD; the filter 41C having an attenuation band including the band B; the switch circuit 51E including the terminal 510E connected to the antenna connection terminal 100C, terminal 512E and/or 513E connected to the filter 31C and/or 32C, the terminal 515E and/or 516E connected to the filter 33C and/or 34C, and the terminal 511E connected to the filter 41C; and the switch circuit 52E including the terminal 521E connected to the filter 41C and the terminal 522E and/or 523E connected to the filter 31C and/or 32C. The filter 31C and/or 32C is switchably connected via the switch circuit 52E and the filter 41C to the terminal 511E of the switch circuit 51E.

According to this, effects similar to those of the above-described fourth embodiment can be achieved and, furthermore, the number of filters and the number of terminals of the switch circuit 51E can be reduced.

### Third Modification of Fourth Embodiment

Next, a third modification of the above-described fourth embodiment is described. The present modification is different from the above-described fourth embodiment mainly in that a switch circuit for using the filter 41C for both of transmission and reception and a switch circuit for using the filter 43C for both of transmission and reception are included in the high-frequency circuit. In the following, the point of the present modification that is different from the above-described fourth embodiment is mainly described with reference to the drawings.

### [7.1 Circuit Structure of High-Frequency Circuit 1F]

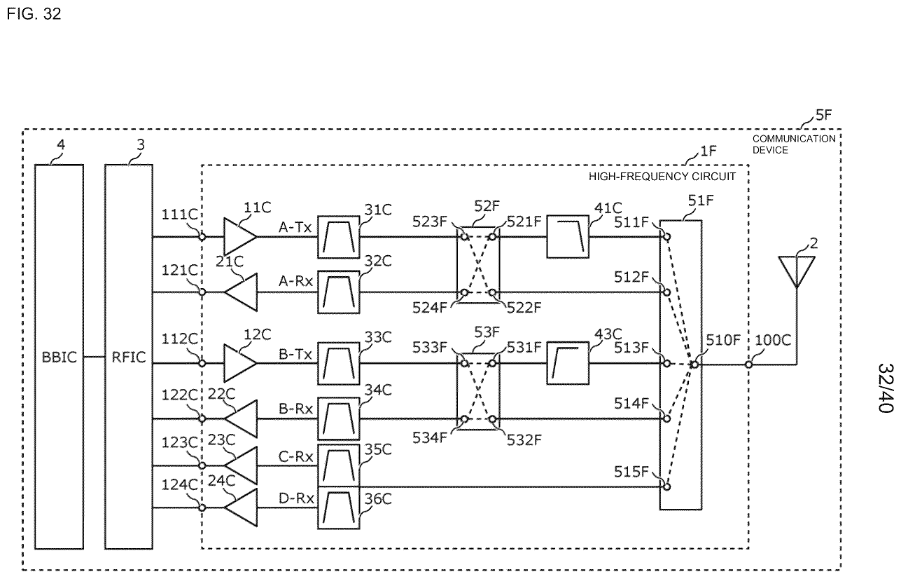

The circuit structure of a high-frequency circuit 1F according to the present modification is described with reference to FIG. 32. FIG. 32 is a circuit structure diagram of a communication device 5F according to the present modification.

Note that FIG. 32 is an exemplary circuit structure and the communication device 5F and the high-frequency circuit 1F can be implemented by using any of various circuit implementations or circuit technologies. Therefore, description of the communication device 5F and the high-frequency circuit 1F provided below is not restrictive.

The communication device 5F according to the present modification is similar to the communication device 5C according to the fourth embodiment except that it includes the high-frequency circuit 1F in place of the high-frequency circuit 1C, and its description is therefore not repeated.

The high-frequency circuit 1F according to the present modification includes: the power amplifiers 11C and 12C; the low-noise amplifiers 21C, 22C, 23C, and 24C; the filters 31C, 32C, 33C, 34C, 35C, 36C, 41C, and 43C; switch circuits 51F, 52F, and 53F; the antenna connection terminal 100C; the input terminals 111C and 112C; and the output terminals 121C, 122C, 123C, and 124C.

The switch circuit 51F is one example of the first switch circuit, and includes terminals 510F to 515F. The terminal 510F is one example of the first terminal, and is connected to the antenna connection terminal 100C. The terminal 511F is one example of the fourth terminal, and is connected to the filter 41C. The terminal 512F is one example of the second terminal, and is switchably connected to the filters 31C and 32C. The terminal 513F is connected to the filter 43C. The terminal 514F is one example of the third terminal, and is switchably connected to the filters 33C and 34C. The terminal 515F is connected to the filters 35C and 36C.

In this connection structure, for example, based on a control signal from the RFIC 3, the switch circuit 51F can connect the terminal 510F to the terminals 511F to 515F. Specifically, the switch circuit 51F may connect the terminal 510F to the terminals 511F and 513F in the first mode and the second mode, may connect the terminal 510F to the terminals 512F and 515F in the third mode, and may connect the terminal 510F to the terminals 514F and 515F in the fourth mode. The switch circuit 51F is configured of, for example, a multi-connection-type switch circuit.

The switch circuit 52F is one example of the second switch circuit, and includes terminals 521F to 524F. The terminal 521F is one example of the fifth terminal, and is connected to the filter 41C. The terminal 522F is one example of the fifth terminal, and is connected to a terminal 512F of the switch circuit 51F. The terminal 523F is one example of the sixth terminal, and is connected to the filter 31C. The terminal 524F is one example of the sixth terminal, and is connected to the filter 32C.

In this connection structure, for example, based on a control signal from the RFIC 3, the switch circuit 52F can connect the terminals 521F and 522F to the terminals 523F and 524F. Specifically, the switch circuit 52F may connect the terminal 521F to the terminal 523F in the first mode, may connect the terminal 521F to the terminal 524F in the second mode, and may switch the connection of the terminal 522F between the terminals 523F and 524F in the third mode. The switch circuit 52F is configured of, for example, a double-pole double-throw (DPDT)-type switch circuit.

The switch circuit 53F includes terminals 531F to 534F. The terminal 531F is connected to the filter 43C. The terminal 532F is connected to the terminal 514F of the switch circuit 51F. The terminal 533F is connected to the filter 33C. The terminal 534F is connected to the filter 34C.

In this connection structure, for example, based on a control signal from the RFIC 3, the switch circuit 53F can connect the terminals 531F and 532F to the terminals 533F and 534F. Specifically, the switch circuit 53F may connect the terminal 531F to the terminal 534F in the first mode, may connect the terminal 531F to the terminal 533F in the second mode, and may switch the connection of the terminal 532F between the terminals 533F and 534F in the third mode. The switch circuit 53F is configured of, for example, a DPDT-type switch circuit.

### Fifth Embodiment

Next, a fifth embodiment is described. The present embodiment is different from the above-described fourth embodiment mainly in that filters 41C to 44C are connected between the filters 31C to 34C and the power amplifiers 11C and 12C and the low-noise amplifiers 21C and 22C. In the following, the point of the present embodiment that is different from the above-described fourth embodiment is mainly described with reference to the drawings.

### [8.1 Circuit Structure of High-Frequency Circuit 1G]

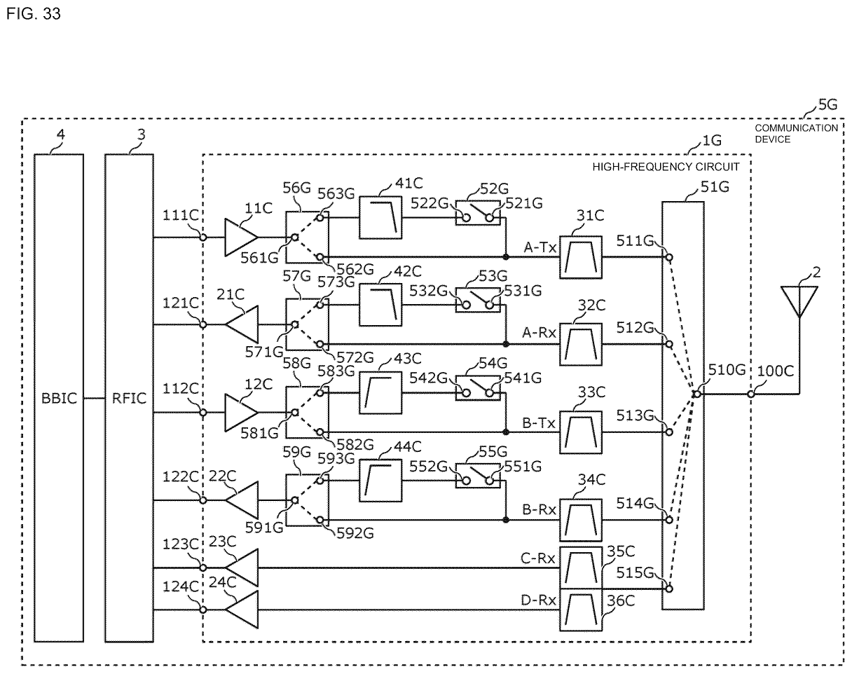

The circuit structure of a high-frequency circuit 1G according to the present embodiment is described with reference to FIG. 33. FIG. 33 is a circuit structure diagram of a communication device 5G according to the present embodiment.

Note that FIG. 33 is an exemplary circuit structure and the communication device 5G and the high-frequency circuit 1G can be implemented by using any of various circuit implementations or circuit technologies. Therefore, description of the communication device 5G and the high-frequency circuit 1G provided below is not restrictive.

The communication device 5G according to the present embodiment is similar to the communication device 5C according to the fourth embodiment except that it includes the high-frequency circuit 1G in place of the high-frequency circuit 1C, and its description is therefore not repeated.

The high-frequency circuit 1G according to the present embodiment includes: the power amplifiers 11C and 12C; the low-noise amplifiers 21C, 22C, 23C, and 24C; the filters 31C, 32C, 33C, 34C, 35C, 36C, 41C, 42C, 43C, and 44C; switch circuits 51G, 52G, 53G, 54G, 55G, 56G, 57G, 58G, and 59G; the antenna connection terminal 100C; the input terminals 111C and 112C; and the output terminals 121C, 122C, 123C, and 124C.

The switch circuit 51G includes terminals 510G to 515G. The terminal 510G is connected to the antenna connection terminal 100C. The terminal 511G is connected to the filter 31C. The terminal 512G is connected to the filter 32C. The terminal 513G is connected to the filter 33C. The terminal 514G is connected to the filter 34C. The terminal 515G is connected to the filters 35C and 36C.

In this connection structure, for example, based on a control signal from the RFIC 3, the switch circuit 51G can connect the terminal 510G to the terminals 511G to 515G. The switch circuit 51G is configured of, for example, a multi-connection-type switch circuit.

The switch circuit 52G is one example of the second switch circuit, and includes terminals 521G and 522G. The terminal 521G is one example of the fourth terminal, and is connected to the filter 31C. The terminal 522G is one example of the fifth terminal, and is connected to the filter 41C.

In this connection structure, for example, based on a control signal from the RFIC 3, the switch circuit 52G can connect the terminal 521G to the terminal 522G. The switch circuit 52G is configured of, for example, an SPST-type switch circuit.

The switch circuit 53G is one example of the second switch circuit, and includes terminals 531G and 532G. The terminal 531G is one example of the fourth terminal, and is connected to the filter 32C. The terminal 532G is one example of the fifth terminal, and is connected to the filter 42C.

In this connection structure, for example, based on a control signal from the RFIC 3, the switch circuit 53G can connect the terminal 531G to the terminal 532G. The switch circuit 53G is configured of, for example, an SPST-type switch circuit.

The switch circuit 54G includes terminals 541G and 542G. The terminal 541G is connected to the filter 33C. The terminal 542G is connected to the filter 43C.

In this connection structure, for example, based on a control signal from the RFIC 3, the switch circuit 54G can connect the terminal 541G to the terminal 542G. The switch circuit 54G is configured of, for example, an SPST-type switch circuit.

The switch circuit 55G includes terminals 551G and 552G. The terminal 551G is connected to the filter 34C. The terminal 552G is connected to the filter 44C.

In this connection structure, for example, based on a control signal from the RFIC 3, the switch circuit 55G can connect the terminal 551G to the terminal 552G. The switch circuit 55G is configured of, for example, an SPST-type switch circuit.

The switch circuit 56G is one example of the first switch circuit, and includes terminals 561G to 563G. The terminal 561G is one example of the first terminal, and is connected to the power amplifier 11C. The terminal 562G is one example of the second terminal, and is connected to the filter 31C. The terminal 563G is one example of the third terminal, and is connected to the filter 41C.

In this connection structure, for example, based on a control signal from the RFIC 3, the switch circuit 56G can connect the terminal 561G exclusively to the terminals 562G and 563G. The switch circuit 56G is configured of, for example, an SPDT-type switch circuit.

The switch circuit 57G is one example of the first switch circuit, and includes terminals 571G to 573G. The terminal 571G is one example of the first terminal, and is connected to the low-noise amplifier 21C. The terminal 572G is one example of the second terminal, and is connected to the filter 32C. The terminal 573G is one example of the third terminal, and is connected to the filter 42C.

In this connection structure, for example, based on a control signal from the RFIC 3, the switch circuit 57G can connect the terminal 571G exclusively to the terminals 572G and 573G. The switch circuit 57G is configured of, for example, an SPDT-type switch circuit.

The switch circuit 58G includes terminals 581G to 583G. The terminal 581G is connected to the power amplifier 12C. The terminal 582G is connected to the filter 33C. The terminal 583G is connected to the filter 43C.

In this connection structure, for example, based on a control signal from the RFIC 3, the switch circuit 58G can connect the terminal 581G exclusively to the terminals 582G and 583G. The switch circuit 58G is configured of, for example, an SPDT-type switch circuit.

The switch circuit 59G includes terminals 591G to 593G. The terminal 591G is connected to the low-noise amplifier 22C. The terminal 592G is connected to the filter 34C. The terminal 593G is connected to the filter 44C.

In this connection structure, for example, based on a control signal from the RFIC 3, the switch circuit 59G can connect the terminal 591G exclusively to the terminals 592G and 593G. The switch circuit 59G is configured of, for example, an SPDT-type switch circuit.

### [8.2 Communication Modes of Communication Device 5G]

Next, communication modes of the communication device 5G are described.

### [8.2.1 First Mode]

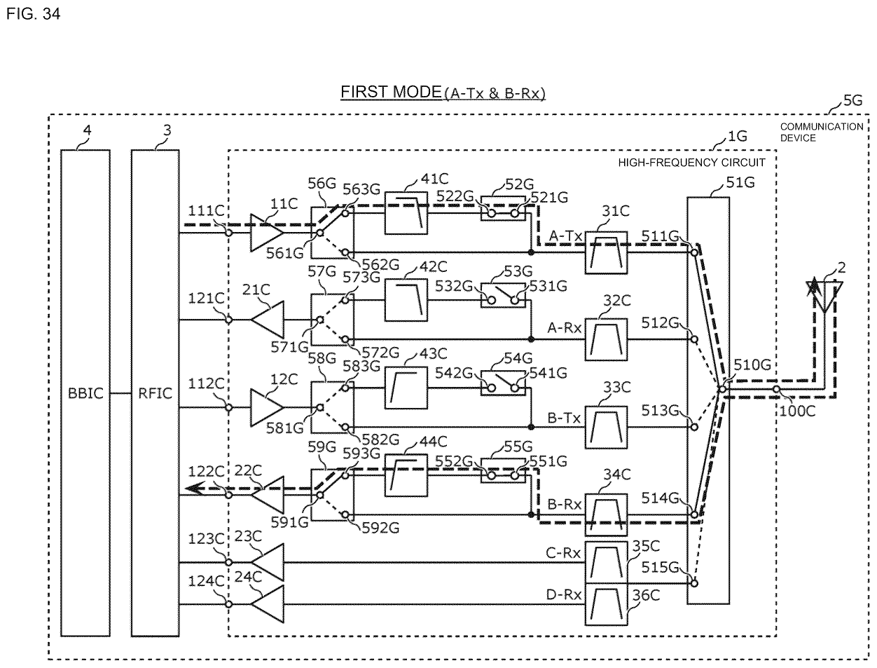

First, a first mode is described with reference to FIG. 34. FIG. 34 is a diagram depicting the first mode of the communication device 5G according to the present embodiment.

In the first mode, transmission of a signal of the band A and reception of a signal of the band B are simultaneously performed. That is, the first mode corresponds to the first connection type in the above-described first to third embodiments, and is a communication mode for Simultaneous Rx/Tx. As depicted in FIG. 34, in the first mode, the switch circuit 51G connects the terminal 510G to the terminals 511G and 514G and does not connect it to the terminals 512G, 513G, and 515G. The switch circuit 52G connects the terminal 521G to the terminal 522G, and the switch circuit 55G connects the terminal 551G to the terminal 552G. That is, the switch circuits 52G and 55G are closed. Here, the switch circuits 53G and 54G are opened. With this, the filters 31C and 41C are connected to the transmission path of the band A, and the filters 34C and 44C are connected to the reception path of the band B.

As a result, the transmission signal of the band A is transferred from the RFIC 3 via the input terminal 111C, the power amplifier 11C, the switch circuit 56G, the filter 41C, the switch circuit 52G, the filter 31C, the switch circuit 51G, and the antenna connection terminal 100C to the antenna 2. The reception signal of the band B is transferred from the antenna 2 via the antenna connection terminal 100C, the switch circuit 51G, the filter 34C, the switch circuit 55G, the filter 44C, the switch circuit 59G, the low-noise amplifier 22C, and the output terminal 122C to the RFIC 3.

### [8.2.2 Second Mode]

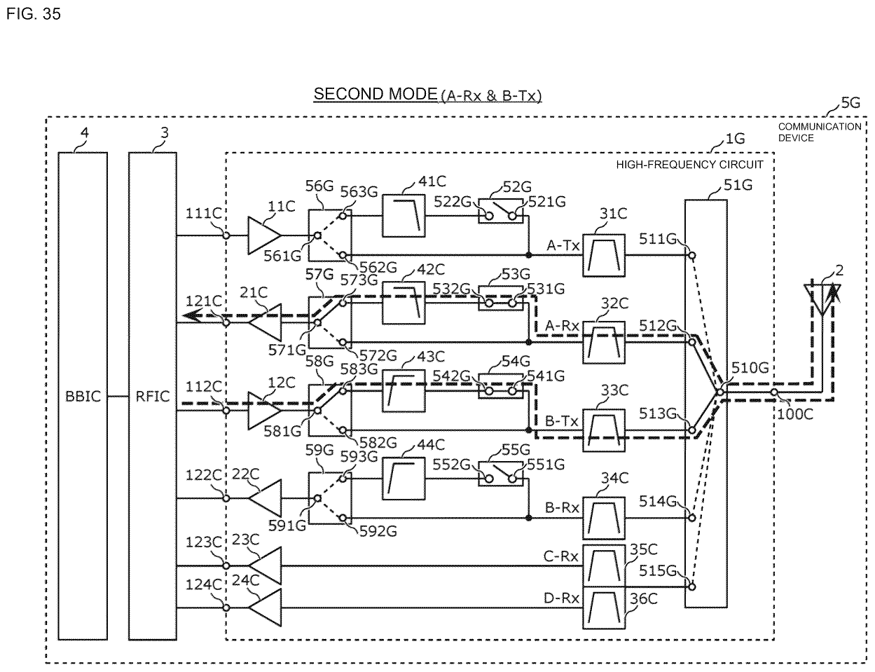

Next, a second mode is described with reference to FIG. 35. FIG. 35 is a diagram depicting the second mode of the communication device 5G according to the present embodiment.

In the second mode, transmission of a signal of the band B and reception of a signal of the band A are simultaneously performed. That is, the second mode corresponds to the second connection type in the above-described first to third embodiments, and is a communication mode for Simultaneous Rx/Tx. As depicted in FIG. 35, in the second mode, the switch circuit 51G connects the terminal 510G to the terminals 512G and 513G and does not connect it to the terminals 511G, 514G, and 515G. The switch circuit 53G connects the terminal 531G to the terminal 532G, and the switch circuit 54G connects the terminal 541G to the terminal 542G. That is, the switch circuits 53G and 54G are closed. Here, the switch circuits 52G and 55G are opened. With this, the filters 32C and 42C are connected to the reception path of the band A, and the filters 33C and 43C are connected to the transmission path of the band B.

As a result, the transmission signal of the band B is transferred from the RFIC 3 via the input terminal 112C, the power amplifier 12C, the switch circuit 58G, the filter 43C, the switch circuit 54G, the filter 33C, the switch circuit 51G, and the antenna connection terminal 100C to the antenna 2. The reception signal of the band A is transferred from the antenna 2 via the antenna connection terminal 100C, the switch circuit 51G, the filter 32C, the switch circuit 53G, the filter 42C, the switch circuit 57G, the low-noise amplifier 21C, and the output terminal 121C to the RFIC 3.

### [8.2.3 Third Mode]

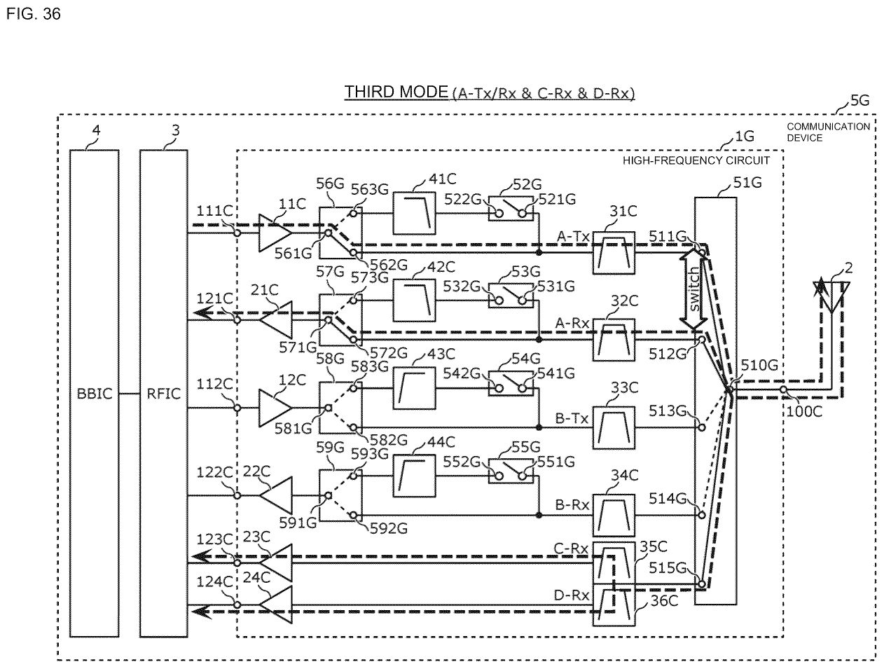

Next, a third mode is described with reference to FIG. 36. FIG. 36 is a diagram depicting the third mode of the communication device 5G according to the present embodiment.

In the third mode, a switch is made with time between transmission and reception of a signal of the band A, and reception of signals of the bands C and D is performed. As depicted in FIG. 36, in the third mode, while connecting the terminal 510G to the terminal 515G, the switch circuit 51G switches the connection of the terminal 510G between the terminals 511G and 512G. Here, the switch circuit 51G does not connect the terminal 510G to the terminals 513G and 514G. With this, the filter 31C is connected to a transmission path of the band A, the filter 32C is connected to a reception path of the band A, and the filters 35C and 36C are each connected to reception paths of the bands C and D.

As a result, the transmission signal of the band A is transferred from the RFIC 3 via the input terminal 111C, the power amplifier 11C, the switch circuit 56G, the filter 31C, the switch circuit 51G, and the antenna connection terminal 100C to the antenna 2. The reception signal of the band A is transferred from the antenna 2 via the antenna connection terminal 100C, the switch circuit 51G, the filter 32C, the switch circuit 57G, the low-noise amplifier 21C, and the output terminal 121C to the RFIC 3. The reception signal of the band C is transferred from the antenna 2 via the antenna connection terminal 100C, the switch circuit 51G, the filter 35C, the low-noise amplifier 23C, and the output terminal 123C to the RFIC 3. The reception signal of the band D is transferred from the antenna 2 via the antenna connection terminal 100C, the switch circuit 51G, the filter 36C, the low-noise amplifier 24C, and the output terminal 124C to the RFIC 3.

### [8.2.4 Fourth Mode]

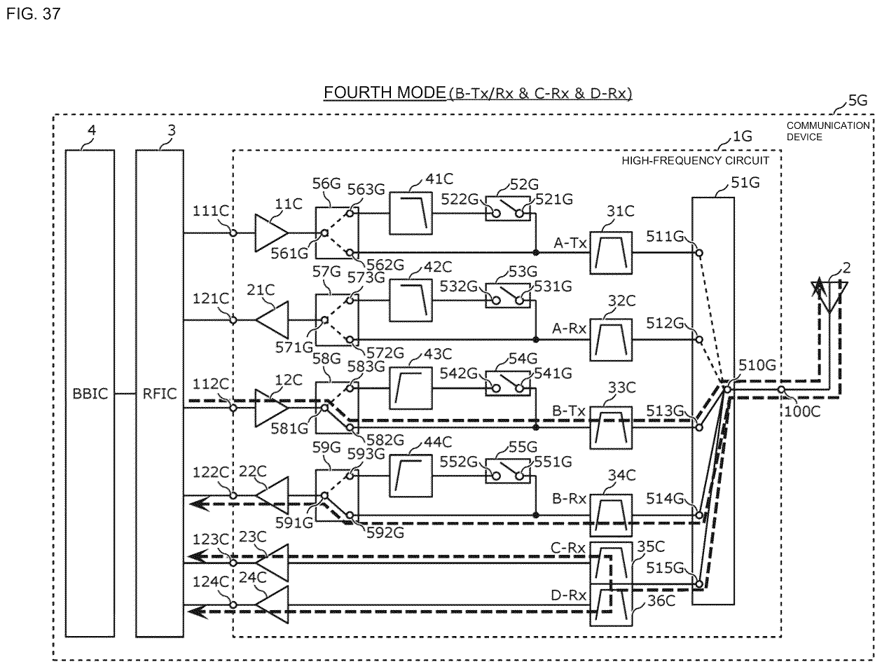

Next, a fourth mode is described with reference to FIG. 37. FIG. 37 is a diagram depicting the fourth mode of the communication device 5G according to the present embodiment.

In the fourth mode, a switch is made with time between transmission and reception of a signal of the band B, and reception of signals of the bands C and D is performed. As depicted in FIG. 37, in the fourth mode, while connecting the terminal 510G to the terminal 515G, the switch circuit 51G switches the connection of the terminal 510G between the terminals 513G and 514G. Here, the switch circuit 51G does not connect the terminal 510G to the terminals 511G and 512G. With this, the filter 33C is connected to a transmission path of the band B, the filter 34C is connected to a reception path of the band B, and the filters 35C and 36C are each connected to reception paths of the bands C and D.

As a result, the transmission signal of the band B is transferred from the RFIC 3 via the input terminal 112C, the power amplifier 12C, the switch circuit 58G, the filter 33C, the switch circuit 51G, and the antenna connection terminal 100C to the antenna 2. The reception signal of the band B is transferred from the antenna 2 via the antenna connection terminal 100C, the switch circuit 51G, the filter 34C, the switch circuit 59G, the low-noise amplifier 22C, and the output terminal 122C to the RFIC 3. The reception signal of the band C is transferred from the antenna 2 via the antenna connection terminal 100C, the switch circuit 51G, the filter 35C, the low-noise amplifier 23C, and the output terminal 123C to the RFIC 3. The reception signal of the band D is transferred from the antenna 2 via the antenna connection terminal 100C, the switch circuit 51G, the filter 36C, the low-noise amplifier 24C, and the output terminal 124C to the RFIC 3.

### [8.3 Overview]

As described above, the high-frequency circuit 1G according to the present embodiment includes: the filter 31C and/or 32C having a pass band including the band A for TDD; the filter 33C and/or 34C having a pass band including the band B capable of simultaneous transmission and reception with the band A for TDD; the filter 41C and/or 42C having an attenuation band including the band B; the switch circuit 56G and/or 57G including the terminal 561G and/or 571G connected to the power amplifier 11C and/or the low-noise amplifier 21C, the terminal 562G and/or 572G connected to the filter 31C and/or 32C, and the terminal 563G and/or 573G connected to the filter 41C and/or 42C; and the switch circuit 52G and/or 53G including the terminal 521G and/or 531G connected to the filter 31C and/or 32C and the terminal 522G and/or 532G connected to the filter 41C and/or 42C. The filter 31C and/or 32C is switchably connected via the switch circuit 52G and/or 53G and the filter 41C and/or 42C to the terminal 563G and/or 573G of the switch circuit 56G and/or 57G.

According to this, effects similar to those of the above-described fourth embodiment can be achieved.

### Sixth Embodiment

Next, a sixth embodiment is described. The present embodiment is different from the above-described fourth embodiment mainly in that the high-frequency circuit does not include a transmission circuit and includes only a reception circuit. In the following, the point of the present embodiment that is different from the above-described fourth embodiment is mainly described with reference to the drawings.

### [9.1 Circuit Structure of High-Frequency Circuit 1H]

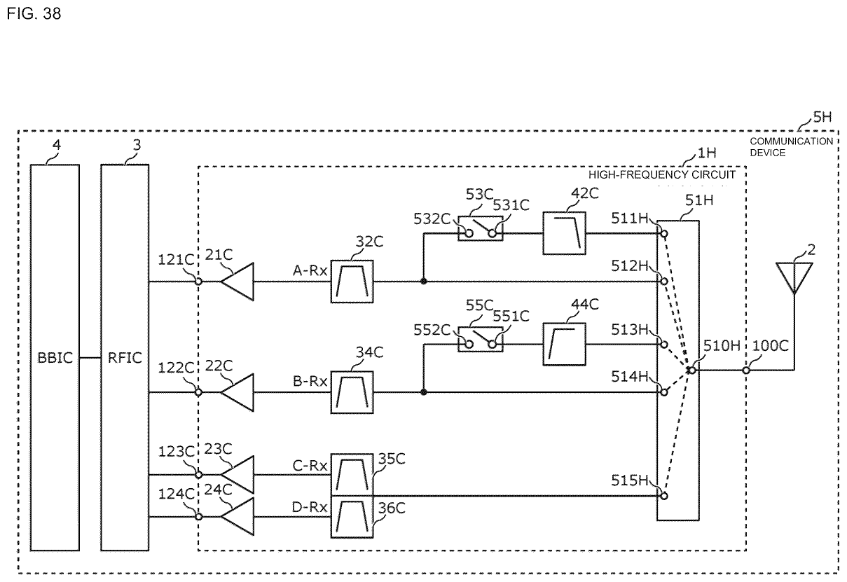

The circuit structure of a high-frequency circuit 1H according to the present embodiment is described with reference to FIG. 38. FIG. 38 is a circuit structure diagram of a communication device 5H according to the present embodiment.

Note that FIG. 38 is an exemplary circuit structure and the communication device 5H and the high-frequency circuit 1H can be implemented by using any of various circuit implementations or circuit technologies. Therefore, description of the communication device 5H and the high-frequency circuit 1H provided below is not restrictive.

The communication device 5H according to the present embodiment is similar to the communication device 5C according to the fourth embodiment except that it includes the high-frequency circuit 1H in place of the high-frequency circuit 1C, and its description is therefore not repeated.

The high-frequency circuit 1H according to the present embodiment includes: the low-noise amplifiers 21C, 22C, 23C, and 24C; the filters 32C, 34C, 35C, 36C, 42C, and 44C; switch circuits 51H, 53C, and 55C; the antenna connection terminal 100C; and the output terminals 121C, 122C, 123C, and 124C.

The switch circuit 51H includes terminals 510H to 515H. The terminal 510H is connected to the antenna connection terminal 100C. The terminal 511H is connected to the filter 42C. The terminal 512H is connected to the filter 32C. The terminal 513H is connected to the filter 44C. The terminal 514H is connected to the filter 34C. The terminal 515H is connected to the filters 35C and 36C.

In this connection structure, for example, based on a control signal from the RFIC 3, the switch circuit 51H can connect the terminal 510H to the terminals 511H to 515H. The switch circuit 51H is configured of, for example, a multi-connection-type switch circuit.

### [9.2 Overview]

Note that the communication device 5H may include a transmission circuit for the band A and/or the band B (not depicted) separately from the high-frequency circuit 1H. In this case, by using the high-frequency circuit 1H and the transmission circuit, the communication device 5H can achieve Simultaneous Rx/Tx. Furthermore, in Simultaneous Rx/Tx, by connecting the filter 42C or 44C to the reception path, it is possible to suppress the transmission signal of one of the bands A and B from interfering with the reception signal of the other one of the bands A and B and improve the quality of the reception signal of the other one of the bands A and B.

### Seventh Embodiment

Next, a seventh embodiment is described. The present embodiment is different from the above-described fourth embodiment mainly in that the band pass filter and Simultaneous Rx/Tx are included in different high-frequency circuits. In the following, the point of the present embodiment that is different from the above-described fourth embodiment is mainly described with reference to the drawings.

### [10.1 Circuit Structure of High-Frequency Circuits 1I and 1J]

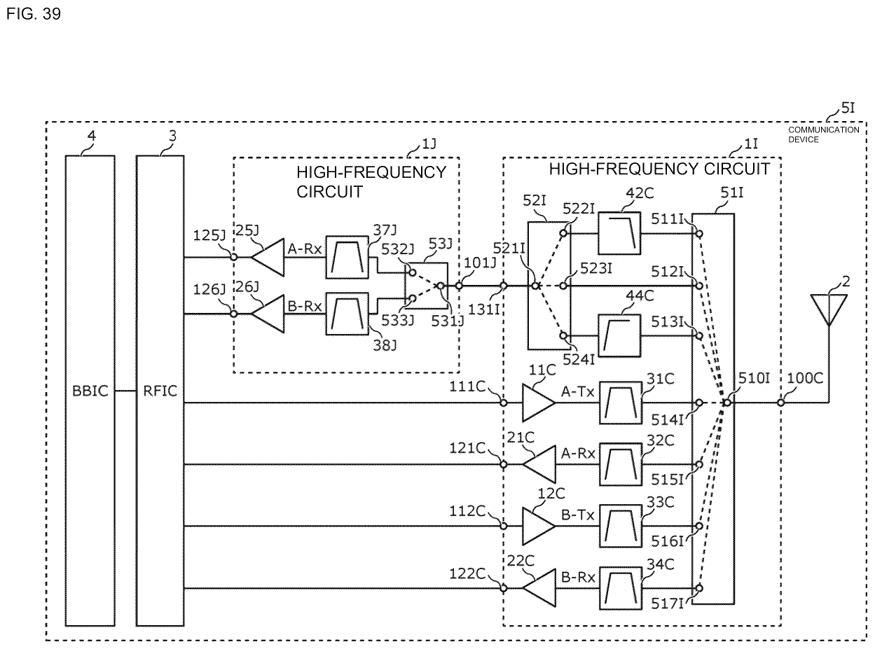

The circuit structure of high-frequency circuits 1I and 1J according to the present embodiment is described with reference to FIG. 39. FIG. 39 is a circuit structure diagram of a communication device 5I according to the present embodiment.

Note that FIG. 39 is an exemplary circuit structure and the communication device 51 and the high-frequency circuits 1I and 1J can be implemented by using any of various circuit implementations or circuit technologies. Therefore, description of the communication device 5I and the high-frequency circuits 1I and 1J provided below is not restrictive.

The communication device 5I according to the present embodiment is similar to the communication device 5C according to the fourth embodiment except that it includes the high-frequency circuits 1I and 1J in place of the high-frequency circuit 1C, and its description is therefore not repeated.

The high-frequency circuit 1I according to the present embodiment includes: the power amplifiers 11C and 12C; the low-noise amplifiers 21C and 22C; the filters 31C, 32C, 33C, 34C, 42C, and 44C; switch circuits 51I and 521; the antenna connection terminal 100C; the input terminals 111C and 112C; and output terminals 121C, 122C, and 131I.

The output terminal 131I is an external connection terminal of the high-frequency circuit 1I, and is a high-frequency output terminal. The output terminal 131I is connected to the high-frequency circuit 1J outside the high-frequency circuit 1I, and is connected to the switch circuit 52I inside the high-frequency circuit 11. The output terminal 131I can supply reception signals of the bands A and B to the high-frequency circuit 1J.

The switch circuit 51I includes terminals 510I to 517I. The terminal 510I is connected to the antenna connection terminal 100C. The terminal 511I is connected to the filter 42C. The terminal 512I is connected to the switch circuit 52I not via the filters 42C and 44C. The terminal 513I is connected to the filter 44C. The terminal 514I is connected to the filter 31C. The terminal 515I is connected to the filter 32C. The terminal 516I is connected to the filter 33C. The terminal 517I is connected to the filter 34C.

In this connection structure, for example, based on a control signal from the RFIC 3, the switch circuit 51I can connect the terminal 510I to the terminals 511I to 517I. Specifically, the switch circuit 51I may connect the terminal 510I to the terminals 513I and 514I in the first mode, may connect the terminal 510I to the terminals 511I and 516I in the second mode, may switch the connection of the terminal 510I between the terminals 5121 and 514I in the third mode, and may switch the connection of the terminal 510I between the terminals 5121 and 516I in the fourth mode. The switch circuit 51I is configured of, for example, a multi-connection-type switch circuit.

The switch circuit 52I includes terminals 521I to 524I. The terminal 521I is connected to the output terminal 131I. The terminal 522I is connected to the filter 42C. The terminal 523I is connected to the switch circuit 51I not via the filters 42C and 44C. The terminal 524I is connected to the filter 44C.

In this connection structure, for example, based on a control signal from the RFIC 3, the switch circuit 52I can connect the terminal 521I exclusively to the terminals 522I to 524I. Specifically, the switch circuit 52I may connect the terminal 521I to the terminal 524I in the first mode, may connect the terminal 521I to the terminal 522I in the second mode, and may connect the terminal 521I to the terminal 523I in the third mode and the fourth mode. The switch circuit 52I is configured of, for example, a multi-connection-type switch circuit.

The high-frequency circuit 1J according to the present embodiment includes: low-noise amplifiers 25J and 26J; filters 37J and 38J; a switch circuit 53J; an input terminal 101J; and output terminals 125J and 126J.

The input terminal 101J is an external connection terminal of the high-frequency circuit 1J, and is a high-frequency input terminal. The input terminal 101J is connected to the high-frequency circuit 1I outside the high-frequency circuit 1J, and is connected to the switch circuit 53J inside the high-frequency circuit 1J. The input terminal 101J can receive reception signals of the bands A and B from the high-frequency circuit 1I.

Each of the output terminals 125J and 126J is an external connection terminal of the high-frequency circuit 1J, and is a high-frequency output terminal.

The input end of the low-noise amplifier 25J is connected to the filter 37J. The output end of the low-noise amplifier 25J is connected to the output terminal 125J. By using electric power supplied from a power supply (not depicted), the low-noise amplifier 25J can amplify a reception signal of the band A passing through the filter 37J. Note that an entire or part of the low-noise amplifier 25J may not be included in the high-frequency circuit 1J. In this case, an entire or part of the low-noise amplifier 25J may be connected between the RFIC 3 and the output terminal 125J or may be included in the RFIC 3.

The input end of the low-noise amplifier 26J is connected to the filter 38J. The output end of the low-noise amplifier 26J is connected to the output terminal 126J. By using electric power supplied from a power supply (not depicted), the low-noise amplifier 26J can amplify a reception signal of the band B passing through the filter 38J. Note that an entire or part of the low-noise amplifier 26J may not be included in the high-frequency circuit 1J. In this case, an entire or part of the low-noise amplifier 26J may be connected between the RFIC 3 and the output terminal 126J or may be included in the RFIC 3.

The filter 37J is a band pass filter having a pass band including the reception band of the band A. One end of the filter 37J is connected to the low-noise amplifier 25J. On the other hand, the other end of the filter 37J is connected to a terminal 532J of the switch circuit 53J. The filter 37J is used for reception of the band A (A-Rx).

The filter 38J is a band pass filter having a pass band including the reception band of the band B. One end of the filter 38J is connected to the low-noise amplifier 26J. On the other hand, the other end of the filter 38J is connected to a terminal 533J of the switch circuit 53J. The filter 38J is used for reception of the band B (B-Rx).

The switch circuit 53J includes terminals 531J to 533J. The terminal 531J is connected to the input terminal 101J. The terminal 532J is connected to the filter 37J. The terminal 533J is connected to the filter 38J.

In this connection structure, for example, based on a control signal from the RFIC 3, the switch circuit 53J can connect the terminal 531J exclusively to the terminals 532J and 533J. Specifically, the switch circuit 53J may connect the terminal 531J to the terminal 533J in the first mode, may connect the terminal 531J to the terminal 532J in the second mode, may connect the terminal 531J to the terminal 532J in the third mode, and may connect the terminal 531J to the terminal 533J in the fourth mode. The switch circuit 53J is configured of, for example, an SPDT-type switch circuit.

### [10.2 Overview]

According to the communication device 51 of the present embodiment, effects similar to those of the above-described fourth embodiment can be achieved.

### Modification of Seventh Embodiment

Next, a modification of the seventh embodiment is described. The present modification is different from the above-described seventh embodiment mainly in that a path capable of connecting the filters 37J and 38J to the antenna connection terminal 100C not via the switch circuit 521 is provided. In the following, the point of the present modification that is different from the above-described seventh embodiment is mainly described with reference to the drawings.

### [11.1 Circuit Structure of High-Frequency Circuits 1K and 1L]

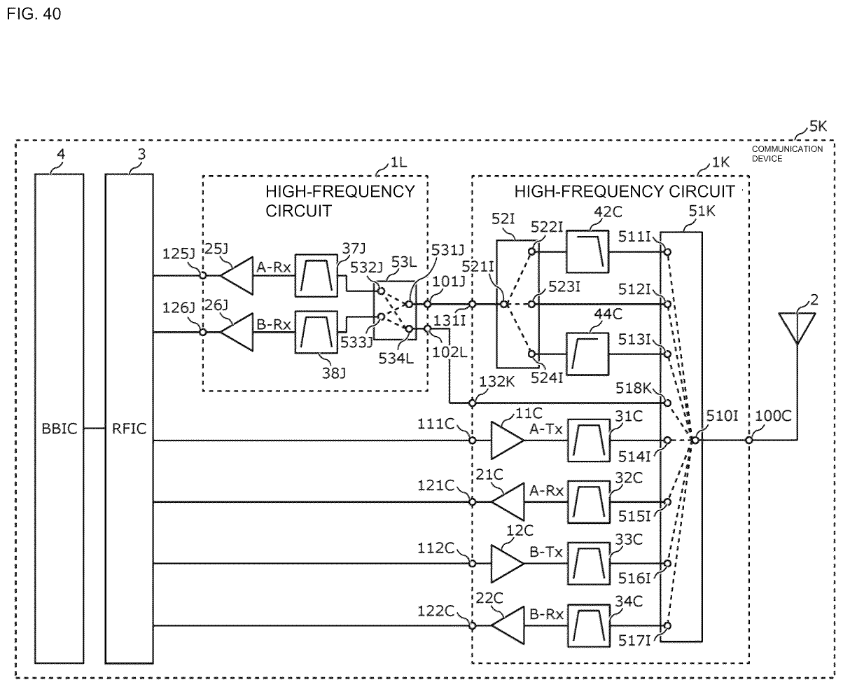

The circuit structure of high-frequency circuits 1K and 1L according to the present modification is described with reference to FIG. 40. FIG. 40 is a circuit structure diagram of a communication device 5K according to the present modification.

Note that FIG. 40 is an exemplary circuit structure and the communication device 5K and the high-frequency circuits 1K and 1L can be implemented by using any of various circuit implementations or circuit technologies. Therefore, description of the communication device 5K and the high-frequency circuits 1K and 1L provided below is not restrictive.

The communication device 5K according to the present modification is similar to the communication device 5C according to the fourth embodiment except that it includes the high-frequency circuits 1K and 1L in place of the high-frequency circuit 1C, and its description is therefore not repeated.

The high-frequency circuit 1K according to the present modification includes: the power amplifiers 11C and 12C; the low-noise amplifiers 21C and 22C; the filters 31C, 32C, 33C, 34C, 42C, and 44C; switch circuits 51K and 521; the antenna connection terminal 100C; the input terminals 111C and 112C; and output terminals 121C, 122C, 131I, and 132K. That is, the present modification is different from the high-frequency circuit 1I according to the above-described seventh embodiment in that the high-frequency circuit 1K includes the switch circuit 51K in place of the switch circuit 51I and further includes the output terminal 132K.

The output terminal 132K is an external connection terminal of the high-frequency circuit 1K, and is a high-frequency output terminal. The output terminal 132K is connected to the high-frequency circuit 1L outside the high-frequency circuit 1K, and is connected to the switch circuit 51K inside the high-frequency circuit 1K.

The switch circuit 51K includes a terminal 518K in addition to the terminals 510I to 517I. The terminal 518K is connected to the output terminal 132K.

In this connection structure, for example, based on a control signal from the RFIC 3, the switch circuit 51K can connect the terminal 510I to the terminals 511I to 517I and 518K. Specifically, the switch circuit 51K may connect the terminal 510I to the terminals 513I and 514I in the first mode, may connect the terminal 510I to the terminals 511I and 516I in the second mode, may switch the connection of the terminal 510I between the terminals 514I and 518K in the third mode, and may switch the connection of the terminal 510I between the terminals 5161 and 518K in the fourth mode. The switch circuit 51K is configured of, for example, a multi-connection-type switch circuit.

The high-frequency circuit 1L according to the present modification includes: the low-noise amplifiers 25J and 26J; the filters 37J and 38J; a switch circuit 53L; input terminals 101J and 102L; and the output terminals 125J and 126J.

The input terminal 102L is an external connection terminal of the high-frequency circuit 1L, and is a high-frequency input terminal. The input terminal 102L is connected to the high-frequency circuit 1K outside the high-frequency circuit 1L, and is connected to the switch circuit 53L inside the high-frequency circuit 1L. The input terminal 102L can receive reception signals of the bands A and B from the high-frequency circuit 1K.

The switch circuit 53L includes a terminal 534L in addition to the terminals 531J to 533J. The terminal 534L is connected to the input terminal 102L.

In this connection structure, for example, based on a control signal from the RFIC 3, the switch circuit 53L can connect the terminals 531J and 534L to the terminals 532J and 533J. Specifically, the switch circuit 53L may connect the terminal 531J to the terminal 533J in the first mode, may connect the terminal 531J to the terminal 532J in the second mode, may connect the terminal 534L to the terminal 532J in the third mode, and may connect the terminal 534L to the terminal 533J in the fourth mode. The switch circuit 53L is configured of, for example, an SPDT-type switch circuit.

### [11.2 Overview]

According to the communication device 5K of the present modification, a signal loss by the switch circuit 52I can be suppressed in the third mode and the fourth mode more than the above-described seventh embodiment.

### OTHER EMBODIMENTS

While the high-frequency circuit according to an aspect of the present disclosure has been described based on the embodiments, the high-frequency circuit according to the present disclosure is not limited to the above-described embodiments. Another embodiment achieved by combining any components in the above-described embodiments, a modification obtained by applying various modifications conceived by a person skilled in the art to any of the above-described embodiments in a range not deviating from the gist of the present disclosure, and various devices having the above-described high-frequency circuit incorporated therein are included in the present disclosure.

For example, in the circuit structure of the high-frequency circuit according to each of the above-described embodiments, another circuit element, wire, or the like may be inserted into a path connecting each circuit element and a signal path disclosed in the drawings. For example, an impedance matching circuit may be inserted between a power amplifier and/or the low-noise amplifier and a filter. Also, for example, an impedance matching circuit may be inserted between a filter and the antenna. The impedance matching circuit can be configured of, for example, an inductor and/or capacitor, but is not particularly restrictive.

Also, a filter may be added to the high-frequency circuit according to each of the above-described embodiments. The added filter may be connected to, for example, the terminal 528 of the switch circuit 52B, or may be connected to another terminal.

Note that the communication device according to each embodiment may have, in addition to the antenna 2, another antenna added thereto. In that case, the switch circuit 53 may have a terminal added thereto, and the added antenna may be connected to the added terminal of the switch circuit 53. Here, the added terminal may be connected exclusively to the terminals 532 and 533. Also, the switch circuits 51C, 51D, 51E, 51F, 51G, 51H, 51I, or 51K may have a terminal added thereto, and the added antenna may be connected to the added terminal of the switch circuit 51C, 51D, 51E, 51F, 51G, 51H, 51I, or 51K.

The features of the high-frequency circuit described based on the above-described embodiments are as follows.

<1>

A high-frequency circuit including:
a first power amplifier;
a first low-noise amplifier and a second low-noise amplifier;
a first filter having a pass band including a first band for time division duplex and switchably connected to the first power amplifier;
a second filter having a pass band including a second band for time division duplex capable of simultaneous transmission and reception with the first band and switchably connected to the first power amplifier;
a third filter having a pass band including the first band and connected to the first low-noise amplifier;
a fourth filter having a pass band including the second band and connected to the second low-noise amplifier;
a fifth filter having a pass band including the first band and having one end switchably connected to each of the first filter and the third filter and another end connected to a first input/output terminal;
a sixth filter having a pass band including the second band and having one end switchably connected to each of the second filter and the fourth filter and another end connected to the first input/output terminal;
a first switch circuit including a first terminal connected to the first power amplifier and a second terminal and a third terminal connected to the first filter and the second filter, respectively; and
a second switch circuit including a fourth terminal, a fifth terminal, a sixth terminal, a seventh terminal, an eighth terminal, and a ninth terminal connected to the first filter, the second filter, the third filter, the fourth filter, the fifth filter, and the sixth filter, respectively, and a tenth terminal connected to a second input/output terminal not via the fifth filter and the sixth filter.
   <2>

The high-frequency circuit according to <1>, further including:
a third switch circuit including an eleventh terminal connected to an antenna, a twelfth terminal connected to the first input/output terminal, and a thirteenth terminal connected to the second input/output terminal.
   <3>

The high-frequency circuit according to <2>, in which
when transmission of a signal of the first band and reception of a signal of the second band are simultaneously performed, the first switch circuit connects the first terminal to the second terminal, the second switch circuit connects the fourth terminal to the eighth terminal and connects the seventh terminal to the ninth terminal, and the third switch circuit connects the eleventh terminal to the twelfth terminal.
   <4>

The high-frequency circuit according to <2> or <3>, in which
when reception of a signal of the first band and transmission of a signal of the second band are simultaneously performed, the first switch circuit connects the first terminal to the third terminal, the second switch circuit connects the fifth terminal to the ninth terminal and connects the sixth terminal to the eighth terminal, and the third switch circuit connects the eleventh terminal to the twelfth terminal.
   <5>

The high-frequency circuit according to any one of <2> to <4>, in which
when reception of a signal of the first band and reception of a signal of the second band are simultaneously performed, the second switch circuit connects the sixth terminal and the seventh terminal to the tenth terminal, and the third switch circuit connects the eleventh terminal to the thirteenth terminal.
   <6>

The high-frequency circuit according to any one of <1> to <5>, in which
a combination of the first band and the second band is a combination of Band 40 for Long Term Evolution (LTE) or n40 for 5th Generation New Radio (5GNR) and Band 41 for LTE or n41 for 5GNR or a combination of Band 39 for LTE or n39 for 5GNR and Band 41 for LTE or n41 for 5GNR.
   <7>

The high-frequency circuit according to <2>, in which
the first switch circuit further includes a fourteenth terminal and a fifteenth terminal, and
the high-frequency circuit further includes
   a fourth switch circuit including a sixteenth terminal connected to the first low-noise amplifier, a seventeenth terminal connected to the fourteenth terminal, and an eighteenth terminal connected to the third filter, and
   a fifth switch circuit including a nineteenth terminal connected to the second low-noise amplifier, a twentieth terminal connected to the fifteenth terminal, and a twenty-first terminal connected to the fourth filter.
      <8>

The high-frequency circuit according to <7>, in which
when transmission of a signal of the first band and reception of a signal of the second band are simultaneously performed, the first switch circuit connects the first terminal to the second terminal, the second switch circuit connects the fourth terminal to the eighth terminal and connects the seventh terminal to the ninth terminal, the third switch circuit connects the eleventh terminal to the twelfth terminal, and the fifth switch circuit connects the nineteenth terminal to the twenty-first terminal.
   <9>

The high-frequency circuit according to <7> or <8>, in which
when reception of a signal of the first band and transmission of a signal of the second band are simultaneously performed, the first switch circuit connects the first terminal to the third terminal, the second switch circuit connects the fifth terminal to the ninth terminal and connects the sixth terminal to the eighth terminal, the third switch circuit connects the eleventh terminal to the twelfth terminal, and the fourth switch circuit connects the sixteenth terminal to the eighteenth terminal.
   <10>

The high-frequency circuit according to any one of <7> to <9>, in which
when reception of a signal of the first band and reception of a signal of the second band are simultaneously performed, the first switch circuit connects the second terminal to the fourteenth terminal and connects the third terminal to the fifteenth terminal, the second switch circuit connects the fourth terminal and the fifth terminal to the tenth terminal, the third switch circuit connects the eleventh terminal to the thirteenth terminal, the fourth switch circuit connects the sixteenth terminal to the seventeenth terminal, and the fifth switch circuit connects the nineteenth terminal to the twentieth terminal.
   <11>

The high-frequency circuit according to any one of <7> to <10>, in which
a combination of the first band and the second band is a combination of Band 40 for LTE or n40 for 5GNR and Band 41 for LTE or n41 for 5GNR or a combination of Band 39 for LTE or n39 for 5GNR and Band 41 for LTE or n41 for 5GNR.
   <12>

The high-frequency circuit according to any one of <7> to <10>, further including:
a second power amplifier;
a third low-noise amplifier;
a seventh filter having a pass band including a transmission band of a third band and connected to the second power amplifier;
an eighth filter having a pass band including a reception band of the third band and connected to the third low-noise amplifier; and
a ninth filter having pass bands including the transmission band and the reception band of the third band and having one end switchably connected to the seventh filter and the eighth filter and another end connected to the first input/output terminal, in which
the second switch circuit further includes a twenty-second terminal connected to the seventh filter and the eighth filter and a twenty-third terminal connected to the ninth filter.
   <13>

The high-frequency circuit according to <12>, in which
when transmission of a signal of the first band, reception of a signal of the second band, and transmission and reception of a signal of the third band are simultaneously performed, the first switch circuit connects the first terminal to the second terminal, the second switch circuit connects the fourth terminal to the eighth terminal, connects the seventh terminal to the ninth terminal, and connects the twenty-second terminal to the twenty-third terminal, the third switch circuit connects the eleventh terminal to the twelfth terminal, and the fifth switch circuit connects the nineteenth terminal to the twenty-first terminal.
   <14>

The high-frequency circuit according to <12> or <13>, in which
when reception of a signal of the first band, transmission of a signal of the second band, and transmission and reception of a signal of the third band are simultaneously performed, the first switch circuit connects the first terminal to the third terminal, the second switch circuit connects the fifth terminal to the ninth terminal, connects the sixth terminal to the eighth terminal, and connects the twenty-second terminal to the twenty-third terminal, the third switch circuit connects the eleventh terminal to the twelfth terminal, and the fourth switch circuit connects the sixteenth terminal to the eighteenth terminal.
   <15>

The high-frequency circuit according to any one of <12> to <14>, in which
when reception of a signal of the first band, reception of a signal of the second band, and transmission and reception of a signal of the third band are simultaneously performed, the first switch circuit connects the second terminal to the fourteenth terminal and connects the third terminal to the fifteenth terminal, the second switch circuit connects the fourth terminal, the fifth terminal, and the twenty-second terminal to the tenth terminal, the third switch circuit connects the eleventh terminal to the thirteenth terminal, the fourth switch circuit connects the sixteenth terminal to the seventeenth terminal, and the fifth switch circuit connects the nineteenth terminal to the twentieth terminal.
   <16>

The high-frequency circuit according to any one of <12> to <15>, in which
a combination of the first band and the second band is a combination of Band 40 for LTE or n40 for 5GNR and Band 41 for LTE or n41 for 5GNR or a combination of Band 39 for LTE or n39 for 5GNR and Band 41 for LTE or n41 for 5GNR, and
the third band is Band 1, Band 3, Band 5, Band 8, or Band 28 for LTE or n1, n3, n5, n8, or n28 for 5GNR.
   <17>

The high-frequency circuit according to any one of <7> to <16>, in which
at least one of the fifth filter and the sixth filter is an acoustic wave filter including an inductor, a capacitor, and an acoustic wave resonator.
   <18>

The high-frequency circuit according to any one of <7> to <17>, in which
at least one of the third filter and the fourth filter is an LC filter.
   <19>

A high-frequency circuit including:
a first filter having a pass band including a first band for time division duplex;
a second filter having a pass band including a second band for time division duplex capable of simultaneous transmission and reception with the first band;
a third filter having an attenuation band including the second band;
a first switch circuit including a first terminal connected to an antenna connection terminal, a second terminal connected to the first filter, a third terminal connected to the second filter, and a fourth terminal connected to the third filter; and
a second switch circuit including a fifth terminal connected to the third filter and a sixth terminal connected to the first filter, in which
the first filter is switchably connected via the second switch circuit and the third filter to the fourth terminal of the first switch circuit.
   <20>

A high-frequency circuit including:
a first filter having a pass band including a first band for time division duplex;
a second filter having a pass band including a second band for time division duplex capable of simultaneous transmission and reception with the first band;
a third filter having an attenuation band including the second band;
a first switch circuit including a first terminal connected to a power amplifier or a low-noise amplifier, a second terminal connected to the first filter, and a third terminal connected to the third filter; and
a second switch circuit including a fourth terminal connected to the first filter and a fifth terminal connected to the third filter, in which
the first filter is switchably connected via the second switch circuit and the third filter to the third terminal of the first switch circuit.

### INDUSTRIAL APPLICABILITY

The present invention can be widely used for communication devices such as mobile phones as a high-frequency circuit arranged at a front-end part.

### REFERENCE SIGNS LIST

1, 1A, 1B, 1C, 1D, 1E, 1F, 1G, 1H, 1I, 1J, 1K, 1L high-frequency circuit
2 antenna
3 RFIC
4 BBIC
5, 5A, 5B, 5C, 5D, 5E, 5F, 5G, 5H, 5I, 5K communication device
11, 11C, 12B, 12C power amplifier
21, 21C, 22, 22C, 23B, 23C, 24C, 25J, 26J low-noise amplifier
31, 31A, 31C, 31D, 32, 32A, 32C, 32D, 33, 33A, 33C, 34, 34A, 34C, 35, 35A, 35C, 36, 36A, 36C, 37B, 37J, 38B, 38J, 39B, 41C, 42C, 43C, 44C filter
51, 51A, 51C, 51D, 51E, 51F, 51G, 51H, 51I, 51K, 52, 52B, 52C, 52E, 52F, 52G, 52I, 53, 53C, 53E, 53F, 53G, 53J, 53L, 54A, 54C, 54G, 55A, 55C, 55G, 56D, 56G, 57D, 57G, 58G, 59G switch circuit
100C antenna connection terminal
101, 102 input/output terminal
101J, 102L, 111, 111C, 112B, 112C input terminal
121, 121C, 122, 122C, 123B, 123C, 124C, 125J, 126J, 131I, 132K output terminal

1. A high-frequency circuit comprising:
a first power amplifier;
a first low-noise amplifier and a second low-noise amplifier;
a first filter having a pass band including a first band for time division duplex and switchably connected to the first power amplifier;
a second filter having a pass band including a second band for time division duplex capable of simultaneous transmission and reception with the first band and switchably connected to the first power amplifier;
a third filter having a pass band including the first band and connected to the first low-noise amplifier;
a fourth filter having a pass band including the second band and connected to the second low-noise amplifier;
a fifth filter having a pass band including the first band and having a first end switchably connected to each of the first filter and the third filter and a second end connected to a first input/output terminal;
a sixth filter having a pass band including the second band and having a first end switchably connected to each of the second filter and the fourth filter and a second end connected to the first input/output terminal;
a first switch circuit including a first terminal connected to the first power amplifier and a second terminal and a third terminal connected to the first filter and the second filter, respectively; and
a second switch circuit including a fourth terminal, a fifth terminal, a sixth terminal, a seventh terminal, an eighth terminal, and a ninth terminal connected to the first filter, the second filter, the third filter, the fourth filter, the fifth filter, and the sixth filter, respectively, and a tenth terminal connected to a second input/output terminal not via the fifth filter and the sixth filter.

2. The high-frequency circuit according to claim 1, further comprising:
a third switch circuit including an eleventh terminal connected to an antenna, a twelfth terminal connected to the first input/output terminal, and a thirteenth terminal connected to the second input/output terminal.

3. The high-frequency circuit according to claim 2, wherein
when transmission of a signal of the first band and reception of a signal of the second band are simultaneously performed, the first switch circuit connects the first terminal to the second terminal, the second switch circuit connects the fourth terminal to the eighth terminal and connects the seventh terminal to the ninth terminal, and the third switch circuit connects the eleventh terminal to the twelfth terminal.

4. The high-frequency circuit according to claim 2, wherein
when reception of a signal of the first band and transmission of a signal of the second band are simultaneously performed, the first switch circuit connects the first terminal to the third terminal, the second switch circuit connects the fifth terminal to the ninth terminal and connects the sixth terminal to the eighth terminal, and the third switch circuit connects the eleventh terminal to the twelfth terminal.

5. The high-frequency circuit according to claim 2, wherein
when reception of a signal of the first band and reception of a signal of the second band are simultaneously performed, the second switch circuit connects the sixth terminal and the seventh terminal to the tenth terminal, and the third switch circuit connects the eleventh terminal to the thirteenth terminal.

6. The high-frequency circuit according to claim 1, wherein
a combination of the first band and the second band is a combination of Band 40 for Long Term Evolution (LTE) or n40 for 5th Generation New Radio (5GNR) and Band 41 for LTE or n41 for 5GNR or a combination of Band 39 for LTE or n39 for 5GNR and Band 41 for LTE or n41 for 5GNR.

7. The high-frequency circuit according to claim 2, wherein
the first switch circuit further includes a fourteenth terminal and a fifteenth terminal, and
the high-frequency circuit further includes
a fourth switch circuit including a sixteenth terminal connected to the first low-noise amplifier, a seventeenth terminal connected to the fourteenth terminal, and an eighteenth terminal connected to the third filter, and
a fifth switch circuit including a nineteenth terminal connected to the second low-noise amplifier, a twentieth terminal connected to the fifteenth terminal, and a twenty-first terminal connected to the fourth filter.

8. The high-frequency circuit according to claim 7, wherein
when transmission of a signal of the first band and reception of a signal of the second band are simultaneously performed, the first switch circuit connects the first terminal to the second terminal, the second switch circuit connects the fourth terminal to the eighth terminal and connects the seventh terminal to the ninth terminal, the third switch circuit connects the eleventh terminal to the twelfth terminal, and the fifth switch circuit connects the nineteenth terminal to the twenty-first terminal.

9. The high-frequency circuit according to claim 7, wherein
when reception of a signal of the first band and transmission of a signal of the second band are simultaneously performed, the first switch circuit connects the first terminal to the third terminal, the second switch circuit connects the fifth terminal to the ninth terminal and connects the sixth terminal to the eighth terminal, the third switch circuit connects the eleventh terminal to the twelfth terminal, and the fourth switch circuit connects the sixteenth terminal to the eighteenth terminal.

10. The high-frequency circuit according to claim 7, wherein
when reception of a signal of the first band and reception of a signal of the second band are simultaneously performed, the first switch circuit connects the second terminal to the fourteenth terminal and connects the third terminal to the fifteenth terminal, the second switch circuit connects the fourth terminal and the fifth terminal to the tenth terminal, the third switch circuit connects the eleventh terminal to the thirteenth terminal, the fourth switch circuit connects the sixteenth terminal to the seventeenth terminal, and the fifth switch circuit connects the nineteenth terminal to the twentieth terminal.

11. The high-frequency circuit according to claim 7, wherein
a combination of the first band and the second band is a combination of Band 40 for LTE or n40 for 5GNR and Band 41 for LTE or n41 for 5GNR or a combination of Band 39 for LTE or n39 for 5GNR and Band 41 for LTE or n41 for 5GNR.

12. The high-frequency circuit according to claim 7, further comprising:
a second power amplifier;
a third low-noise amplifier;
a seventh filter having a pass band including a transmission band of a third band and connected to the second power amplifier;
an eighth filter having a pass band including a reception band of the third band and connected to the third low-noise amplifier; and
a ninth filter having pass bands including the transmission band and the reception band of the third band and having a first end switchably connected to the seventh filter and the eighth filter and a second end connected to the first input/output terminal, wherein
the second switch circuit further includes a twenty-second terminal connected to the seventh filter and the eighth filter and a twenty-third terminal connected to the ninth filter.

13. The high-frequency circuit according to claim 12, wherein
when transmission of a signal of the first band, reception of a signal of the second band, and transmission and reception of a signal of the third band are simultaneously performed, the first switch circuit connects the first terminal to the second terminal, the second switch circuit connects the fourth terminal to the eighth terminal, connects the seventh terminal to the ninth terminal, and connects the twenty-second terminal to the twenty-third terminal, the third switch circuit connects the eleventh terminal to the twelfth terminal, and the fifth switch circuit connects the nineteenth terminal to the twenty-first terminal.

14. The high-frequency circuit according to claim 12, wherein when reception of a signal of the first band, transmission of a signal of the second band, and transmission and reception of a signal of the third band are simultaneously performed, the first switch circuit connects the first terminal to the third terminal, the second switch circuit connects the fifth terminal to the ninth terminal, connects the sixth terminal to the eighth terminal, and connects the twenty-second terminal to the twenty-third terminal, the third switch circuit connects the eleventh terminal to the twelfth terminal, and the fourth switch circuit connects the sixteenth terminal to the eighteenth terminal.

15. The high-frequency circuit according to claim 12, wherein
when reception of a signal of the first band, reception of a signal of the second band, and transmission and reception of a signal of the third band are simultaneously performed, the first switch circuit connects the second terminal to the fourteenth terminal and connects the third terminal to the fifteenth terminal, the second switch circuit connects the fourth terminal, the fifth terminal, and the twenty-second terminal to the tenth terminal, the third switch circuit connects the eleventh terminal to the thirteenth terminal, the fourth switch circuit connects the sixteenth terminal to the seventeenth terminal, and the fifth switch circuit connects the nineteenth terminal to the twentieth terminal.

16. The high-frequency circuit according to claim 12, wherein
a combination of the first band and the second band is a combination of Band 40 for LTE or n40 for 5GNR and Band 41 for LTE or n41 for 5GNR or a combination of Band 39 for LTE or n39 for 5GNR and Band 41 for LTE or n41 for 5GNR, and the third band is Band 1, Band 3, Band 5, Band 8, or Band 28 for LTE or n1, n3, n5, n8, or n28 for 5GNR.

17. The high-frequency circuit according to claim 7, wherein
at least one of the fifth filter and the sixth filter is an acoustic wave filter including an inductor, a capacitor, and an acoustic wave resonator.

18. The high-frequency circuit according to claim 7, wherein
at least one of the third filter and the fourth filter is an LC filter.

19. A high-frequency circuit comprising:
a first filter having a pass band including a first band for time division duplex;
a second filter having a pass band including a second band for time division duplex capable of simultaneous transmission and reception with the first band;
a third filter having an attenuation band including the second band;
a first switch circuit including a first terminal connected to an antenna connection terminal, a second terminal connected to the first filter, a third terminal connected to the second filter, and a fourth terminal connected to the third filter; and
a second switch circuit including a fifth terminal connected to the third filter and a sixth terminal connected to the first filter, wherein
the first filter is switchably connected via the second switch circuit and the third filter to the fourth terminal of the first switch circuit.

20. A high-frequency circuit comprising:
a first filter having a pass band including a first band for time division duplex;
a second filter having a pass band including a second band for time division duplex capable of simultaneous transmission and reception with the first band;
a third filter having an attenuation band including the second band;
a first switch circuit including a first terminal connected to a power amplifier or a low-noise amplifier, a second terminal connected to the first filter, and a third terminal connected to the third filter; and
a second switch circuit including a fourth terminal connected to the first filter and a fifth terminal connected to the third filter, wherein
the first filter is switchably connected via the second switch circuit and the third filter to the third terminal of the first switch circuit.
